(19) United States
(12) Patent Application Publication
(10) Pub. No.: US 2020/0358137 A1
(43) Pub. Date: Nov. 12, 2020

(54) IMPROVED LEAD ACID BATTERY SEPARATORS, RESILIENT SEPARATORS, BATTERIES, SYSTEMS, AND RELATED METHODS

(71) Applicant: Daramic, LLC, Charlotte, NC (US)

(72) Inventors: Eric H. Miller, Philpot, KY (US); Girish Shivaji Patil, Lexington, KY (US); J. Kevin Whear, Utica, KY (US)

(21) Appl. No.: 16/966,027

(22) PCT Filed: Jan. 31, 2019
(86) PCT No.: PCT/US2019/015949

§ 371 Date: Jul. 30, 2020

Related U.S. Application Data
(60) Provisional application No. 62/624,278, filed on Jan. 31, 2018.

(51) Int. Cl. H01M 10/12; H01M 10/10; H01M 2/16; H01M 2/18; H01M 4/68

(52) U.S. Cl. CPC H01M 10/12; H01M 10/10; H01M 2/162; H01M 2300/0005; H01M 2/18; H01M 4/68; H01M 2220/20; H01M 2/1653

(57) ABSTRACT

Disclosed herein are exemplary embodiments of improved separators for lead acid batteries, improved lead acid batteries incorporating the improved separators, and systems incorporating the same. A lead acid battery separator is provided with a porous membrane with a plurality of ribs extending from a surface thereon. The ribs are provided with a plurality of discontinuous peaks arranged such as to provide resilient support for the porous membrane in order to resist forces exerted by swelling NAM and thus mitigate the effects of acid starvation associated with NAM swelling. The separator is also provided to be capable utilizing any motion experienced by the battery housing such a separator in order to mitigate the effects of acid stratification by facilitating acid mixing. A lead acid battery is further provided that incorporates the provided separator. Such a lead acid battery may be a flooded lead acid battery, an enhanced flooded lead acid battery, and may be provided as operating in a partial state of charge. Systems incorporating such a lead acid battery are also provided, such as a vehicle or any other energy storage system, such as solar or wind energy collection. Other exemplary embodiments are provided such as to have any one or more of the following: a lowered electrical resistance; increased puncture resistance; increased oxidation resistance; increased ability to mitigate the effects of dendrite growth, and/or other improvements.

### RELATED APPLICATIONS

This patent application is a 371 Application which claims priority to PCT/US2019/015949, filed Jul. 31, 2019, which claims priority to and the benefit of U.S. Provisional App. No. 62/624,278, filed on Jan. 31, 2018.

### FIELD

In accordance with at least select embodiments, the present disclosure or invention is directed to novel or improved separators for lead acid batteries, such as flooded lead acid batteries, and in particular enhanced flooded lead acid batteries (“EFBs”), and various other lead acid batteries, such as gel and absorptive glass mat (“AGM”) batteries. In accordance with at least select embodiments, the present disclosure or invention is directed to novel or improved separators, battery separators, resilient separators, balanced separators, EFB separators, batteries, cells, systems, methods involving the same, vehicles using the same, methods of manufacturing the same, the use of the same, and combinations thereof. In addition, disclosed herein are methods, systems, and battery separators for enhancing battery life and reducing battery failure by reducing battery electrode acid starvation.

In accordance with at least selected embodiments, the present disclosure or invention is directed to novel or improved separators, battery separators, enhanced flooded battery separators, batteries, cells, and/or methods of manufacture and/or use of such separators, battery separators, enhanced flooded battery separators, cells, batteries, systems, methods, and/or vehicles using the same. In accordance with at least certain embodiments, the present disclosure or invention is directed to novel or improved battery separators, resilient separators, balanced separators, flooded lead acid battery separators, or enhanced flooded lead acid battery separators such as those useful for deep-cycling and/or partial state of charge (“PSoC”) applications. Such applications may include such non-limiting examples as: electric motive machine applications, such as fork lifts and golf carts (sometimes referred to as golf cars), e-rickshaws, e-bikes, e-trikes, and/or the like; automobile or truck applications such as starting lighting ignition (“SLI”) batteries, such as those used for internal combustion engine vehicles; idle-start-stop (“ISS”) vehicle batteries; hybrid vehicle applications, hybrid-electric vehicle applications; batteries with high power requirements, such as uninterrupted power supply (“UPS”) or valve regulated lead acid (“VRLA”), and/or for batteries with high CCA requirements; inverters; and energy storage systems, such as those found in renewable and/or alternative energy systems, such as solar and wind power collection systems.

In accordance with at least selected embodiments, the present disclosure or invention is directed to separators, particularly separators for flooded lead acid batteries capable of reducing or mitigating acid starvation; reducing or mitigating acid stratification; reducing or mitigating dendrite growth; and having reduced electrical resistance and/or capable of increasing cold cranking amps. In addition, disclosed herein are methods, systems, and battery separators for enhancing battery life; reducing or mitigating acid starvation; reducing or mitigating acid stratification; reducing to mitigating dendrite growth; reducing the effects of oxidation; reducing water loss; reducing internal resistance; increasing wettability; improving acid diffusion; improving cold cranking amps, improving uniformity, and any combination thereof in at least enhanced flooded lead acid batteries. In accordance with at least particular embodiments, the present disclosure or invention is directed to an improved separator for enhanced flooded lead acid batteries wherein the separator includes an improved and novel rib design, and improved separator resiliency. In accordance with at least particular embodiments, the present disclosure or invention is directed to an improved separator for enhanced flooded lead acid batteries wherein the separator includes performance enhancing additives or coatings, increased oxidation resistance, optimized porosity, increased void volume, amorphous silica, higher oil absorption silica, higher silanol group silica, silica with an OH to Si ratio of 21:100 to 35:100, a shish-kebab structure or morphology, a polyolefin microporous membrane containing particle-like filler in an amount of 40% or more by weight of the membrane and polymer, such as ultrahigh molecular weight polyethylene (“UHMWPE”), having shish-kebab formations with extended chain crystal (shish formation) and folded chain crystal (kebab formation) and the average repetition periodicity of the kebab formation from 1 nm to 150 nm, decreased sheet thickness, decreased tortuosity, reduced thickness, reduced oil content, increased wettability, increased acid diffusion, and/or the like, and any combination thereof.

### BACKGROUND

An exemplary lead acid battery has a positive terminal and a negative terminal. Within the battery is an array of alternating positive plates (or positive electrodes) and negative plates (or negative electrodes) with separators disposed therebetween each electrode. The positive electrodes are in electrical communication with the positive terminal, and the negative electrodes are in contact with the negative terminal. The positive electrodes may be doped with a positive active material (“PAM”) and the negative electrodes may be doped with a negative active material (“NAM”), each of which contributes to increasing the functionality of the electrodes. The positive electrode may be substantially made of lead dioxide (PbO₂) and the negative electrode may be substantially made of lead (Pb).

The positive electrodes, negative electrodes, and separators are substantially submerged within an aqueous electrolyte solution. The electrolyte may be, for example, a solution of sulfuric acid (H₂SO₄) and water (H₂O). The electrolyte solution may have, for example, a specific gravity of approximately 1.28, with a range of approximately 1.215 to 1.300.

The reaction at the lead dioxide (PbO₂) positive (+) electrode (the “positive half-reaction”) supplies electrons and is left positive. This positive half-reaction during discharge at the lead dioxide (PbO₂) positive (+) electrode produces lead sulfate (PbSO₄) and water (H₂O) and is shown below in Eq. 1:

PbO₂+SO₄⁻²+4H⁺+2e⁻↔PbSO₄+2H₂O (Eq. 1)

where:
PbO₂ is the solid lead dioxide positive (+) electrode;
SO₄⁻² is aqueous;
4H⁺ is aqueous;
2e⁻ is in the solid lead dioxide (PbO₂) positive (+) electrode;
PbSO₄ is a solid precipitate within the aqueous electrolyte; and
H₂O is a liquid.

The positive half-reaction is reversible upon charging the battery.

The negative half-reaction at the lead (Pb) negative (−) electrode (the “negative half-reaction”) supplies positive ions and is left negative. The negative half-reaction during discharge produces lead sulfate (PbSO₄) and negative ions (e⁻) and is shown below in Eq. 2:

Pb+SO₄⁻²↔PbSO₄+2e⁻ (Eq. 2)

where:
Pb is the solid lead negative (−) electrode;
SO₄⁻² is aqueous;
PbSO₄ is a solid precipitate within the aqueous electrolyte; and
2e⁻ is in the lead (Pb) negative (−) electrode;

The negative half-reaction is reversible upon charging the battery.

Together, these half-reactions give way to the overall chemical reaction of the lead acid battery, as shown below in Eq. 3:

Pb+PbO₂+2H₂SO₄↔2PbSO₄+2H₂O (Eq. 3)

where:
Pb is the solid negative (−) electrode;
PbO₂ is the solid positive (+) electrode;
H₂SO₄ is a liquid within the aqueous electrolyte;
PbSO₄ is a solid precipitate within the aqueous electrolyte; and
H₂O is a liquid within the aqueous electrolyte.

The overall chemical reaction is reversible upon charging the battery. For each of the above reactions, discharge occurs moving from left to right, and charging occurs moving right to left. It should be noted that other elements may be added to the electrode plates or in pasting material (PAM or NAM), such as antimony (Sb) or carbon (C), in order to increase the efficiency of the above reactions.

As can be seen from the overall reaction, the acid (H₂SO₄) is necessary for the electrochemical reaction as well as providing a medium for ions to flow between the electrodes. It is therefore imperative that the electrodes be in contact with acid at all times, otherwise the electrodes will experience acid starvation and the battery will suffer in terms of capacity, performance, and life.

As can be seen in Eq. 2, the discharging reaction converts a portion of the lead (Pb), which may also present in the NAM, and the acid (H₂SO₄) into lead sulfate (PbSO₄), which is a larger molecule. As the lead sulfate is a larger molecule that the lead, it occupies a larger volume and, as will be discussed hereinafter, is believed to contribute to NAM swelling. Because the lead sulfate is formed during discharge, batteries operating in a partial state of charge (i.e., at least partially discharged) are more susceptible to NAM swelling.

Acid starvation has been witnessed to occur in the presence of NAM swelling. As the NAM swells, it presses against the negative side of the separator and pushes the positive side toward the positive electrode. If severe enough, this swelling may force portions of the separator to deflect and contact the positive electrode and/or PAM. This, in turn, pushes or squeezes the electrolyte or acid, which would normally occupy the volume between the separator and positive electrode, out of that volume. The present invention addresses acid starvation as will be discussed in greater detail herein.

Acid starvation also occurs during conditions of acid stratification, which occurs when the denser-than-water acid settles to the bottom of the battery case and the water in the electrolyte rises to the top of the case. The present invention addresses acid stratification as will be discussed in greater detail herein.

Deep cycle batteries, such as those used in golf carts (also known as golf cars), forklifts, e-rickshaws, e-bikes, electric vehicles, hybrid vehicles, idle-stop-start (“ISS”) vehicles, and the like, and stationary applications, such as those used in solar or wind power collection, operate nearly constantly in a partial state of charge. Such batteries, with the possible exception of truck, heavy duty (“HD”) truck, or ISS batteries, are used for 8-12 hours or more being discharged before they are charged. Furthermore, the operators of those batteries may not over-charge the batteries before returning them to service. ISS batteries experience cycles of discharge and brief intermittent charging cycles, and generally rarely achieve a full charge or are ever overcharged. Due to their continuous use and discharge, it is imperative that these batteries are capable of performing to their fullest during use. This is not possible if the electrodes are acid starved.

In some instances, acid starvation can be at least partially avoided using valve regulated lead acid (“VRLA”) technology where the acid is immobilized by either a gelled electrolyte and/or by an absorbent glass mat (“AGM”) battery separator system. In contrast to the freely-flowing fluid electrolyte in flooded lead acid batteries, in VRLA and/or AGM batteries, the electrolyte is absorbed on a fiber or fibrous material, such as a fiber glass mat, a polymeric fiber mat, a gelled electrolyte, and so forth. However, VRLA and/or AGM battery systems are substantially more expensive to manufacture than flooded battery systems. VRLA and/or AGM technology in some instances, may be more sensitive to overcharging, may dry out in high heat, may experience a gradual decline in capacity, and may have a lower specific energy. Similarly, in some instances, gel VRLA technology may have higher internal resistance and may have reduced charge acceptance.

Given that electric vehicles, hybrid electric vehicles, ISS vehicles and renewable and alternative energy collection are becoming increasingly used to combat emissions of CO₂ and other pollutants, enhanced flooded lead acid batteries are expected to become more and more prevalent. Thus, batteries and separators that combat acid starvation are greatly needed.

For at least certain applications or batteries, there remains a need for improved separators providing for improved cycle life, reduced failure, improved performance in a partial state of charge, reduced water loss, and/or reduced acid starvation. More particularly, there remains a need for improved separators, and improved batteries, such as those operating at a partial state of charge, utilizing an improved separator, which provides for enhancing battery life, reducing battery failure, improving oxidation stability, improving, maintaining, and/or lowering float current, improving end of charge (“EOC”) current, decreasing the current and/or voltage needed to charge and/or fully charge a deep cycle battery, minimizing internal electrical resistance increases, lowering electrical resistance, reducing antimony poisoning, reducing acid stratification, reducing acid starvation, improving acid diffusion, reducing water loss, and/or improving uniformity in lead acid batteries.

### SUMMARY

The details of one or more embodiments are set forth in the description herinafter. Other features, objects, and advantages will be apparent from the description and from the claims. In accordance with at least select embodiments, the present disclosure or invention may address the above issues or needs. In accordance with at least certain embodiments, aspects, or objects, the present disclosure or invention may provide an improved separator and/or battery utilizing said separator which overcomes the aforementioned problems. For instance by providing batteries having reduced acid starvation; reduced acid stratification; improved separator resiliency; mitigating the formation of dendrites; increased oxidation resistance; reduced water loss; reduced internal resistance; increased separator wettability; improved acid diffusion through the separator; improved cold cranking amps, improved uniformity; and/or having improved cycling performance; and any combination thereof.

In accordance with at least selected embodiments, the present disclosure or invention may address the above issues or needs and/or may provide novel or improved separators and/or enhanced flooded batteries. In accordance with at least selected embodiments, the present disclosure or invention is directed to novel or improved separators, battery separators, enhanced flooded battery separators, batteries, cells, and/or methods of manufacture and/or use of such separators, battery separators, enhanced flooded battery separators, cells, and/or batteries. In accordance with at least certain embodiments, the present disclosure or invention is directed to novel or improved battery separators, resilient separators, balanced separators, flooded lead acid battery separators, or enhanced flooded battery separators for automobile applications, for trucks, for idle-start-stop (“ISS”) batteries, for batteries with high power requirements, for partial state of charge batteries, for deep cycle batteries, such as uninterrupted power supply (“UPS”) or valve regulated lead acid (“VRLA”), and/or for batteries with high CCA requirements, and/or improved methods of making and/or using such improved separators, cells, batteries, systems, and/or the like. In accordance with at least certain embodiments, the present disclosure or invention is directed to an improved separator for enhanced flooded batteries and/or improved methods of using such batteries having such improved separators. In addition, disclosed herein are methods, systems and battery separators for enhancing battery performance and life, reducing acid stratification, reducing internal electrical resistance, increasing cold cranking amps, and/or improving uniformity in at least enhanced flooded batteries. In accordance with at least particular embodiments, the present disclosure or invention is directed to an improved separator for enhanced flooded batteries wherein the separator includes or provides acid mixing ribs or protrusions, decreased electrical resistance, performance enhancing additives or coatings, improved fillers, increased porosity, decreased tortuosity, reduced thickness, reduced oil content, increased wettability, increased acid diffusion, and/or the like. One particular possibly preferred novel or improved separator for enhanced flooded batteries, ISS batteries, deep cycle batteries, truck batteries, heavy duty (HD) truck batteries, or partial state of charge batteries includes or provides acid mixing ribs, positive side serrated ribs, negative side cross ribs (“NCR”), decreased electrical resistance, performance enhancing additives or coatings, reduced water loss, low ER, improved fillers, increased porosity, decreased tortuosity, reduced thickness, reduced oil content, increased wettability, increased acid diffusion, and/or the like. Another particular possibly preferred novel or improved separator for enhanced flooded batteries, ISS batteries, deep cycle batteries, truck batteries, or partial state of charge batteries includes or provides acid mixing ribs, positive side serrated ribs, negative side cross ribs, decreased electrical resistance, performance enhancing additives or coatings, reduced water loss, low ER, and/or improved fillers.

In accordance with at least select embodiments, the present disclosure or invention is directed to novel or improved separators for lead acid batteries, such as flooded lead acid batteries, and in particular enhanced flooded lead acid batteries (“EFBs”), and various other lead acid batteries, such as gel and absorptive glass mat (“AGM”) batteries. In accordance with at least select embodiments, the present disclosure or invention is directed to novel or improved separators, battery separators, resilient separators, balanced separators, EFB separators, batteries, cells, systems, methods involving the same, vehicles using the same, methods of manufacturing the same, the use of the same, and combinations thereof. In addition, disclosed herein are methods, systems, and battery separators for enhancing battery life and reducing battery failure by reducing battery electrode acid starvation.

In accordance with at least selected embodiments, the present disclosure or invention is directed to novel or improved separators, battery separators, enhanced flooded battery separators, batteries, cells, and/or methods of manufacture and/or use of such separators, battery separators, enhanced flooded battery separators, cells, batteries, systems, methods, and/or vehicles using the same. In accordance with at least certain embodiments, the present disclosure or invention is directed to novel or improved battery separators, flooded lead acid battery separators, or enhanced flooded lead acid battery separators such as those useful for deep-cycling and/or partial state of charge (“PSoC”) applications. Such applications may include such non-limiting examples as: electric motive machine applications, such as fork lifts and golf carts (sometimes referred to as golf cars), e-rickshaws, e-bikes, e-trikes, and/or the like; automobile or truck applications such as starting lighting ignition (“SLI”) batteries, such as those used for internal combustion engine vehicles; idle-start-stop (“ISS”) vehicle batteries; hybrid vehicle applications, hybrid-electric vehicle applications; batteries with high power requirements, such as uninterrupted power supply (“UPS”) or valve regulated lead acid (“VRLA”), and/or for batteries with high CCA requirements; inverters; and energy storage systems, such as those found in renewable and/or alternative energy systems, such as solar and wind power collection systems.

In accordance with at least selected embodiments, the present disclosure or invention is directed to separators, particularly separators for flooded lead acid batteries capable of reducing or mitigating acid starvation; reducing or mitigating acid stratification; reducing or mitigating dendrite growth; and having reduced electrical resistance and/or capable of increasing cold cranking amps. In addition, disclosed herein are methods, systems, and battery separators for enhancing battery life; reducing or mitigating acid starvation; reducing or mitigating acid stratification; reducing to mitigating dendrite growth; reducing the effects of oxidation; reducing water loss; reducing internal resistance; increasing wettability; improving acid diffusion; improving cold cranking amps, improving uniformity, and any combination thereof in at least enhanced flooded lead acid batteries. In accordance with at least particular embodiments, the present disclosure or invention is directed to an improved separator for enhanced flooded lead acid batteries wherein the separator includes an improved and novel rib design, and improved separator resiliency. In accordance with at least particular embodiments, the present disclosure or invention is directed to an improved separator for enhanced flooded lead acid batteries wherein the separator includes performance enhancing additives or coatings, increased oxidation resistance, increased porosity, increased void volume, amorphous silica, higher oil absorption silica, higher silanol group silica, silica with an OH to Si ratio of 21:100 to 35:100, a shish-kebab structure or morphology, a polyolefin microporous membrane containing particle-like filler in an amount of 40% or more by weight of the membrane and polymer, such as ultrahigh molecular weight polyethylene (“UHMWPE”), having shish-kebab formations with extended chain crystal (shish formation) and folded chain crystal (kebab formation) and the average repetition periodicity of the kebab formation from 1 nm to 150 nm, decreased sheet thickness, decreased tortuosity, reduced thickness, reduced oil content, increased wettability, increased acid diffusion, and/or the like, and any combination thereof.

In accordance with at least a first aspect of certain selected embodiments, a lead acid battery separator is provided with a porous membrane having a polymer and a filler. The porous membrane is provided with at least a first surface with at least a first plurality of ribs extending from the first surface. The first plurality of ribs is provided with a first plurality of teeth or discontinuous peaks or protrusions, where each of the first plurality of teeth or discontinuous peaks or protrusions are in such proximity to one another so as to provide resiliency to the separator. Such resiliency may refer to the separators ability to resist deflecting while under pressure resulting from active material swelling. Such proximity may be at least approximately 1.5 mm from one tooth, peak, or protrusion to another. The separator may be further provided with a continuous base portion with the first plurality of teeth or discontinuous peaks or protrusions extending from the base portion.

In certain embodiments, the separator may be provided with a continuous base portion with the first plurality of teeth or discontinuous peaks or protrusions extending from the base portion. The base portion may be wider than the width of the teeth or discontinuous peaks or protrusions. In addition, the base portion may extend continuously between each of the teeth or discontinuous peaks or protrusions.

In accordance with at least certain select embodiments, the separator may be provided with ribs that are one or more of the following: solid ribs, discrete broken ribs, continuous ribs, discontinuous ribs, discontinuous peaks, discontinuous protrusions, angled ribs, linear ribs, longitudinal ribs extending substantially in a machine direction of the porous membrane, lateral ribs extending substantially in a cross-machine direction of the porous membrane, transverse ribs extending substantially in the cross-machine direction of the separator, transverse ribs or NCRs extending substantially in the cross-machine direction of the separator with fissures therein, teeth, toothed ribs, serrations, serrated ribs, battlements, battlemented ribs, curved ribs, sinusoidal ribs, disposed in a continuous zig-zag-sawtooth-like fashion, disposed in a broken discontinuous zig-zag-sawtooth-like fashion, grooves, channels, textured areas, protrusions, nubs, embossments, dimples, cones, trapezoids, columns, mini columns, porous, non-porous, mini ribs, cross-mini ribs, battlemented, and combinations thereof.

At least a portion of the first plurality of ribs may be defined by an angle that may be neither parallel nor orthogonal relative to an edge of the separator. Furthermore, the angle may be defined as an angle relative to a machine direction of the porous membrane and the angle may be one of the following: between greater than zero degrees (0°) and less than 180 degrees (180°), and greater than 180 degrees (180°) and less than 360 degrees (360°). In certain aspects of disclosed embodiments, the angle may vary throughout the plurality of ribs.

In certain select aspects of the present invention, the first plurality of ribs may have a cross-machine direction spacing pitch of approximately 1.5 mm to approximately 10 mm, and the plurality of teeth or discontinuous peaks or protrusions may have a machine direction spacing pitch of approximately 1.5 mm to approximately 10 mm.

In certain select embodiments, the separator may be provided with a second plurality of ribs extending from a second surface of the porous membrane. The second plurality of ribs may be one or more of the following: solid ribs, discrete broken ribs, continuous ribs, discontinuous ribs, discontinuous peaks, discontinuous protrusions, angled ribs, linear ribs, longitudinal ribs extending substantially in a machine direction of the porous membrane, lateral ribs extending substantially in a cross-machine direction of the porous membrane, transverse ribs extending substantially in the cross-machine direction of the separator, teeth, toothed ribs, battlements, battlemented ribs, curved ribs, sinusoidal ribs, disposed in a continuous zig-zag-sawtooth-like fashion, disposed in a broken discontinuous zig-zag-sawtooth-like fashion, grooves, channels, textured areas, embossments, dimples, columns, mini columns, porous, non-porous, mini ribs, cross-mini ribs, fissured cross mini ribs, and combinations thereof.

At least a portion of the second plurality of ribs may be defined by an angle that may be neither parallel nor orthogonal relative to an edge of the separator. Furthermore, the angle may be defined as an angle relative to a machine direction of the porous membrane and the angle may be one of the following: between greater than zero degrees (0°) and less than 180 degrees (180°), and greater than 180 degrees (180°) and less than 360 degrees (360°). In certain aspects of disclosed embodiments, the angle may vary throughout the plurality of ribs.

The second plurality of ribs have a cross-machine or machine direction spacing pitch of approximately 1.5 mm to approximately 10 mm.

The first surface may be provided with one or more ribs that are of a different height than the first plurality of ribs disposed adjacent to an edge of the lead acid battery separator. Likewise, the second surface may be provided with one or more ribs that are of a different height than the second plurality of ribs disposed adjacent to an edge of the lead acid battery separator.

In select embodiments, the polymer may be one of the following: a polymer, polyolefin, polyethylene, polypropylene, ultra-high molecular weight polyethylene (“UHMWPE”), phenolic resin, polyvinyl chloride (“PVC”), rubber, synthetic wood pulp (“SWP”), lignins, glass fibers, synthetic fibers, cellulosic fibers, and combinations thereof.

A fibrous mat may be provided. The mat may be one of the following: glass fibers, synthetic fibers, silica, at least one performance enhancing additive, latex, natural rubber, synthetic rubber, and combinations thereof, and may be nonwoven, woven, mesh, fleece, net, and combinations thereof.

In addition, the separator may be a cut-piece, a leaf, a pocket, a sleeve, a wrap, an envelope, and a hybrid envelope.

According to at least certain select exemplary embodiments, a separator may be provided with resilient means for mitigating separator deflection.

In accordance with at least certain select embodiments, a lead acid battery is provided with a positive electrode, and a negative electrode provided with swollen negative active material. A separator is provided with at least a portion of the separator being disposed between the positive electrode and the negative electrode. An electrolyte is provided that substantially submerges at least a portion of the positive electrode, at least a portion of the negative electrode, and at least a portion of the separator. In at least certain select embodiments, the separator may have a porous membrane made of at least a polymer and a filler. A first plurality of ribs may extend from a surface of the porous membrane. The ribs may be arranged such as to prevent acid starvation in the presence of NAM swelling. The lead acid battery may operate in any one or more of the following conditions: in motion, stationary, in a backup power application, in a cycling applications, in a partial state of charge, and any combination thereof.

The ribs may be provided with a plurality of teeth, or discontinuous peaks or protrusions. Each tooth, or discontinuous peak or protrusion may be at least approximately 1.5 mm from another of the plurality of discontinuous peaks. A continuous base portion may be provided, with the plurality of teeth, or discontinuous peaks or protrusions extending therefrom.

The first plurality of ribs may further be provided so as to enhance acid mixing in a battery, particularly during movement of the battery. The separator may be disposed parallel to a start and stop motion of the battery. The separator may be provided with a mat adjacent to the positive electrode, the negative electrode, or the separator. The mat may be at least partially made of glass fibers, synthetic fibers, silica, at least one performance enhancing additive, latex, natural rubber, synthetic rubber, and any combination thereof. The mat may be nonwoven, woven, mesh, fleece, net, and combinations thereof.

In at least certain select embodiments of the present invention, the lead acid battery may be a flat-plate battery, a flooded lead acid battery, an enhanced flooded lead acid battery (“EFB”), a valve regulated lead acid (“VRLA”) battery, a deep-cycle battery, a gel battery, an absorptive glass mat (“AGM”) battery, a tubular battery, an inverter battery, a vehicle battery, a starting-lighting-ignition (“SLI”) vehicle battery, an idling-start-stop (“ISS”) vehicle battery, an automobile battery, a truck battery, a motorcycle battery, an all-terrain vehicle battery, a forklift battery, a golf cart battery, a hybrid-electric vehicle battery, an electric vehicle battery, an e-rickshaw battery, or an e-bike battery, or any combination thereof.

In certain embodiments, the battery may operate at a depth of discharge of between approximately 1% and approximately 99%.

In accordance with at least one embodiment, a microporous separator with decreased tortuosity is provided. Tortuosity refers to the degree of curvature/turns that a pore takes over its length. Thus, a microporous separator with decreased tortuosity will present a shorter path for ions to travel through the separator, thereby decreasing electrical resistance. Microporous separators in accordance with such embodiments can have decreased thickness, increased pore size, more interconnected pores, and/or more open pores.

In accordance with at least certain selected embodiments, a microporous separator with increased porosity, or a separator with a different pore structure whose porosity is not significantly different from a known separator, and/or decreased thickness is provided. An ion will travel more rapidly though a microporous separator with increased porosity, increased void volume, reduced tortuosity, and/or decreased thickness, thereby decreasing electrical resistance. Such decreased thickness may result in decreased overall weight of the battery separator, which in turn decreases the weight of the enhanced flooded battery in which the separator is used, which in turn decreases the weight of the overall vehicle in which the enhanced flooded battery is used. Such decreased thickness may alternatively result in increased space for the positive active material (“PAM”) or the negative active material (“NAM”) in the enhanced flooded battery in which the separator is used.

In accordance with at least certain selected embodiments, a microporous separator with increased wettability (in water or acid) is provided. The separator with increased wettability will be more accessible to the electrolyte ionic species, thus facilitating their transit across the separator and decreasing electrical resistance.

In accordance with at least one embodiment, a microporous separator with decreased final oil content is provided. Such a microporous separator will also facilitate lowered ER (electrical resistance) in an enhanced flooded battery or system.

The separator may contain improved fillers that have increased friability, and that may increase the porosity, pore size, internal pore surface area, wettability, and/or the surface area of the separator. In some embodiments, the improved fillers have high structural morphology and/or reduced particle size and/or a different amount of silanol groups than previously known fillers and/or are more hydroxylated than previously known fillers. The improved fillers may absorb more oil and/or may permit incorporation of a greater amount of processing oil during separator formation, without concurrent shrinkage or compression when the oil is removed after extrusion. The fillers may further reduce what is called the hydration sphere of the electrolyte ions, enhancing their transport across the membrane, thereby once again lowering the overall electrical resistance or ER of the battery, such as an enhanced flooded battery or system.

The filler or fillers may contain various species (such as polar species, such as metals) that increase the ionic diffusion, and facilitate the flow of electrolyte and ions across the separator. Such also leads to decreased overall electrical resistance as such a separator is used in a flooded battery, such as an enhanced flooded battery.

The microporous separator further comprises a novel and improved pore morphology and/or novel and improved fibril morphology such that the separator contributes to significantly decreasing the electrical resistance in a flooded lead acid battery when such a separator is used in such a flooded lead acid battery. Such improved pore morphology and/or fibril morphology may result in a separator whose pores and/or fibrils approximate a shish-kebab (or shish kabob) type morphology. Another way to describe the novel and improved pore shape and structure is a textured fibril morphology in which silica nodes or nodes of silica are present at the kebab-type formations on the polymer fibrils (the fibrils sometimes called shishes) within the battery separator. Additionally, in certain embodiments, the silica structure and pore structure of a separator according to the present invention may be described as a skeletal structure or a vertebral structure or spinal structure, where silica nodes on the kebabs of polymer, along the fibrils of polymer, appear like vertebrae or disks (the “kebabs”), and sometimes are oriented substantially perpendicularly to, an elongate central spine or fibril (extended chain polymer crystal) that approximates a spinal column-like shape (the “shish”).

In some instances, the improved battery comprising the improved separator with the improved pore morphology and/or fibril morphology may exhibit 20% lower, in some instances, 25% lower, in some instances, 30% lower electrical resistance, and in some instances, even more than a 30% drop in electrical resistance (“ER”) (which may reduce battery internal resistance) while such a separator retains and maintains a balance of other key, desirable mechanical properties of lead acid battery separators. Further, in certain embodiments, the separators described herein have a novel and/or improved pore shape such that more electrolyte flows through or fills the pores and/or voids as compared to known separators.

In addition, the present disclosure provides improved enhanced flooded lead acid batteries comprising one or more improved battery separators for an enhanced flooded battery, which separator combines for the battery the desirable features of decreased acid stratification, lowered voltage drop (or an increase in voltage drop durability), and increased CCA, in some instances, more than 8%, or more than 9%, or in some embodiments, more than 10%, or more than 15%, increased CCA. Such an improved separator may result in an enhanced flooded battery whose performance matches or even exceeds the performance of an AGM battery. Such low electrical resistance separator may also be treated so as to result in an enhanced flooded lead acid battery having reduced water loss.

The separator may contain one or more performance enhancing additives, such as a surfactant, along with other additives or agents, residual oil, and fillers. Such performance enhancing additives can reduce separator oxidation and/or even further facilitate the transport of ions across the membrane contributing to the overall lowered electrical resistance for the enhanced flooded battery described herein.

The separator for a lead acid battery described herein may comprise a polyolefin microporous membrane, wherein the polyolefin microporous membrane comprises: polymer, such as polyethylene, such as ultrahigh molecular weight polyethylene, particle-like filler, and processing plasticizer (optionally with one or more additional additives or agents). The polyolefin microporous membrane may comprise the particle-like filler in an amount of 40% or more by weight of the membrane. And the ultrahigh molecular weight polyethylene may comprise polymer in a shish-kebab formation comprising a plurality of extended chain crystals (the shish formations) and a plurality of folded chain crystals (the kebab formations), wherein the average repetition or periodicity of the kebab formations is from 1 nm to 150 nm, preferably, from 10 nm to 120 nm, and more preferably, from 20 nm to 100 nm (at least on portions of the rib side of the separator).

The average repetition or periodicity of the kebab formations is calculated in accordance with the following definition:
The surface of the polyolefin microporous membrane is observed using a scanning electron microscope (“SEM”) after being subjected to metal vapor deposition, and then the image of the surface is taken at, for example 30,000 or 50,000-fold magnification at 1.0 kV accelerating voltage.
In the same visual area of the SEM image, at least three regions where shish-kebab formations are continuously extended in the length of at least 0.5 μm or longer are indicated. Then, the kebab periodicity of each indicated region is calculated.
The kebab periodicity is specified by Fourier transform of concentration profile (contrast profile) obtained by projecting in the vertical direction to the shish formation of the shish-kebab formation in each indicated region to calculate the average of the repetition periods.
The images are analyzed using general analysis tools, for example, MATLAB (R2013a).
Among the spectrum profiles obtained after the Fourier transform, spectrum detected in the short wavelength region are considered as noise. Such noise is mainly caused by deformation of contrast profile. The contrast profiles obtained for separators in accordance with the present invention appear to generate square-like waves (rather than sinusoidal waves). Further, when the contrast profile is a square-like wave, the profile after the Fourier transform becomes a Sine function and therefore generates plural peaks in the short wavelength region besides the main peak indicating the true kebab periodicity. Such peaks in the short wavelength region can be detected as noise.

In some embodiments, the separator for a lead acid battery described herein comprises a filler selected from the group consisting of silica, precipitated silica, fumed silica, and precipitated amorphous silica; wherein the molecular ratio of OH to Si groups within said filler, measured by ²⁹Si-NMR, is within a range of from 21:100 to 35:100, in some embodiments, 23:100 to 31:100, in some embodiments, 25:100 to 29:100, and in certain preferred embodiments, 27:100 or higher.

Silanol groups change a silica structure from a crystalline structure to an amorphous structure, since the relatively stiff covalent bond network of Si—O has partially disappeared. The amorphous-like silicas such as Si(—O—Si)₂(—OH)₂ and Si(—O—Si)₃(—OH) have plenty of distortions, which may function as various oil absorption points. Therefore oil absorbability becomes high when the amount of silanol groups (Si—OH) is increased for the silica. Additionally, the separator described herein may exhibit increased hydrophilicity and/or may have higher void volume and/or may have certain aggregates surrounded by large voids when it comprises a silica comprising a higher amount of silanol groups and/or hydroxyl groups than a silica used with a known lead acid battery separator.

The microporous separator further comprises a novel and improved pore morphology and/or novel and improved fibril morphology such that the separator contributes to significantly decreasing the electrical resistance in a flooded lead acid battery when such a separator is used in such a flooded lead acid battery. Such improved pore morphology and/or fibril morphology may result in a separator whose pores and/or fibrils approximate a shish-kebab (or shish kabob) type morphology. Another way to describe the novel and improved pore shape and structure is a textured fibril morphology in which silica nodes or nodes of silica are present at the kebab-type formations on the polymer fibrils (the fibrils sometimes called shishes) within the battery separator. Additionally, in certain embodiments, the silica structure and pore structure of a separator according to the present invention may be described as a skeletal structure or a vertebral structure or spinal structure, where silica nodes on the kebabs of polymer, along the fibrils of polymer, appear like vertebrae or disks (the “kebabs”), and sometimes are oriented substantially perpendicularly to, an elongate central spine or fibril (extended chain polymer crystal) that approximates a spinal column-like shape (the “shish”).

In certain selected embodiments, a vehicle may be provided with a lead acid battery as generally described herein. The battery may further be provided with a separator as described herein. The vehicle may be an automobile, a truck, a motorcycle, an all-terrain vehicle, a forklift, a golf cart, a hybrid vehicle, a hybrid-electric vehicle battery, an electric vehicle, an idling-start-stop (“ISS”) vehicle, an e-rickshaw, an e-bike, an e-bike battery, and combinations thereof.

In certain preferred embodiments, the present disclosure or invention provides a flexible battery separator whose components and physical attributes and features synergistically combine to address, in unexpected ways, previously unmet needs in the deep cycle battery industry, with an improved battery separator (a separator having a porous membrane of polymer, such as polyethylene, plus a certain amount of a performance enhancing additive and ribs) that meets or, in certain embodiments, exceeds the performance of the previously known flexible, which are currently used in many deep cycle battery applications. In particular, the inventive separators described herein are more robust, less fragile, less brittle, more stable over time (less susceptible to degradation) than separators traditionally used with deep cycle batteries. The flexible, performance enhancing additive-containing and rib possessing separators of the present invention combine the desired robust physical and mechanical properties of a polyethylene-based separator with the capabilities of a conventional separator, while also enhancing the performance of the battery system employing the same.

In accordance with at least selected embodiments, the present disclosure or invention may address the above issues or needs. In accordance with at least certain objects, the present disclosure or invention may provide an improved separator and/or battery which overcomes the aforementioned problems, for instance by providing enhanced flooded batteries having reduced acid starvation, reduced acid stratification, reduced dendrite growth, reduced internal electrical resistance and increased cold cranking amps.

### BRIEF DESCRIPTION OF THE FIGURES

FIG. 1A illustrates a typical lead acid battery. FIG. 1B depicts an exemplary array of alternating electrodes and battery separators interleafed therebetween.

FIG. 2 depicts a typical battery separator disposed between two electrodes without any active material swelling.

FIG. 3 depicts a typical battery separator disposed between two electrodes with swollen negative active material as may be found in a typical lead acid battery, especially one that is in a partial state of charge, and especially one that is rarely overcharged.

FIG. 4 depicts an exemplary embodiment of a battery separator of the present invention disposed between a positive electrode and negative electrode as may be found in a typical lead acid battery; the negative electrode is shown with swollen NAM.

FIGS. 5A-5D illustrate an exemplary embodiment of a rib profile for an exemplary embodiment of an acid mixing or resilient separator of the present invention.

FIGS. 6A and 6B illustrate an electrode surface and the portions supported by an inventive separator.

FIGS. 7A-7C illustrate various exemplary negative rib configurations believed to mitigate dendrite formation and migration.

FIGS. 8 and 9 are illustrations of a test set up for mimicking NAM swelling to evaluate separator resilience.

FIG. 10 is a photographic evaluation for separator resilience.

FIG. 11 is a photographic evaluation for separator acid mixing.

FIG. 12 depicts the particle size distribution of the new silica and standard silica before sonication and after 30 seconds of sonication and after 60 seconds of sonication.

FIG. 13 depicts the size of a standard silica with that of a silica used in an inventive embodiment of the present invention.

FIG. 14 shows the size of a new silica before and after sonication.

FIG. 15 illustrates a tip used to puncture test separators.

FIG. 16A is a schematic rendering of an elongation test sample. FIGS. 16B and 16C illustrate a sample holder for an elongation test.

FIG. 17A includes an SEM of the inventive separator of Example 1. FIGS. 17B-17D include Welch Power Spectral Density Estimate graphs showing results from the FTIR spectral tests performed on the three shish-kebab regions (Nos. 1, 2, and 3), respectively, shown and marked in FIG. 17A, wherein the x-axis of the graphs in FIGS. 17A-17D is normalized frequency (x λrad/sample), and wherein the y-axis of those graphs=power/frequency (dB/rad/sample).

FIGS. 18A-18D are similar to FIGS. 17A-17D, respectively, but are representative of the inventive separator of Example 2.

FIGS. 19A-19D are similar to FIGS. 17A-17D, respectively, but are representative of the inventive separator of Example 3.

FIGS. 20A-20D are similar to FIGS. 17A-17D, respectively, but are representative of the inventive separator of Example 4.

FIGS. 21A-21D are similar to FIGS. 17A-17D, respectively, but are representative of the inventive separator of Example 5.

FIGS. 22A-22D are similar to FIGS. 17A-17D, respectively, but are representative of the separator of Comparative Example 1 (CE1).

FIGS. 23A and 23B are similar to FIGS. 17A and 17B, respectively, but are representative of the separator of Comparative Example 2.

FIG. 24 is an SEM of the separator of Comparative Example 3.

FIG. 25 includes ²⁹Si-NMR spectra for Comparative Example 4 and Example 1, respectively.

FIG. 26 includes deconvolution of the component peaks from the spectra of FIG. 25 to determine the Q₂:Q₃:Q₄ ratios for the separator samples of Comparative Example 4 and Example 1, respectively.

FIG. 27 shows a Nuclear Magnetic Resonance (“NMR”) tube with separator samples submerged in D2O.

FIG. 28 shows the diffusion coefficients at −10° C. at A=20 ms for a solution of H₂SO₄ only, a reference separator, an inventive embodiment separator, and an AGM separator.

FIG. 29 illustrates a pore size distribution of an inventive embodiment compared to that of a commercially available separator.

FIG. 30 depicts the pore diameter distribution of an inventive embodiment separator.

FIG. 31 is a chart that describes the dispersion of a new silica filler within an inventive embodiment separator and a standard silica within a commercially available separator.

FIG. 32 includes a depiction of the pore size distribution of an embodiment of the instant invention, a lower ER separator, in comparison with a conventional separator.

FIG. 33 includes a depiction of the oxidation stability of an embodiment of the instant invention (sometimes referred to as the “EFS” product, an Enhanced Flooded Separator™) in comparison with a conventional separator. In the battery overcharge test, after 1,000 hours, the separator according to the present invention is less brittle than the control separator and thus exhibits higher elongation.

FIG. 34 includes a depiction of the electrical resistance data of separators prepared with different silica fillers. The silica fillers differ in their intrinsic oil absorption. In certain embodiments of the present invention, the improved separator is formed using a silica having an intrinsic oil absorption value of about 175-350 ml/100 g, in some embodiments, 200-350 ml/100 g, in some embodiments, 250-350 ml/100 gm, and in some further embodiments, 260-320 ml/100 g, though other oil absorption values are possible as well.

FIG. 35 includes a depiction of the electrical resistance data of separators prepared with different process oils. The oils differ in their aniline point.

FIG. 36 includes a depiction of acid stratification (%) versus Hg porosity (%) for separators according to the present invention.

FIG. 37 includes a depiction of ER boil versus backweb thickness.

FIG. 38 includes an SEM image of an embodiment of a separator of the instant invention at 50,000× magnification, while FIGS. 39A and 39B are SEM images of the same separator at 10,000× magnification. In the SEM of FIG. 38, the shish kebab-type morphology or textured fibril-type structure is observed, and the pore and silica structure leaves certain cavities or pores with much less polymer webbing (in some cases almost no polymer webbing) and much fewer thick fibrils or strands of hydrophobic polymer (in some cases almost no or no thick fibrils or strands of hydrophobic polymer). Electrolyte and/or acid, and therefore ions pass much more readily through the pore structure observed in this separator shown in FIGS. 38-39B. The structure of the separator provides free space in which acid freely moves.

FIGS. 40A and 40B include depictions of the pore size distribution of separator embodiments. FIG. 40A is for a control separator, while FIG. 40B is for a low ER separator with desirable mechanical properties according to one embodiment of the present invention. Note that FIG. 40B can also be seen as part of FIG. 32.

FIG. 41 includes a comparison of various pore size measurements for a separator according to the instant invention with a conventional separator. In FIG. 41, the bubble flow rate difference is significant in that it is measuring the through-pores of the separator and measuring the ability of such through-pores to functionally transport ions all the way through the separator. While the mean pore size and the minimum pore size are not significantly different, the maximum pore size is greater for the separator according to the present invention, and the bubble flow rate is significantly higher for the separator according to the present invention.

FIGS. 42A and 42B show porometry data and a depiction of the flow of liquid through a separator in accordance with an embodiment of the invention (FIG. 42A) in comparison with flow of liquid through a control separator (FIG. 42B).

FIGS. 43A and 43B includes two SEMs at two different magnifications of a control separator made by Daramic, LLC. In these SEMs, relatively thick fibrils or strands of hydrophobic polymer are observed.

FIGS. 44A and 44B includes two SEMs at two different magnifications of another control separator made by Daramic, LLC. In these SEMs, areas that appear to be polymer webbing can be observed.

FIG. 45A includes an SEM of a separator formed according to an embodiment of the present invention, wherein the shish-kebab polymer formation(s) are observed. FIG. 45B portrays how a Fourier transform contrast profile (spectrum at the bottom of FIG. 45B) helps determine the repetition or periodicity of the shish-kebab formations (see shish-kebab formation at the top of FIG. 45B) in the separator.

### DETAILED DESCRIPTION

In accordance with at least select embodiments, the present disclosure or invention may address the above issues or needs. In accordance with at least certain objects, aspects, or embodiments, the present disclosure or invention may provide an improved separator and/or battery which overcomes the aforementioned problems, for instance by providing batteries with separators that reduce acid starvation and/or mitigate the effects of acid starvation.

In accordance with at least select embodiments, the present disclosure or invention is directed to novel or improved separators, cells, batteries, systems, and/or methods of manufacture and/or use of such novel separators, cells, and/or batteries. In accordance with at least certain embodiments, the present disclosure or invention is directed to novel or improved battery separators for flat-plate batteries, tubular batteries, flooded lead acid batteries, enhanced flooded lead acid batteries (“EFBs”), deep-cycle batteries, gel batteries, absorptive glass mat (“AGM”) batteries, inverter batteries, solar or wind power storage batteries, vehicle batteries, starting-lighting-ignition (“SLI”) vehicle batteries, idling-start-stop (“ISS”) vehicle batteries, automobile batteries, truck batteries, motorcycle batteries, all-terrain vehicle batteries, forklift batteries, golf cart batteries, hybrid-electric vehicle batteries, electric vehicle batteries, e-rickshaw batteries, e-bike batteries, and/or improved methods of making and/or using such improved separators, cells, batteries, systems, and/or the like. In addition, disclosed herein are methods, systems and battery separators for enhancing battery performance and life, reducing battery failure, reducing acid stratification, mitigating dendrite formation, improving oxidation stability, improving, maintaining, and/or lowering float current, improving end of charge current, decreasing the current and/or voltage needed to charge and/or fully charge a deep cycle battery, reducing internal electrical resistance, reducing antimony poisoning, increasing wettability, improving acid diffusion, improving uniformity in a lead acid battery, and/or improving cycle performance. In accordance with at least particular embodiments, the present disclosure or invention is directed to an improved separator wherein the novel separator includes decreased electrical resistance, performance enhancing additives or coatings, improved fillers, increased wettability, increased acid diffusion, negative cross ribs, and/or the like.

As can be seen in Eq. 2, the discharging reaction converts a portion of the lead (Pb), which may also present in the NAM, and the acid (H₂SO₄) into lead sulfate (PbSO₄), which is a larger molecule. As the lead sulfate is a larger molecule that the lead, it occupies a larger volume and, as will be discussed hereinafter, is believed to contribute to NAM swelling. Because the lead sulfate is formed during discharge, batteries operating in a partial state of charge (i.e., at least partially discharged) are more susceptible to NAM swelling. Such batteries include those operating in: hybrid vehicles; hybrid-electric vehicles; idling-start-stop (“ISS”) vehicles; electric vehicles, such as forklifts, golf carts, e-rickshaws, e-trikes, and e-bikes; inverters; and renewable and/or alternative energy systems, such as solar power systems and wind power systems. Batteries in these applications may likely be operating at a partial state of charge and may experience negative active material swelling.

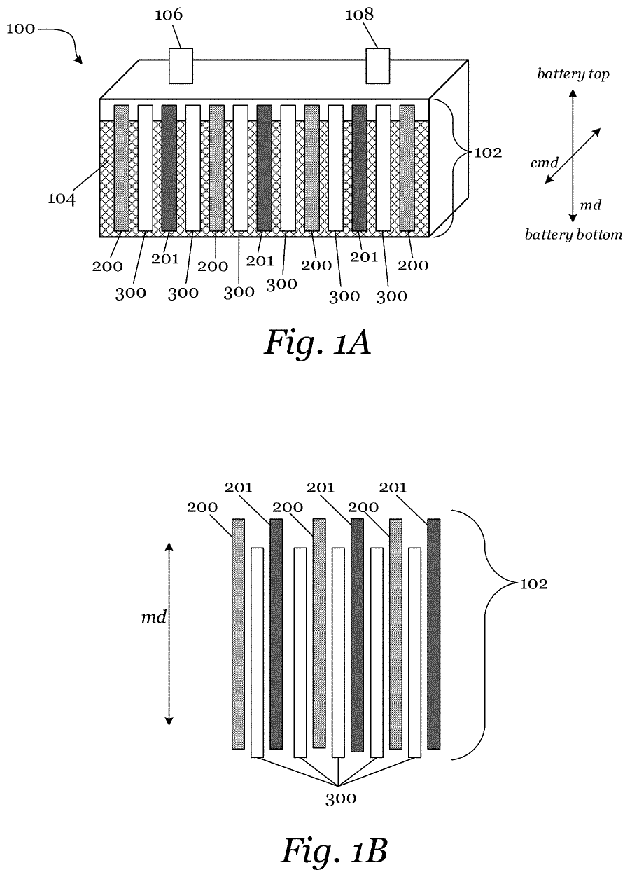

Referring now to FIG. 1A, an exemplary lead acid battery 100 is provided with an array 102 of alternating positive electrodes 200 and negative electrodes 201, and a separator 300 interlayered therebetween each positive electrode 200 and negative electrode 201. The electrodes 200, 201 and separators 300 are substantially submerged in a sulfuric acid (H₂SO₄) electrolyte 104. The positive electrodes 200 are in electrical communication with the positive terminal 106, and negative electrodes 201 are in electrical communication with the negative terminal 108. Alternatively, the separators may be formed as pockets or envelopes and envelope either the positive electrodes 200 or the negative electrodes 201.

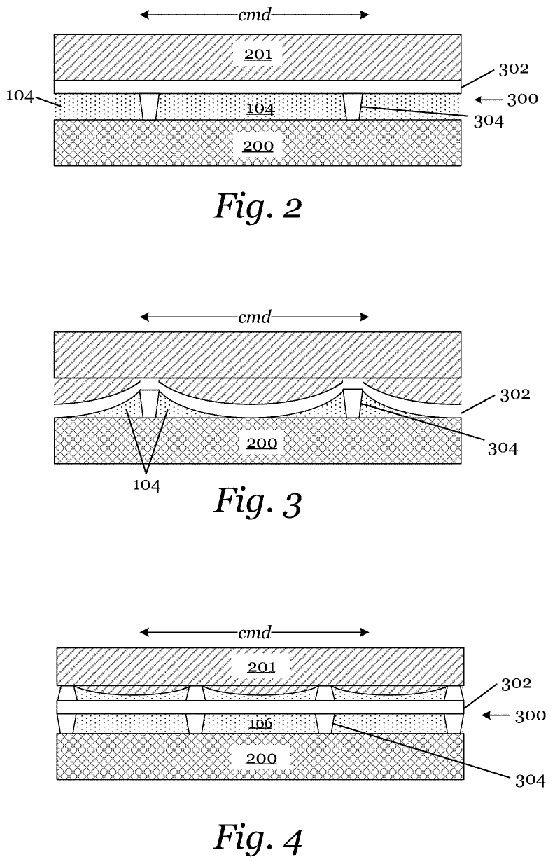

With reference now to FIG. 2, a partial exemplary array 102 is depicted looking down from the top of the battery (not shown). The separator 300 is depicted with a porous membrane 302 and a series of positive ribs 304 extending therefrom in contact with the positive electrode 200. Though not shown, negative mini ribs may be present and in contact with the negative electrode 201.

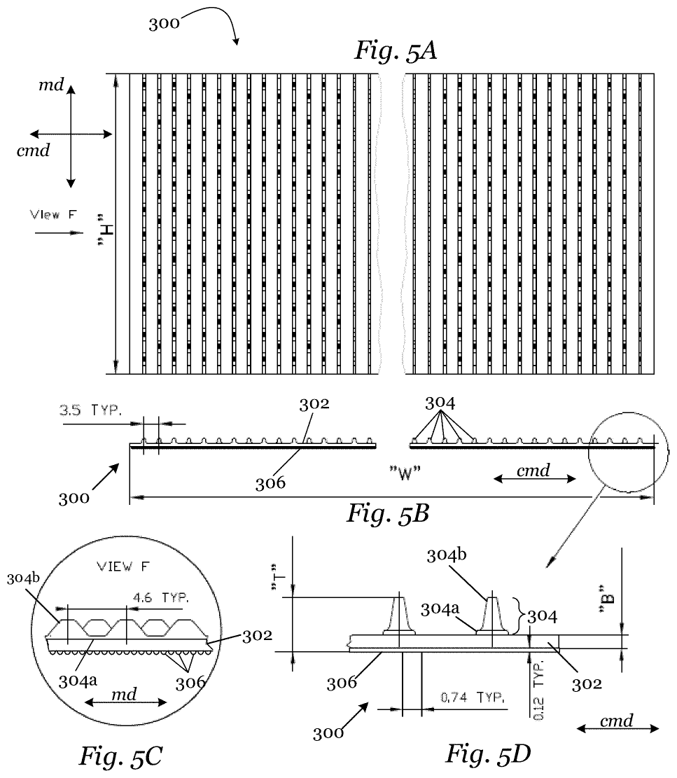

As a battery cycles through charging and discharging cycles, the negative active material (“NAM”) that the negative electrode 201 is doped with begins to expand. Without wishing to be bound by any particular theory, it is believed that NAM swelling may occur to the extent that it exerts pressure on the separator backweb 302 to the point when the backweb 302 contacts the positive electrode 200. Thus, starving the positive electrode 200 and the negative electrode 201 of electrolyte 104. This is known as acid starvation and can severely affect the performance and/or life of the battery. Acid starvation can still occur even if the backweb 302 does not contact the positive electrode 200. This is because the NAM can still swell to the point of squeezing electrolyte 104 from being in contact with the negative electrode 201 and still deflect the backweb 302 enough to squeeze some electrolyte 104 away from the positive electrode 200. FIG. 3 is a schematic depiction of this exertion on the separator backweb 302 to the point that the backweb 302 contacts the positive electrode 200.

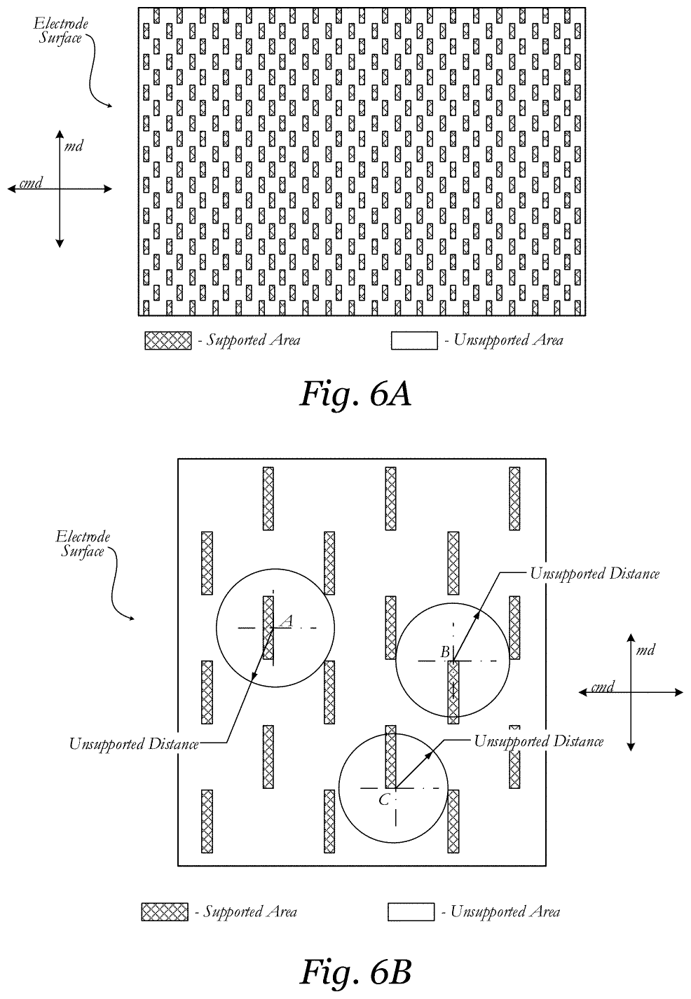

Referring now to FIG. 4, a schematic of a particular exemplary separator 300 of the present invention is shown. In this example embodiment, the separator 300 is provided with ribs 106 extending in the machine direction of the separator that contact the negative electrode (i.e., negative ribs). This provides support of the NAM and spacing between the NAM and the backweb 302 such that the NAM does not even contact the separator backweb 302 and therefore cannot deflect it. It should be noted that FIGS. 2-4 are not drawn to scale.

As discussed herein, current separators marketed, sold, and used in flooded lead acid batteries, particularly enhanced flooded lead acid batteries that operate or are intended to operate at a partial state of charge exhibit the above-described NAM swelling, and squeezing and displacement of acid, which eventually leads to an inoperable battery. Thus, there is a need for improved separators for flooded lead acid batteries, particularly enhanced flooded lead acid batteries that operate at a partial state of charge, (e.g., those used in start/stop vehicles).

Physical Description

An exemplary separator may be provided with a web of a porous membrane, such as a microporous membrane having pores less than about 5 μm, preferably less than about 1 μm, a mesoporous membrane, or a macroporous membrane having pores greater than about 1 μm. The porous membrane may preferably have a pore size that is sub-micron up to 100 μm, and in certain embodiments between about 0.1 μm to about 10 μm. Porosity of the separator membrane described herein may be greater than 50% to 60% in certain embodiments. In certain select embodiments, the porous membrane may be flat or possess ribs that extend from a surface thereof.

Ribs

Particular goals of the present invention include minimizing the effects of NAM swelling (e.g., acid starvation) while also taking advantage of any motion that the battery may be subject to maximize acid mixing to reduce the effects of acid stratification. Both of these are problems exhibited by batteries operating in a partial state of charge.

The inventors have found that one way to minimize the effects of NAM swelling is to maximize the resiliency of the separator such as to reduce the likelihood that the NAM will deflect the porous backweb into the positive active material (“PAM”). A particular method of increasing the separator resiliency is to increase the porous membrane backweb thickness. This however also increases the separator's electrical resistance (to name but one detriment of a thicker backweb) which negatively affects the performance of the battery. The inventors have discovered that increasing the contact points between the separator and the positive electrode acts to stiffen the backweb between contact points. Increasing the number of ribs to achieve this goal also increases the amount of contact area between the separator and positive electrode. Minimizing the contact area is believed to lower the electrical resistance of the separator as well as opening more surface area of the electrodes to the electrolyte for the electrochemical reactions that provide the functionality of the battery. It is also believed that the reduced contact area reduces the opportunities for dendrites to form through the separator and cause an electrical short. The issue of dendrite formation is discussed hereinafter. A further goal is to maximize electrolyte or acid mixing for batteries that are used in motion in order to minimize the effects of acid stratification. Furthermore, solid ribs do not facilitate the goal of acid mixing to reduce acid stratification.

The inventors have found that a separator may be provided with resilient means to resist or mitigate backweb deflection under the forces and pressures exerted by NAM swelling, which leads to acid starvation, by maximizing the number of contact points while simultaneously minimizing the contact area between the separator and the adjacent electrodes as a select exemplary preferred embodiment. The inventors have found another select exemplary embodiment may provide a separator with acid mixing means for reducing, mitigating, or reversing the effects of acid stratification by maximizing the number of discrete contact points between the separator and the adjacent electrodes. Another select exemplary embodiment may provide the separator with dendrite mitigation means to reduce or mitigate lead sulfate (PbSO₄) dendrite growth. The inventors have determined that such resilient means, acid mixing means, and dendrite mitigation means may be addressed, achieved, or at least partially addressed and/or achieved by the design of the rib structure. Accordingly, select embodiments described herein rely on rib structure in order to balance these parameters to achieve the desired goals, to provide resilient means, acid mixing means, and dendrite mitigation means, and/or to at least partially address and/or achieve balance of these parameters and/or the desired resilient means, acid mixing means, and/or dendrite mitigation means.

The ribs 304, 306 may be a uniform set, an alternating set, or a mix or combination of solid, discrete broken ribs, continuous, discontinuous, angled, linear, longitudinal ribs extending substantially in a machine direction (“MD”) (i.e., running from top to bottom of the separator in the battery) of the separator, lateral ribs extending substantially in a cross-machine direction CMD of the separator, transverse ribs extending substantially in a cross-machine direction (“CMD”) (i.e., in a lateral direction of the separator in the battery, orthogonal to the MD) of the separator, cross ribs extending substantially in a cross-machine direction of the separator, discrete teeth or toothed ribs, serrations, serrated ribs, battlements or battlemented ribs, curved or sinusoidal, disposed in a solid or broken zig-zag-like fashion, grooves, channels, textured areas, embossments, dimples, porous, non-porous, mini ribs or cross-mini ribs, and/or the like, and combinations thereof. Further, either set of the ribs 304, 306 may extend from or into the positive side, the negative side, or both sides.

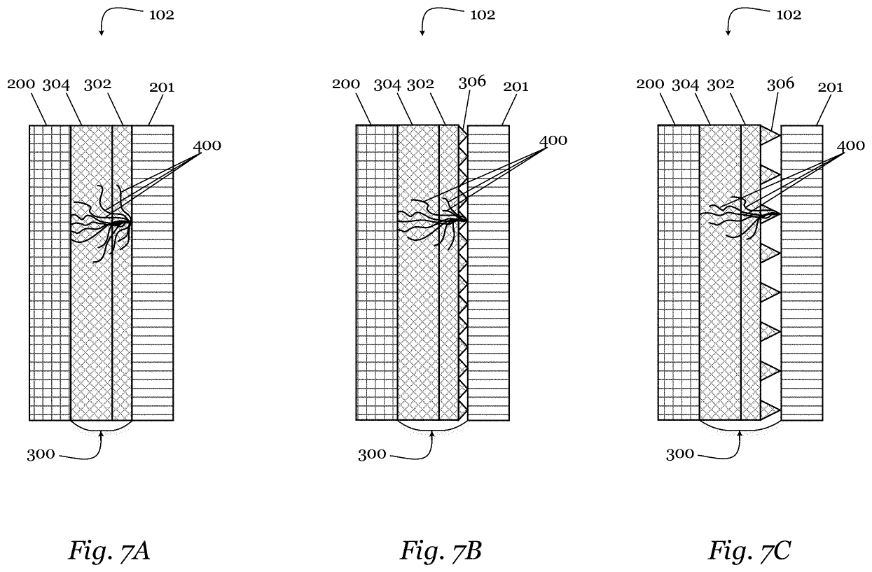

Referring now to FIGS. 5A-5D, an exemplary separator is provided with positive ribs 304 substantially aligned in a machine direction (“MD”) of the separator that are intended to contact a positive electrode in an exemplary battery. The separator is further provided with negative ribs 306 substantially aligned in a machine direction of the separator and substantially parallel to the positive ribs. The negative ribs are intended to contact a negative electrode in an exemplary battery. While the negative ribs in this illustrated example are substantially aligned in a machine direction of the separator, they may alternatively be substantially aligned in the cross-machine direction, typically known as negative cross-ribs.

With continued reference to FIGS. 5A-5D, select embodiments of the inventive separator are provided with an array of positive ribs. The positive ribs are provided with a base portion 304a that may extend the length of the separator in the machine direction. Spaced teeth, discontinuous peaks, or other protrusions 304b may then extend from the surface of that base portion, such that the teeth 304b are raised above the underlying surface of the porous membrane backweb. Furthermore, the base portion may be wider than the teeth themselves. The positive ribs run substantially parallel to one another at a typical spacing of approximately 2.5 mm to approximately 6.0 mm, with a typical spacing of approximately 3.5 mm. The height of the positive ribs (combined teeth and base portion) as measured from the surface of then porous membrane backweb may be approximately 10 μm to approximately 2.0 mm, with a typical height of approximately 0.5 mm. Exemplary rib teeth of adjacent ribs may be substantially in line with one another. However as pictured in FIGS. 5A-5D, exemplary teeth may be offset from one another from one rib to an adjacent rib, either entirely or partially out of phase from an adjacent rib. As shown, the teeth are entirely out of phase from one rib to an adjacent rib. The positive rib teeth may be spaced at a pitch in the machine direction of the separator of approximately 3.0 mm to approximately 6.0 mm, with a typical spacing of approximately 4.5 mm.

As shown in FIGS. 5A-5D, negative ribs 306 are depicted as being substantially parallel to the machine direction of the separator. However, they may alternatively be substantially parallel to a cross machine direction. The depicted exemplary negative ribs are shown as being solid and substantially straight. However, they may alternatively be toothed in a generally similar manner as the shown positive ribs 304. The negative ribs 306 may be spaced at a pitch of approximately 10 μm to approximately 10.0 mm, with a preferred pitch between approximately 700 μm and approximately 800 μm, with a more preferred nominal pitch of approximately 740 μm. The height of the negative ribs as measured from the surface of the backweb may be approximately 10 μm to approximately 2.0 mm.

It should be noted that the positive ribs may alternatively be placed in an exemplary battery such that they contact the negative electrode. Likewise, the negative ribs may alternatively be placed in an exemplary battery such that they contact the positive electrode.

Table 1, below, details the rib count and the percentage of surface contact area for four separators (one exemplary inventive separator and three control separators) that are 162 mm by 162 mm (262 cm²). As shown, the exemplary inventive separator has 43 toothed ribs uniformly spaced across the width of the separator in the cross-machine direction. The teeth of the positive ribs on the exemplary inventive separator contacts 3.8% of the 262 cm² on the positive electrode. The details of the control separators are further detailed in Table 1. It is appreciated that control separators #1, #2, and #3 are typical of commercially available separators presently used flooded lead acid batteries generally and presently available on the market.

TABLE 1

| | Ribs | Contact area |
|---|---|---|
| | (No. | (% of |
| Separator | (configuration)) | total area) |
| Inventive Separator | 43 (toothed ribs) | 3.8% |
| Control #1 | 22 (solid ribs) | 4.8% |
| Control #2 | 18 (solid ribs) | 3.9% |
| Control #3 | 11 (solid ribs) | 2.9% |

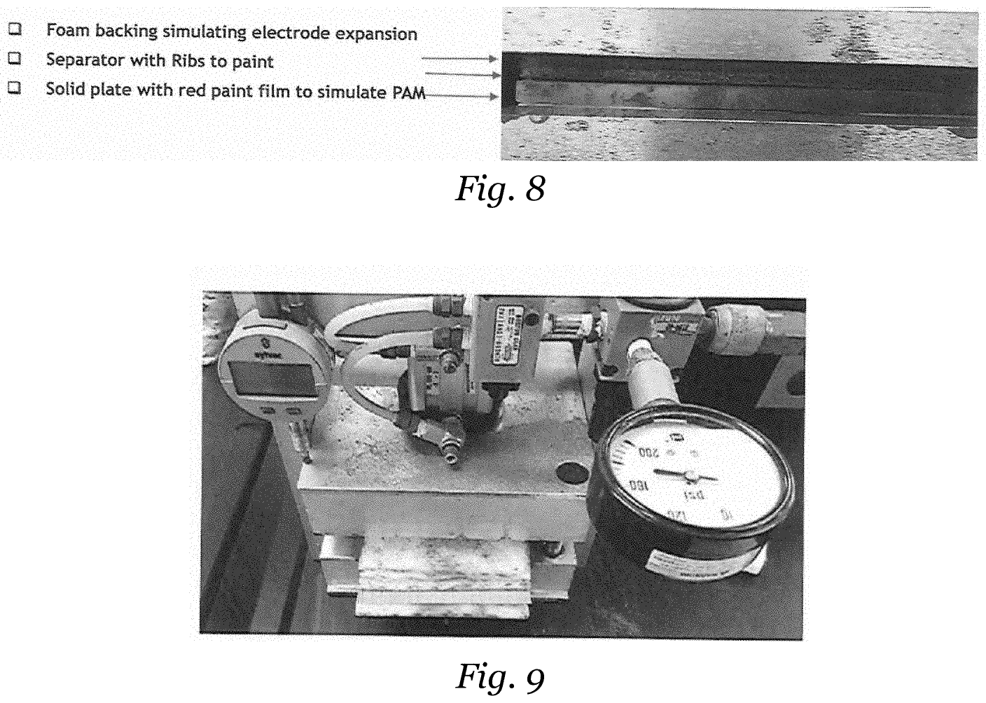

As stated, the inventors found that maximizing the number of contact points while simultaneously minimizing the contact area achieves the goal of increasing separator resiliency while keeping electrical resistance under control. Furthermore, the toothed design helps facilitate acid mixing by utilizing any motion to which a battery may be subjected. With reference to FIGS. 6A and 6B, the teeth of the separator ribs may be approximately 1.5 mm to approximately 6.0 mm apart from the closest adjacent tooth as identified by the encompassing circles about points A, B, and C. The inventors have found that a preferred, non-limiting, distance is approximately 2.0 mm between adjacent teeth. In addition, the teeth being offset from adjacent rows being completely out of phase helps to facilitate acid mixing. The inventors have also found that the base portion helps to stiffen the backweb enough to provide resilience to the NAM swelling.

It is appreciated that while the exemplary inventive ribs are shown and described herein as being positive ribs 304, they may nonetheless be provided on the negative side of the separator, and the illustrated and described negative ribs 306 may be provided on the positive side of the separator.

The positive or negative ribs may additionally be any form or combination of solid ribs, discrete broken ribs, continuous ribs, discontinuous ribs, angled ribs, linear ribs, longitudinal ribs extending substantially in a machine direction of said porous membrane, lateral ribs extending substantially in a cross-machine direction of said porous membrane, transverse ribs extending substantially in said cross-machine direction of the separator, discrete teeth, toothed ribs, serrations, serrated ribs, battlements, battlemented ribs, curved ribs, sinusoidal ribs, disposed in a continuous zig-zag-sawtooth-like fashion, disposed in a broken discontinuous zig-zag-sawtooth-like fashion, grooves, channels, textured areas, embossments, dimples, columns, mini columns, porous, non-porous, mini ribs, cross-mini ribs, and combinations thereof.

The positive or negative ribs may additionally be any form or combination of being defined by an angle that is neither parallel nor orthogonal relative to an edge of the separator. Furthermore, that angle may vary throughout the teeth or rows of the ribs. The angled rib pattern may be a possibly preferred Daramic® RipTide™ acid mixing rib profile that can help reduce or eliminate acid stratification in certain batteries. Moreover, the angle may be defined as being relative to a machine direction of the porous membrane and the angle may between approximately greater than zero degrees (0°) and approximately less than 180 degrees (180°), and approximately greater than 180 degrees (180°) and approximately less than 360 degrees (360°).

The ribs may extend uniformly across the width of the separator, from lateral edge to lateral edge. This is known as a universal profile. Alternatively, the separator may have side panels adjacent to the lateral edges with minor ribs disposed in the side panel. These minor ribs may be more closely spaced and smaller than the primary ribs. For instance, the minor ribs may be 25% to 50% of the height of the primary ribs. The side panels may alternatively be flat. The side panels may assist in sealing an edge of the separator to another edge of the separator as done when enveloping the separator, which is discussed hereinbelow.

In select exemplary embodiments, at least a portion of the negative ribs may preferably have a height of approximately 5% to approximately 100% of the height of the positive ribs. In some exemplary embodiments, the negative rib height may be approximately 5%, 10%, 15%, 20%, 25%, 30%, 35%, 40%, 45%, 50%, 55%, 60%, 65%, 70%, 75%, 80%, 95%, or 100% compared to the positive rib height. In other exemplary embodiments, the negative rib height may no greater than approximately 100%, 95%, 90%, 85%, 80%, 75%, 70%, 65%, 60%, 55%, 50%, 45%, 40%, 35%, 30%, 25%, 20%, 15%, 10%, or 5% compared to the positive rib height.

In some select embodiments, at least a portion of the porous membrane may have negative ribs that are longitudinal or transverse or cross-ribs. The negative ribs may be parallel to the top edge of the separator, or may be disposed at an angle thereto. For instance, the negative ribs may be oriented approximately 0°, 5°, 15°, 25°, 30°, 45°, 60°, 70°, 80°, or 90° relative to the top edge. The cross-ribs may be oriented approximately 0° to approximately 30°, approximately 30° to approximately 45°, approximately 45° to approximately 60°, approximately 30° to approximately 60°, approximately 30° to approximately 90°, or approximately 60° to approximately 90° relative to the top edge.

Certain exemplary embodiments may possess a base portion. If present, it may have an average base height of from approximately 5 μm to approximately 200 μm. For example, the average base height may be greater than or equal to approximately 5 μm, 10 μm, 20 μm, 30 μm, 40 μm, 50 μm, 100 μm, or 200 μm. Further, if present it may have an average base width that is from approximately 0.0 μm to approximately 50 μm wider than the tooth width. For example, the average base width may be greater than or equal to approximately 0.0 μm, 5 μm, 10 μm, 20 μm, 30 μm, 40 μm, or 50 μm wider than the tooth width.

Certain exemplary embodiments may possess teeth or toothed ribs. If present, they may have an average tip length of from approximately 50 μm to approximately 1.0 mm. For example, the average tip length may be greater than or equal to approximately 50 μm, 100 μm, 200 μm, 300 μm, 400 μm, 500 μm, 600 μm, 700 μm, 800 μm, 900 μm, or 1.0 mm. Alternatively, they may be no greater than or equal to 1.0 mm, 900 μm, 800 μm, 700 μm, 600 μm, 500 μm, 400 μm, 300 μm, 200 μm, 100 μm, or 50 μm.

At least a portion of the teeth or toothed ribs may have an average tooth base length of from approximately 50 μm to approximately 1.0 mm. For example, the average tooth base length may be approximately 50 μm, 100 μm, 200 μm, 300 μm, 400 μm, 500 μm, 600 μm, 700 μm, 800 μm, 900 μm, or 1.0 mm. Alternatively, they may be no greater than or equal to approximately 1.0 mm, 900 μm, 800 μm, 700 μm, 600 μm, 500 μm, 400 μm, 300 μm, 200 μm, 100 μm, or 50 μm.

At least a portion of the teeth or toothed ribs may have an average height (combined base portion height and teeth height) of from approximately 50 μm to approximately 1.0 mm. For example, the average height may be approximately 50 μm, 100 μm, 200 μm, 300 μm, 400 μm, 500 μm, 600 μm, 700 μm, 800 μm, 900 μm, or 1.0 mm. Alternatively, they may be no greater than or equal to approximately 1.0 mm, 900 μm, 800 μm, 700 μm, 600 μm, 500 μm, 400 μm, 300 μm, 200 μm, 100 μm, or 50 μm.

At least a portion of the teeth or toothed ribs may have an average center-to-center pitch within a column in the machine direction of from approximately 100 μm to approximately 50 mm. For example, the average center-to-center pitch may be greater than or equal to approximately 50 μm, 100 μm, 200 μm, 300 μm, 400 μm, 500 μm, 600 μm, 700 μm, 800 μm, 900 μm, or 1.0 mm, and in similar increments up to 50 mm. Alternatively, they may be no greater than or equal to approximately 50 μm, 100 μm, 200 μm, 300 μm, 400 μm, 500 μm, 600 μm, 700 μm, 800 μm, 900 μm, or 1.0 mm, and in similar increments up to 50 mm. In addition, adjacent columns of teeth or toothed ribs may be identically disposed at the same position in a machine direction or offset. In an offset configuration, adjacent teeth or toothed ribs are disposed at different positions in the machine direction.

At least a portion of the teeth or toothed ribs may have an average height to base width ratio of from approximately 0.1:1.0 to approximately 500:1.0. For example, the average height to base width ratio may be approximately 0.1:1.0, 25:1.0, 50:1.0, 100:1.0, 150:1.0, 200:1.0, 250:1.0, 300:1.0, 350:1, 450:1.0, or 500:1.0. Alternatively, the average height to base width ratio may be no greater than or equal to approximately 500:1.0, 450:1.0, 400:1.0, 350:1.0, 300:1.0, 250:1.0, 200:1.0, 150:1.0, 100:1.0, 50:1.0, 25:1.0, or 0.1:1.0.

At least a portion of the teeth or toothed ribs can have average base width to tip width ratio of from approximately 1,000:1.0 to approximately 0.1:1.0. For example, the average base width to tip width ratio may be approximately 0.1:1.0, 1.0:1.0, 2:1.0, 3:1.0, 4:1.0, 5:1.0, 6:1.0, 7:1.0, 8:1.0, 9:1.0, 10:1.0, 15:1.0, 20:1.0, 25:1.0, 50:1.0, 100:1.0, 150:1.0, 200:1.0, 250:1.0, 300:1.0, 350:1.0, 450:1.0, 500:1.0, 550:1.0, 600:1.0, 650:1.0, 700:1.0, 750:1.0, 800:1.0, 850:1.0, 900:1.0, 950:1.0, or 1,000:1.0. Alternatively, the average base width to tip width ratio may be no greater than approximately 1,000:1.0, 950:1.0, 900:1.0, 850:1.0, 800:1.0, 750:1.0, 700:1.0, 650:1.0, 600:1.0, 550:1.0, 500:1.0, 450:1.0, 400:1.0, 350:1.0, 300:1.0, 250:1.0, 200:1.0, 150:1.0, 100:1.0, 50:1.0, 25:1.0, 20:1.0, 15:1.0, 10:1.0, 9:1.0, 8:1.0, 7:1.0, 6:1.0, 5:1.0, 4:1.0, 3:1.0, 2:1.0, 1.0:1.0, or 0.1:1.0.

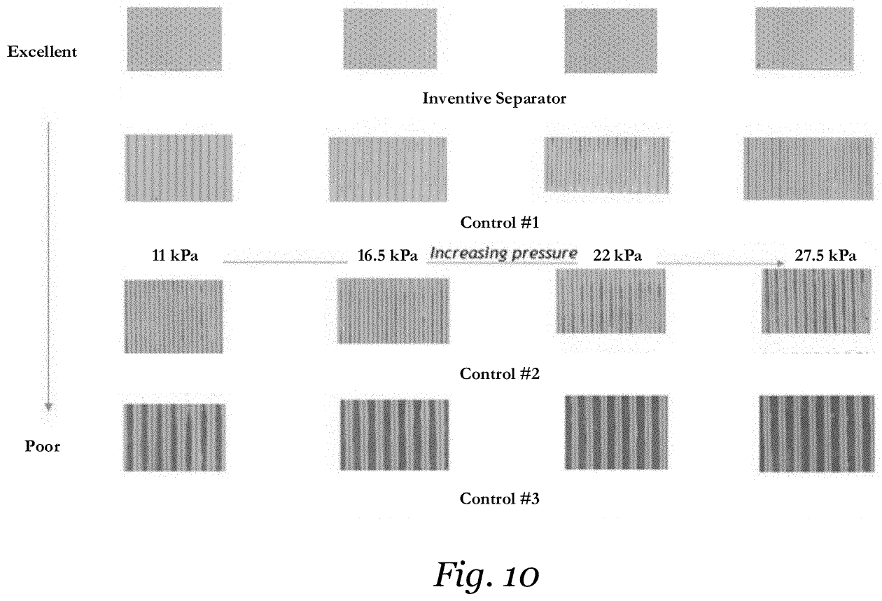

FIGS. 7A-7C illustrate various scenarios of dendrite formation. The figures show various embodiments of a separator 300 disposed between a positive electrode 200 and a negative electrode 201. All separators have positive ribs 304, but only FIGS. 7B and 7C depict a separator 300 with negative electrodes 306. The inventors believe that the more contact a separator 300 has with the negative electrode 201, the more likely dendrites 400 are to form and grow within its porous structure. As shown in FIG. 7A, the back web 302 has a flat surface facing the negative electrode 201. And according to the inventors' hypothesis, dendrites 400 have many opportunities to grow and form a bridge between the negative electrode 201 and the positive electrode 200 within the separator 300. FIG. 7B depicts a separator 300 with negative cross ribs 306, thus reducing the contact area between the separator 300 and the negative electrode 201 and allowing for fewer opportunities for dendrites 400 to form and grow within the separator 300 and form a bridge between the two electrodes 200, 201. As shown in FIG. 7C, the separator 300 is provided with fewer negative cross ribs 306 than that shown in FIG. 7B and they are also spaced farther apart and taller than those shown in FIG. 7B. Thus providing even less contact between the separator 300 and the negative electrode 201, and therefore even fewer opportunities for dendrites 400 to form a bridge from the negative electrode 201 and the positive electrode 200. In accordance with the inventors' hypothesis, it is possible to achieve even fewer opportunities for dendrite 400 growth by reducing the contact between the ribs 306 and the negative electrode 201, such as by providing discontinuous or broken ribs in some fashion. This may be achieved by providing discontinuous, broken, serrated or other forms of ribs wherein there are portions in which the ribs 306 do not contact the surface of the negative electrode 201. While these examples concentrate on negative ribs 306, the same treatment may also be applied to the positive ribs 304.

Testing of Separators

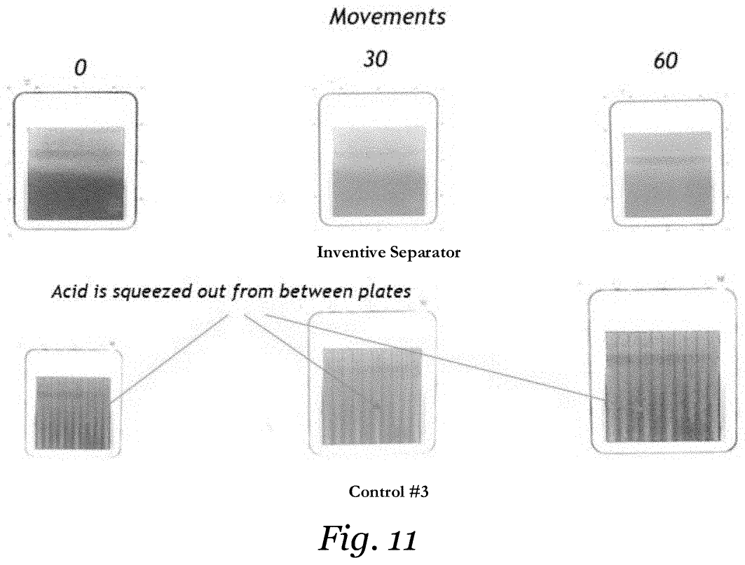

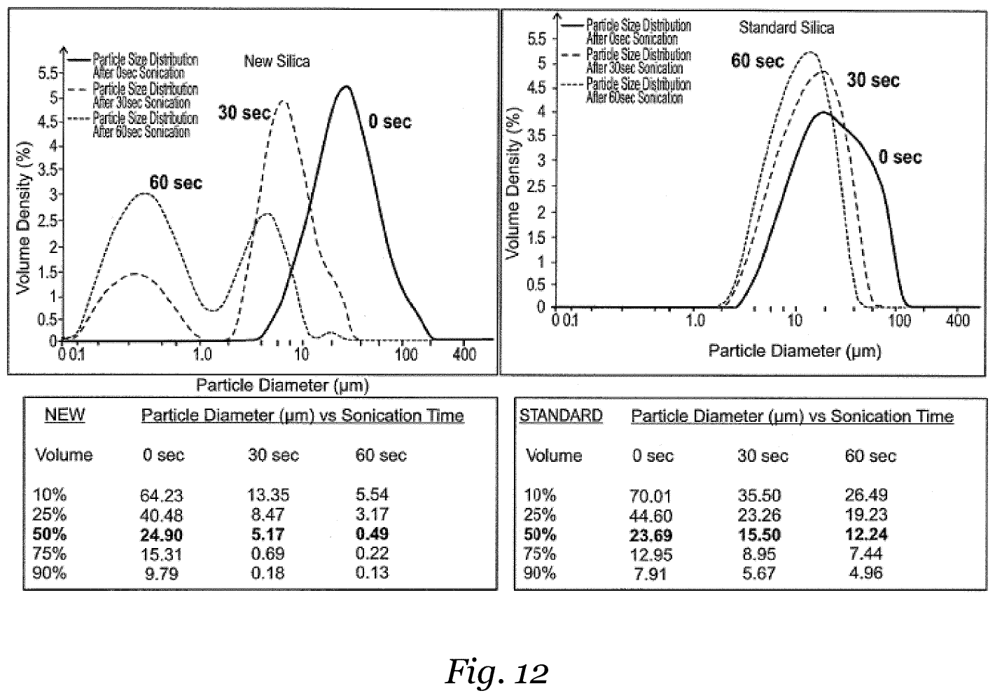

Referring now to FIGS. 8 and 9, clamping test equipment is shown for a compression test for simulating NAM swelling in order to evaluate separator resilience. As shown, a structure is formed of the following components: 1) a foam backing with a solid backing to simulate NAM swelling or expansion; 2) a separator with the negative ribs contacting the foam backing; and 3) a solid plastic plate in contact with the positive ribs and coated with red paint. The compression tests were performed as follows:

1) the separator, two solid plastic plates, and the foam backing are all cut or otherwise formed into 5 inch (12.7 cm) by 5 inch (12.7 cm) square pieces;

2) a paint applicator is formed as follows:

a) tape a felt sheet to a plastic square;

b) using a 3 mL eye dropper, mix 9 mL of red paint and 3 mL of water in a rectangular dish; and

c) put the paint applicator felt-sided down into the dish and leave it there until application;

3) Mark all sections with an arrow to ensure that all parts are added in the same order and the same direction. The stacked cell is provided, in order of bottom to top:

a) a first solid plastic plate (paint will be applied here),

b) a separator (with the positive ribs in contact with the first solid plastic plate),

c) a foam backing that is approximately 7.6 mm thick, and

d) a second solid plastic plate;

4) apply the proper air pressure in order to apply the desired pressure on the foam backing, as tested pressures of approximately 11 kPa, approximately 16.5 kPa, approximately 22 kPa, and approximately 27.5 kPa were applied to the stack to simulate NAM swelling;

5) apply the paint to the first solid piece of plastic by placing the first solid piece of plastic on a solid sturdy surface facing up; remove the paint applicator out of the paint and drag it across the top of the dish to remove some of the paint; place the paint applicator on the top surface of the solid piece of plastic and move it parallel to the surface of the first solid piece of plastic across the plastic in a first direction, and then move the paint applicator in a second direction perpendicular to the first direction; while ensuring that the coating of paint is even and with as few bubbles as possible;

6) add the separator with the positive ribs contacting the painted surface and the rest of the pieces in the above order and place in the compression apparatus before the paint has a chance to substantially dry;

7) engage the clamping apparatus to clamp the stack at the desired pressure and keep the stack clamped for one minute;

8) release the compression and remove the stack from the apparatus; remove the separator off the first solid plastic piece and set it aside to dry;

9) clean any remaining paint off the first plastic piece with water and paper towels for the next test; and

10) measure the thickness of the foam backing after each test to ensure that the integrity of the foam backing is still intact; replace the foam if it does not return to its original thickness after repeated use.

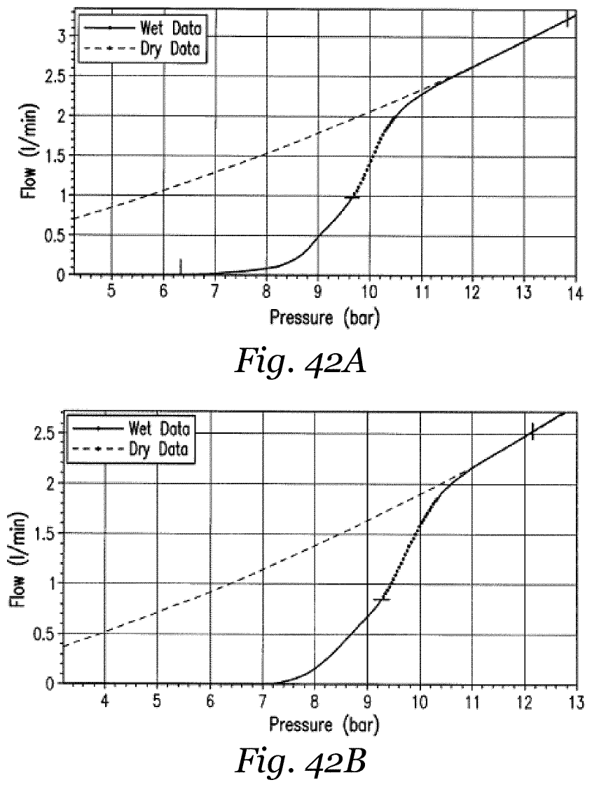

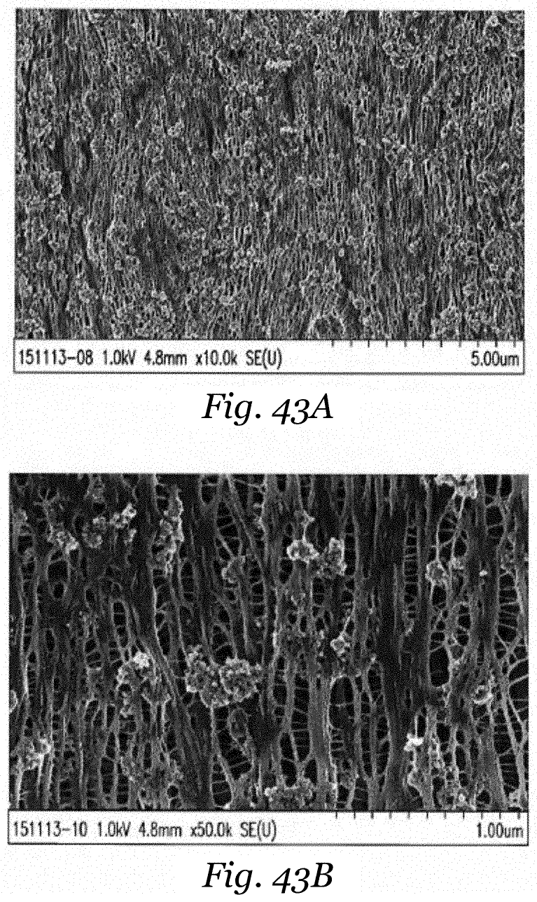

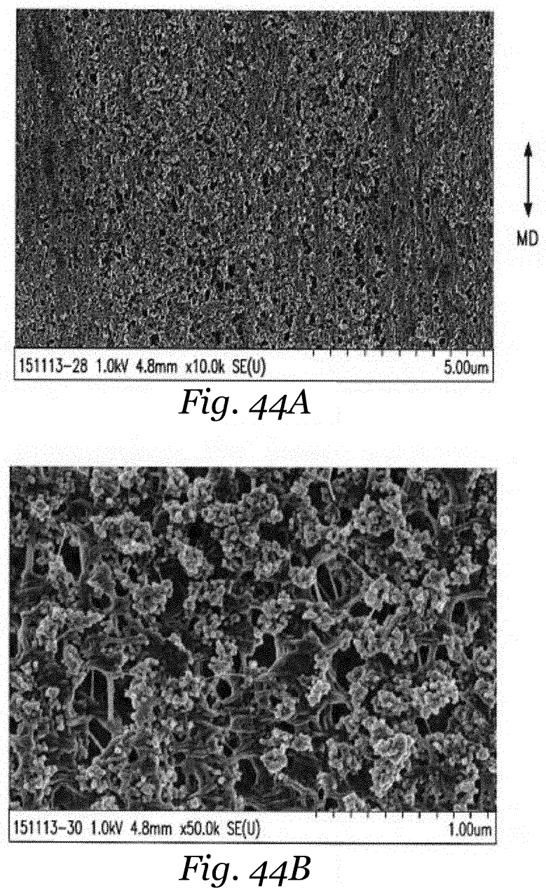

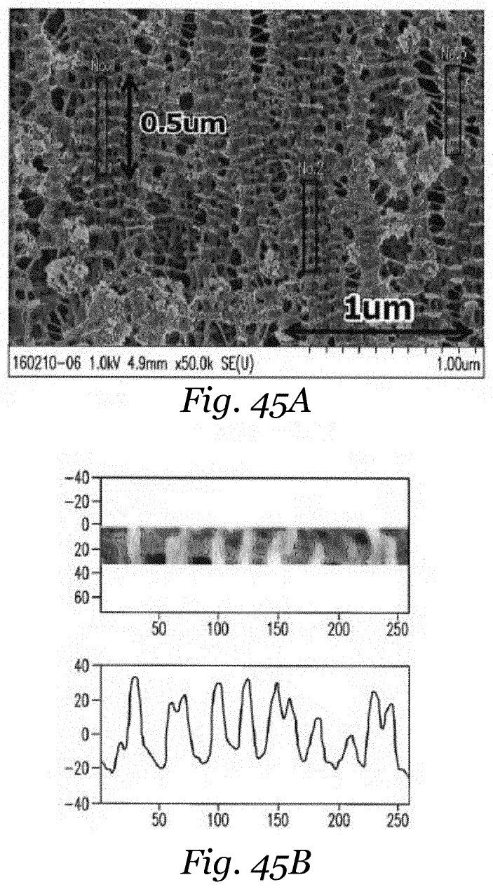

Pressure was applied equally on the stack as shown in FIG. 9. Specifically, pressures of 11 kPa, 16.5 kPa, 22 kPa, and 27.5 kPa were applied in different tests of a given separator sample. In this test, the ribs of the separator will be in contact with the solid plate with red paint in the structure (i.e., before any pressure is applied to the structure) so there will necessarily be red paint on the tips of the rib. However, transfer of red paint to the back web of the separator indicates deformation of the back web towards the solid plate coated with red paint. The results of this compression test are detailed in Table 2, and photographically shown in FIG. 42. It is appreciated that the photographs are of representative portions of the separators and not the entire separator.

Referring to Table 2, below, the performance in the presence of NAM swelling (i.e., acid availability) is shown for samples of one exemplary inventive separator and samples of three control separators. The separator samples are the same as previously presented in Table 1. It is appreciated that new separator samples were used for each test at the various pressures. All separators are made with the same composition of polyethylene, silica, and residual un-extracted oil. All separators are further provided with an average backweb thickness of approximately 250 μm, and a total thickness of between approximately 800 μm and approximately 1.0 mm.

TABLE 2

NAM Swelling Performance (% paint
coverage on backweb and rating)

| Separator | 11 kPa | 16.5 kPa | 22 kPa | 27.5 kPa |
|---|---|---|---|---|
| Inventive | Excellent | Excellent | Excellent | Excellent |
| Separator | | | | |
| Control #1 | Excellent | Fair | Fair | Poor |
| Control #2 | Poor | Poor | Fail | Fail |
| Control #3 | Fail | Fail | Fail | Fail |

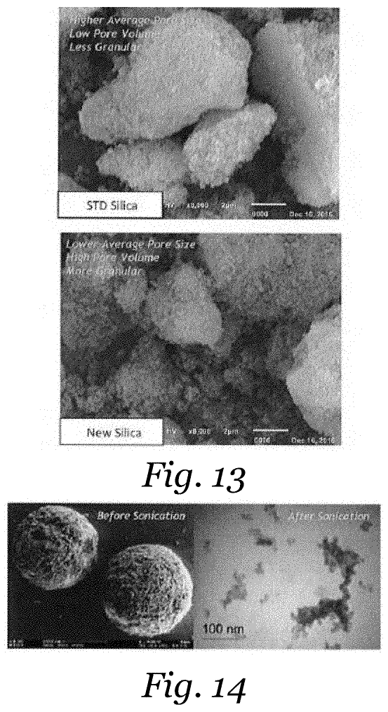

The photographical results shown in FIG. 10 reveal that at all applied pressures, red paint was transferred to 0% of the backweb surface of the inventive separator samples and paint was transferred only to the tips of the ribs. At an applied pressure of 11 kPa, red paint was transferred to 0% of the backweb surface of control separator #1; approximately 20% of the backweb surface of control separator #2; and to 50% of the backweb surface of control separator #3.

These test results show that acid availability under compression is not affected when separators according to the present invention are used. The same is shown for control separator #1 under low pressure. However, acid availability under compression is affected when control separators #2 and #3 are used. The control separator samples are generally representative of typical separators presently and commercially available on the market for flooded lead acid batteries that operate or are intended to operate at a partial state of charge.

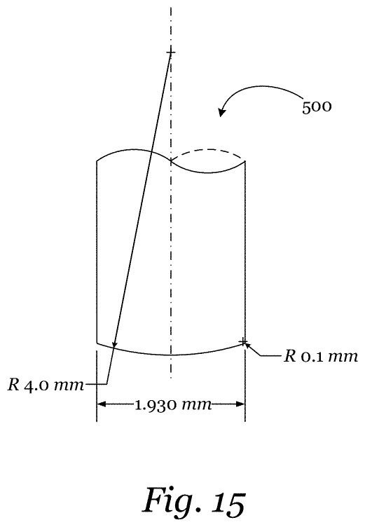

To determine the effectiveness for minimizing the effects of acid stratification, the inventive separator was subjected to a motion test. For this test, a structure comprising foam backing with a separator formed on either side of the foam backing is assembled. The foam is placed on a negative side of both of the separators (opposite the ribs) to simulate negative active material swelling. The structure was then placed in a motion device. Sulfuric acid and water were added to the device. Methyl orange was added to sulfuric acid to make the acid red and clear water on top creating a stratified cell. The acid had a specific gravity of 1.28. The structure was then subjected to 0, 30, and 60 movements to simulate the motion of a start/stop car. FIG. 11 shows photographical evidence of this motion test for an inventive separator sample and a sample of control separator #3. As shown, acid remained available for the inventive separator throughout these motions with some mixing. For control separator #3, most of the acid was displaced and squeezed out from between the ribs and no acid mixing was observed.

Backweb Thickness

In some embodiments, the porous separator membrane can have a backweb thickness from approximately 50 μm to approximately 1.0 mm. for example, the backweb thickness may be may be approximately 50 μm, 100 μm, 200 μm, 300 μm, 400 μm, 500 μm, 600 μm, 700 μm, 800 μm, 900 μm, or 1.0 mm. In other exemplary embodiments, the backweb thickness TBACK may be no greater than approximately 1.0 mm, 900 μm, 800 μm, 700 μm, 600 μm, 500 μm, 400 μm, 300 μm, 200 μm, 100 μm, or 50 μm. Though in certain embodiments, a very thin flat backweb thickness of 50 μm or thinner is provided, for example, between approximately 10 μm to approximately 50 μm thick.

The total thickness of exemplary separators (backweb 302 thickness and the heights of positive ribs 304 and negative ribs 306) typically range from approximately 250 μm to approximately 4.0 mm. The total thickness of separators used in automotive start/stop batteries are typically approximately 250 μm to approximately 1.0 mm. The total thickness of separators used in industrial traction-type start/stop batteries are typically approximately 1.0 mm to approximately 4.0 mm.

Form/Envelope

The separator 300 may be provided as a flat sheet, a leaf or leaves, a wrap, a sleeve, or as an envelope or pocket separator. An exemplary envelope separator may envelope a positive electrode (“positive enveloping separator”), such that the separator has two interior sides facing the positive electrode and two exterior sides facing adjacent negative electrodes. Alternatively, another exemplary envelope separator may envelope a negative electrode (“negative enveloping separator”), such that the separator has two interior sides facing the negative electrode and two exterior sides facing adjacent positive electrodes. In such enveloped separators, the bottom edge 103 may be a folded or a sealed crease edge. Further, the lateral edges 105a, 105b may be continuously or intermittently sealed seam edges. The edges may be bonded or sealed by adhesive, heat, ultrasonic welding, and/or the like, or any combination thereof.

Certain exemplary separators may be processed to form hybrid envelopes. The hybrid envelope may be provided by forming one or more slits or openings before, during or after, folding the separator sheet in half and bonding edges of the separator sheet together so as to form an envelope. The length of the openings may be at least 1/50, 1/25, 1/20, 1/15, 1/10 ⅛, ⅕, ¼, ⅓, or ½ the length of the entire edge. The length of the openings may be 1/50 to ⅓, 1/25 to ⅓, 1/20 to ⅓, 1/20 to ¼, 1/15 to ¼, 1/15 to ⅕, or 1/10 to ⅕ the length of the entire edge. The hybrid envelope can have 1 to 5, 1 to 4, 2 to 4, 2 to 3, or 2 openings, which may or may not be equally disposed along the length of the bottom edge. It is preferred that no opening is in the corner of the envelope. The slits may be cut after the separator has been folded and sealed to give an envelope, or the slits may be formed prior to shaping the porous membrane into the envelope.

Some other exemplary embodiments of separator assembly configurations include: the ribs 104 facing a positive electrode; the ribs 104 facing a negative electrode; a negative or positive electrode envelope; a negative or positive electrode sleeve, a negative or positive electrode hybrid envelope; both electrodes may be enveloped or sleeved, and any combination thereof.

Composition

In certain embodiments, the improved separator may include a porous membrane may be made of: a natural or synthetic base material; a processing plasticizer; a filler; natural or synthetic rubber(s) or latex, and one or more other additives and/or coatings, and/or the like.

Base Materials

In certain embodiments, exemplary natural or synthetic base materials may include: polymers; thermoplastic polymers; phenolic resins; natural or synthetic rubbers; synthetic wood pulp; lignins; glass fibers; synthetic fibers; cellulosic fibers; and any combination thereof. In certain preferable embodiments, an exemplary separator may be a porous membrane made from thermoplastic polymers. Exemplary thermoplastic polymers may, in principle, include all acid-resistant thermoplastic materials suitable for use in lead acid batteries. In certain preferred embodiments, exemplary thermoplastic polymers may include polyvinyls and polyolefins. In certain embodiments, the polyvinyls may include, for example, polyvinyl chloride (“PVC”). In certain preferred embodiments, the polyolefins may include, for example, polyethylene, polypropylene, ethylene-butene copolymer, and any combination thereof, but preferably polyethylene. In certain embodiments, exemplary natural or synthetic rubbers may include, for example, latex, uncross-linked or cross-linked rubbers, crumb or ground rubber, and any combination thereof.

In addition, it has been observed that when antimony (Sb) is present in the NAM and/or negative electrode, NAM swelling is reduced. Accordingly, there may be an antimony coating on the separator or antimony additive in the separator composition.

Polyolefins

In certain embodiments, the porous membrane layer preferably includes a polyolefin, specifically polyethylene. Preferably, the polyethylene is high molecular weight polyethylene (“HMWPE”), (e.g., polyethylene having a molecular weight of at least 600,000). Even more preferably, the polyethylene is ultra-high molecular weight polyethylene (“UHMWPE”). Exemplary UHMWPE may have a molecular weight of at least 1,000,000, in particular more than 4,000,000, and most preferably 5,000,000 to 8,000,000 as measured by viscosimetry and calculated by Margolie's equation. Further, exemplary UHMWPE may possess a standard load melt index of substantially zero (0) as measured as specified in ASTM D 1238 (Condition E) using a standard load of 2,160 g. Moreover, exemplary UHMWPE may have a viscosity number of not less than 600 ml/g, preferably not less than 1,000 ml/g, more preferably not less than 2,000 ml/g, and most preferably not less than 3,000 ml/g, as determined in a solution of 0.02 g of polyolefin in 100 g of decalin at 130° C.

Rubber

The novel separator disclosed herein may contain latex and/or rubber. As used herein, rubber shall describe, rubber, latex, natural rubber, synthetic rubber, cross-linked or uncross-linked rubbers, cured or uncured rubber, crumb or ground rubber, or mixtures thereof. Exemplary natural rubbers may include one or more blends of polyisoprenes, which are commercially available from a variety of suppliers. Exemplary synthetic rubbers include methyl rubber, polybutadiene, chloropene rubbers, butyl rubber, bromobutyl rubber, polyurethane rubber, epichlorhydrin rubber, polysulphide rubber, chlorosulphonyl polyethylene, polynorbornene rubber, acrylate rubber, fluorine rubber and silicone rubber and copolymer rubbers, such as styrene/butadiene rubbers, acrylonitrile/butadiene rubbers, ethylene/propylene rubbers (“EPM” and “EPDM”) and ethylene/vinyl acetate rubbers. The rubber may be a cross-linked rubber or an uncross-linked rubber; in certain preferred embodiments, the rubber is uncross-linked rubber. In certain embodiments, the rubber may be a blend of cross-linked and uncross-linked rubber.

Plasticizer

In certain embodiments, exemplary processing plasticizers may include processing oil, petroleum oil, paraffin-based mineral oil, mineral oil, and any combination thereof.

Fillers

The separator can contain a filler having a high structural morphology. Exemplary fillers can include: silica, dry finely divided silica; precipitated silica; amorphous silica; highly friable silica; alumina; talc; fish meal; fish bone meal; carbon; carbon black; and the like, and combinations thereof. In certain preferred embodiments, the filler is one or more silicas. High structural morphology refers to increased surface area. The filler can have a high surface area, for instance, greater than approximately 100 m²/g, 110 m²/g, 120 m²/g, 130 m²/g, 140 m²/g, 150 m²/g, 160 m²/g, 170 m²/g, 180 m²/g, 190 m²/g, 200 m²/g, 210 m²/g, 220 m²/g, 230 m²/g, 240 m²/g, or 250 m²/g. In some embodiments, the filler (e.g., silica) can have a surface area from approximately 100 m²/g to approximately 300 m²/g, approximately 125 m²/g to approximately 275 m²/g, approximately 150 m²/g to approximately 250 m²/g, or preferably approximately 170 m²/g to approximately 220 m²/g. Surface area can be assessed using TriStar 3000™ for multipoint BET nitrogen surface area. High structural morphology permits the filler to hold more oil during the manufacturing process. For instance, a filler with high structural morphology has a high level of oil absorption, for instance, greater than about 150 ml/100 g, 175 ml/100 g, 200 ml/100 g, 225 ml/100 g, 250 ml/100 g, 275 ml/100 g, 300 ml/100 g, 325 ml/100 g, or 350 ml/100 g. In some embodiments the filler (e.g., silica) can have an oil absorption from 200-500 ml/100 g, 200-400 ml/100 g, 225-375 ml/100 g, 225-350 ml/100 g, 225-325 ml/100 g, preferably 250-300 ml/100 g. In some instances, a silica filler is used having an oil absorption of 266 ml/100 g. Such a silica filler has a moisture content of 5.1%, a BET surface area of 178 m²/g, an average particle size of 23 μm, a sieve residue 230 mesh value of 0.1%, and a bulk density of 135 g/L.

Silica with relatively high levels of oil absorption and relatively high levels of affinity for the plasticizer (e.g., mineral oil) becomes desirably dispersible in the mixture of polyolefin (e.g., polyethylene) and the plasticizer when forming an exemplary lead acid battery separator of the type shown herein. In the past, some separators have experienced the detriment of poor dispersibility caused by silica aggregation when large amounts of silica are used to make such separators or membranes. In at least certain of the inventive separators shown and described herein, the polyolefin, such as polyethylene, forms a shish-kebab structure, since there are few silica aggregations or agglomerates that inhibit the molecular motion of the polyolefin at the time of cooling the molten polyolefin. All of this contributes to improved ion permeability through the resulting separator membrane, and the formation of the shish-kebab structure or morphology means that mechanical strength is maintained or even improved while a lower overall ER separator is produced.

In some select embodiments, the filler (e.g., silica) has an average particle size no greater than 25 μm, in some instances, no greater than 22 μm, 20 μm, 18 μm, 15 μm, or 10 μm. In some instances, the average particle size of the filler particles is 15-25 μm. The particle size of the silica filler and/or the surface area of the silica filler contributes to the oil absorption of the silica filler. Silica particles in the final product or separator may fall within the sizes described above. However, the initial silica used as raw material may come as one or more agglomerates and/or aggregates and may have sizes around 200 μm or more.

In some preferred embodiments, the silica used to make the inventive separators has an increased amount of or number of surface silanol groups (surface hydroxyl groups) compared with silica fillers used previously to make lead acid battery separators. For example, the silica fillers that may be used with certain preferred embodiments herein may be those silica fillers having at least 10%, at least 15%, at least 20%, at least 25%, at least 30%, or at least 35% more silanol and/or hydroxyl surface groups compared with known silica fillers used to make known polyolefin lead acid battery separators.

The ratio (Si—OH)/Si of silanol groups (Si—OH) to elemental silicon (Si) can be measured, for example, as follows.

1. Freeze-crush a polyolefin porous membrane (where certain inventive membranes contain a certain variety of oil-absorbing silica according to the present invention), and prepare the powder-like sample for the solid-state nuclear magnetic resonance spectroscopy (²⁹Si—NMR).

2. Perform the ²⁹Si-NMR to the powder-like sample, and observe the spectrums including the Si spectrum strength which is directly bonding to a hydroxyl group (Spectrum: Q₂ and Q₃) and the Si spectrum strength which is only directly bonding to an oxygen atom (Spectrum: Q₄), wherein the molecular structure of each NMR peak spectrum can be delineated as follows:
Q₂: (SiO)₂— Si*—(OH)₂: having two hydroxyl groups
Q₃: (SiO)₃— Si*—(OH): having one hydroxyl group
Q₄: (SiO)₄—Si*: All Si bondings are SiO

Where Si* is proved element by NMR observation.

3. The conditions for ²⁹Si-NMR used for observation are as follows:
Instrument: Bruker BioSpin Avance 500
Resonance Frequency: 99.36 MHz
Sample amount: 250 mg
NMR Tube: 7 mφ
Observing Method: DD/MAS
Pulse Width: 45°
Repetition time: 100 sec
Scans: 800
Magic Angle Spinning: 5,000 Hz
Chemical Shift Reference: Silicone Rubber as −22.43 ppm

4. Numerically, separate peaks of the spectrum, and calculate the area ratio of each peak belonging to Q₂, Q₃, and Q₄. After that, based on the ratios, calculate the molar ratio of hydroxyl groups (—OH) bonding directly to Si. The conditions for the numerical peak separation is conducted in the following manner:
Fitting region: −80 to −130 ppm
Initial peak top: −93 ppm for Q₂, −101 ppm for Q₃, −111 ppm for Q₄, respectively.
Initial full width half maximum: 400 Hz for Q₂, 350 Hz for Q₃, 450 Hz for Q₄, respectively.
Gaussian function ratio: 80% at initial and 70 to 100% while fitting.

5. The peak area ratios (Total is 100) of Q₂, Q₃, and Q₄ are calculated based on the each peak obtained by fitting. The NMR peak area corresponded to the molecular number of each silicate bonding structure (thus, for the Q₄ NMR peak, four Si—O—Si bonds are present within that silicate structure; for the Q₃ NMR peak, three Si—O—Si bonds are present within that silicate structure while one Si—OH bond is present; and for the Q₂ NMR peak, two Si—O—Si bonds are present within that silicate structure while two Si—OH bonds are present). Therefore each number of the hydroxyl group (—OH) of Q₂, Q₃, and Q₄ is multiplied by two (2) one (1), and zero (0), respectively. These three results are summed. The summed value displays the mole ratio of hydroxyl groups (—OH) directly bonding to Si.

In certain embodiments, the silica may have a molecular ratio of OH to Si groups, measured by ²⁹Si-NMR, that may be within a range of approximately 21:100 to 35:100, in some preferred embodiments approximately 23:100 to approximately 31:100, in certain preferred embodiments, approximately 25:100 to approximately 29:100, and in other preferred embodiments at least approximately 27:100 or greater.

In some select embodiments, use of the fillers described above permits the use of a greater proportion of processing oil during the extrusion step. As the porous structure in the separator is formed, in part, by removal of the oil after the extrusion, higher initial absorbed amounts of oil results in higher porosity or higher void volume. While processing oil is an integral component of the extrusion step, oil is a non-conducting component of the separator. Residual oil in the separator protects the separator from oxidation when in contact with the positive electrode. The precise amount of oil in the processing step may be controlled in the manufacture of conventional separators. Generally speaking, conventional separators are manufactured using 50-70% processing oil, in some embodiments, 55-65%, in some embodiments, 60-65%, and in some embodiments, about 62% by weight processing oil. Reducing oil below about 59% is known to cause burning due to increased friction against the extruder components. However, increasing oil much above the prescribed amount may cause shrinking during the drying stage, leading to dimensional instability. Although previous attempts to increase oil content resulted in pore shrinkage or condensation during the oil removal, separators prepared as disclosed herein exhibit minimal, if any, shrinkage and condensation during oil removal. Thus, porosity can be increased without compromising pore size and dimensional stability, thereby decreasing electrical resistance.

In certain select embodiments, the use of the filler described above allows for a reduced final oil concentration in the finished separator. Since oil is a non-conductor, reducing oil content can increase the ionic conductivity of the separator and assist in lowering the ER of the separator. As such, separators having reduced final oil contents can have increased efficiency. In certain select embodiments are provided separators having a final processing oil content (by weight) less than 20%, for example, between about 14% and 20%, and in some particular embodiments, less than 19%, 18%, 17%, 16%, 15%, 14%, 13%, 12%, 11%, 10%, 9%, 8%, 7%, 6%, or 5%.

The fillers may further reduce what is called the hydration sphere of the electrolyte ions, enhancing their transport across the membrane, thereby once again lowering the overall electrical resistance or ER of the battery, such as an enhanced flooded battery or system.

The filler or fillers may contain various species (e.g., polar species, such as metals) that facilitate the flow of electrolyte and ions across the separator. Such also leads to decreased overall electrical resistance as such a separator is used in a flooded battery, such as an enhanced flooded battery.

Friability

In certain select embodiments, the filler can be an alumina, talc, silica, or a combination thereof. In some embodiments, the filler can be a precipitated silica, and in some embodiments, the precipitated silica is amorphous silica. In some embodiments, it is preferred to use aggregates and/or agglomerates of silica or friable silica which allow for a fine dispersion of filler throughout the separator, thereby decreasing tortuosity and electrical resistance. In certain preferred embodiments, the filler (e.g., silica) is characterized by a high level of friability. Good friability enhances the dispersion of the filler throughout the polymer during extrusion of the porous membrane, enhancing porosity and thus overall ionic conductivity through the separator.

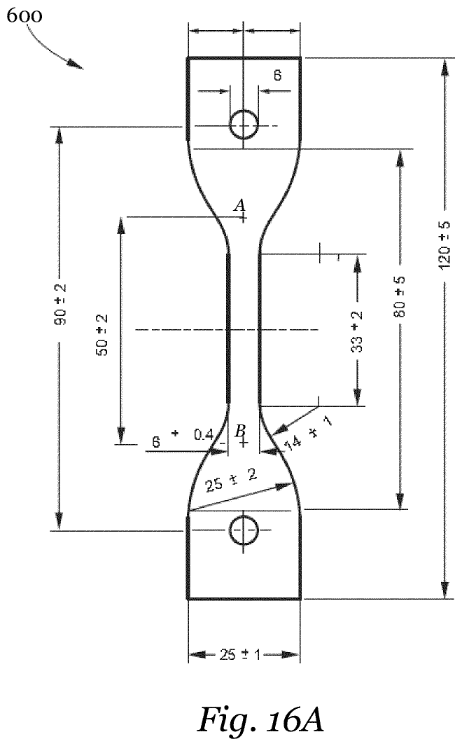

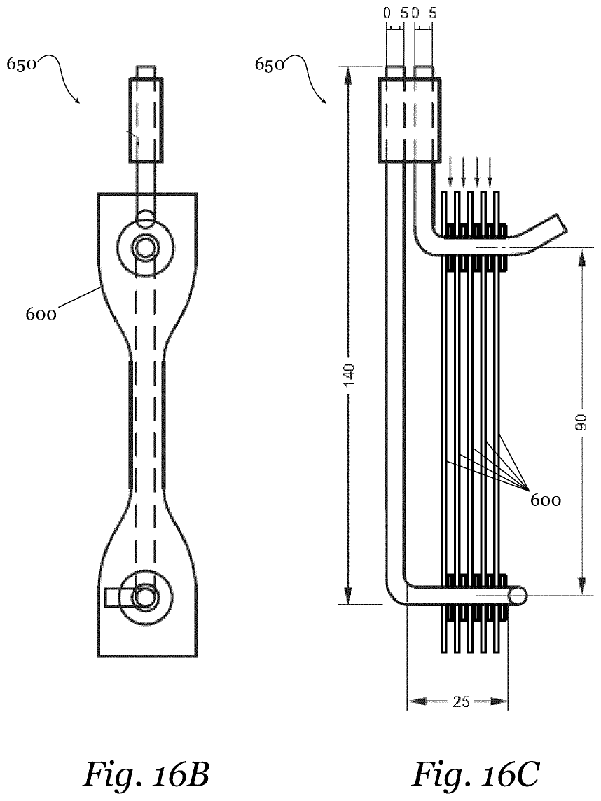

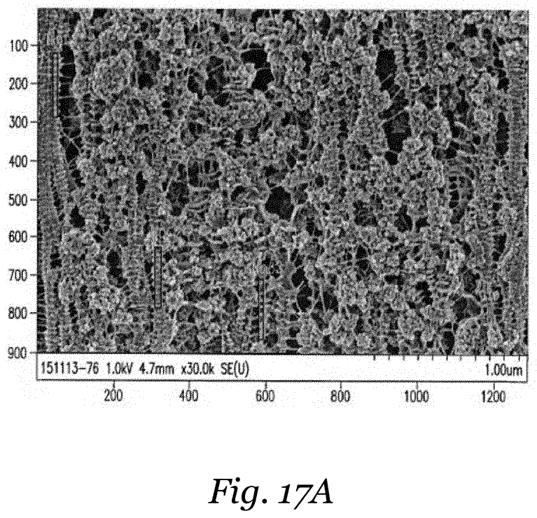

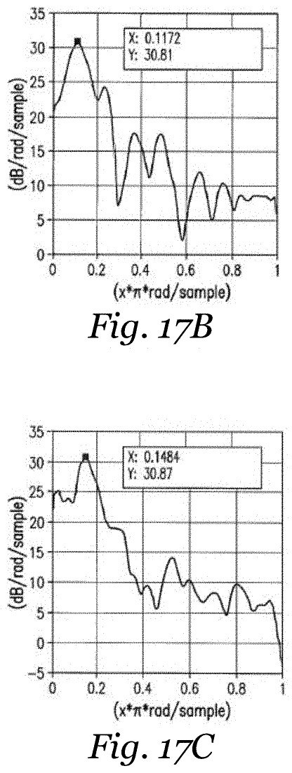

Friability may be measured as the ability, tendency or propensity of the silica particles or material (aggregates or agglomerates) to be broken down into smaller sized and more dispersible particles, pieces or components. As shown on the left side of FIG. 12, the NEW silica is more friable (is broken down into smaller pieces after 30 seconds and after 60 seconds of sonication) than the STANDARD silica. For example, the NEW silica had a 50% volume particle diameter of 24.90 um at 0 seconds sonication, 5.17 um at 30 seconds and 0.49 um at 60 seconds. Hence, at 30 seconds sonication there was over a 50% reduction in size (diameter) and at 60 seconds there was over a 75% reduction in size (diameter) of the 50% volume silica particles. Hence, one possibly preferred definition of “high friability” may be at least a 50% reduction in average size (diameter) at 30 seconds of sonication and at least a 75% reduction in average size (diameter) at 60 seconds of sonication of the silica particles (or in processing of the resin silica mix to form the membrane). In at least certain embodiments, it may be preferred to use a more friable silica, and may be even more preferred to use a silica that is friable and multi-modal, such as bi-modal or tri-modal, in its friability. With reference to FIG. 12, the STANDARD silica appears single modal in it friability or particle size distribution, while the NEW silica appears more friable, and bi-modal (two peaks) at 30 seconds sonication and tri-modal (three peaks) at 60 seconds sonication. Such friable and multi-modal particle size silica or silicas may provide enhanced membrane and separator properties. FIG. 12 is a SEM image comparing the STANDARD silica and the NEW silica. FIG. 14 is a SEM image of the NEW silica before and after sonication.

The use of a filler having one or more of the above characteristics enables the production of a separator having a higher final porosity. The separators disclosed herein can have a final porosity greater than 60%, 61%, 62%, 63%, 64%, 65%, 66%, 67%, 68%, 69%, or 70%. Porosity may be measured using gas adsorption methods. Porosity can be measured by BS-TE-2060.

In some select embodiments, the porous separator can have a greater proportion of larger pores while maintaining the average pore size no greater than about 1 μm, 0.9 μm, 0.8 μm, 0.7 μm, 0.6 μm, 0.5 μm, or 0.1 μm.

In accordance with at least one embodiment, the separator is made up of polyethylene, such as an ultrahigh molecular weight polyethylene (“UHMWPE”), mixed with a processing oil and filler as well as any desired additive. In accordance with at least one other embodiment, the separator is made up of an ultrahigh molecular weight polyethylene (UHMWPE) mixed with a processing oil and talc. In accordance with at least one other embodiment, the separator is made up of UHMWPE mixed with a processing oil and silica, for instance, precipitated silica, for instance, amorphous precipitated silica. The additive can then be applied to the separator via one or more of the techniques described above.

Besides reducing electrical resistance and increasing cold cranking amps, preferred separators are also designed to bring other benefits. With regard to assembly, the separators are more easily passed through processing equipment, and therefore more efficiently manufactured. To prevent shorts during high speed assembly and later in life, the separators have superior puncture strength and oxidation resistance when compared to standard PE separators. Combined with reduced electrical resistance and increased cold cranking amps, battery manufacturers are likely to find improved and sustained electrical performance in their batteries with these new separators.

Electrical Resistance

In certain selected embodiments, the disclosed separators exhibit decreased electrical resistance, for instance, an electrical resistance no greater than about 200 mΩ·cm², 180 mΩ·cm², 160 mΩ·cm², 140 mΩ·cm², 120 mΩ·cm², 100 mΩ·cm², 80 mΩ·cm², 60 mΩ·cm², 50 mΩ·cm², 40 mΩ·cm², 30 mΩ·cm², or 20 mΩ·cm². In various embodiments, the separators described herein exhibit about a 20% or more reduction in ER compared with a known separator of the same thickness. For example, a known separator may have an ER value of 60 mΩ·cm², thus, a separator according to the present invention at the same thickness would have an ER value of less than about 48 mΩ·cm².

To test a sample separator for ER testing evaluation in accordance with the present invention, it must first be prepared. To do so, a sample separator is preferably submerged in a bath of demineralized water, the water is then brought to a boil and the separator is then removed after 10 minutes in the boiling demineralized water bath. After removal, excess water is shaken off the separator and then placed in a bath of sulfuric acid having a specific gravity of 1.280 at 27° C.±1° C. The separator is soaked in the sulfuric acid bath for 20 minutes. The separator is then ready to be tested for electrical resistance.

Puncture Resistance

In certain selected embodiments, exemplary separators may be characterized with an increased puncture resistance. For instance, a puncture resistance of approximately 9 N or higher, 9.5 N or higher, 10 N or higher, 10.5 N or higher, 11 N or higher, 11.5 N or higher 12 N or higher, 12.5 N or higher, 13 N or higher, 13.5 N or higher, 14 N or higher, 14.5 N or higher, 15 N or higher, 15.5 N or higher, 16 N or higher, 16.5 N or higher, 17 N or higher, 17.5 N or higher, 18 N or higher, 18.5 N or higher, 19 N or higher, 19.5 N or higher, or 20 N or higher. In certain embodiments, exemplary separators may be preferably defined with a puncture resistance of approximately 9 N-20 N or higher, or more preferably approximately 12 N-20 N or higher.

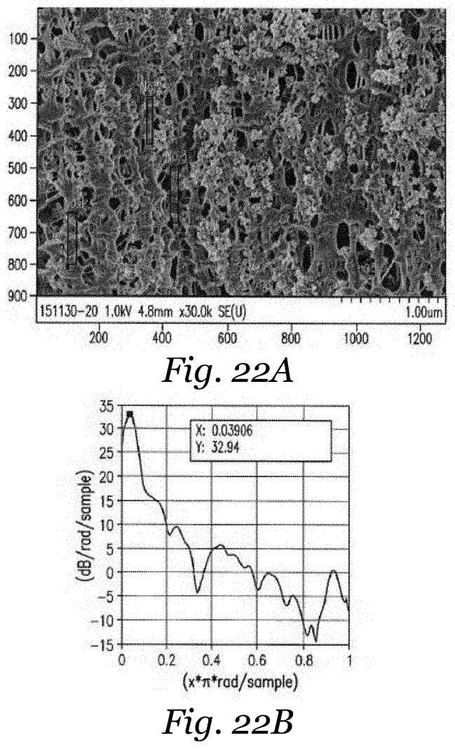

The puncture resistance may be measured as the force required to puncture the porous membrane utilizing the tip 500 as generally depicted in FIG. 25. The puncture base in which the porous membrane is supported while the tip 500 punctures the membrane may generally be described as a base having a 6.5 mm diameter straight hole with a 10 mm depth. The travel limit of the tip may be approximately 4 mm-8 mm below the puncture base surface. The puncture tip 100 is linearly moved into the membrane at a rate of approximately 5 mm/s.

Oxidation Stability

In certain select embodiments, exemplary separators may be characterized with an improved and higher oxidation resistance. Oxidation resistance is measured in elongation of sample separator specimens in the cross-machine direction after prolonged exposure to the lead acid battery electrolyte. For instance, exemplary separators may have an elongation at 40 hours of approximately 150% or higher, 200% or higher, 250% or higher, 300% or higher, 350% or higher, 400% or higher, 450% or higher, or 500% or higher. In certain embodiments, exemplary separators may have a preferred oxidation resistance or elongation at 40 hours of approximately 200% or higher.

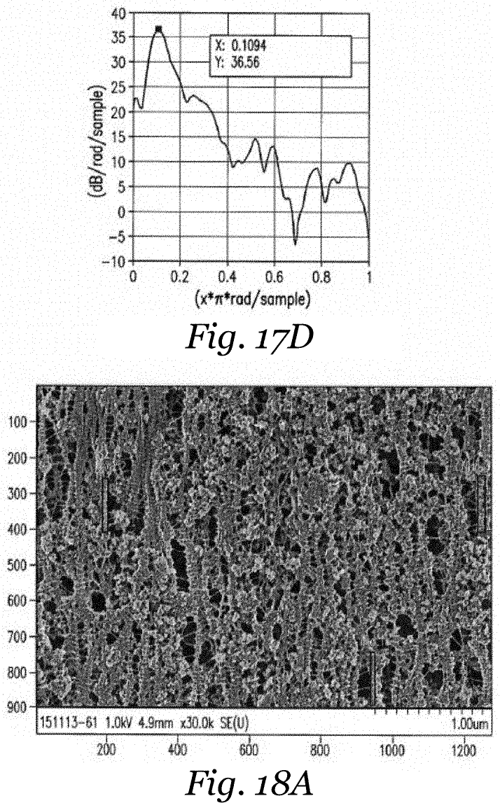

To test samples for oxidation resistance, sample specimens 600 of exemplary separators are first cut to a shape as generally set forth in FIG. 16A. The specimens 600 are then placed in a sample holder 650 as generally shown in FIGS. 16B and 16C.

A first sample set is tested dry, at time=zero (0) hours, for elongation percentage to break. The elongation is based upon the 50 mm distance as measured from points A and B in FIG. 16A. For instance, if points A and B are stretched to a distance of 300%, then the final distance between A and B would be 150 mm.

The elongation test is designed to simulate extended exposure to electrolyte in a cycling battery in a shortened time period. The samples 600 are first fully submersed in isopropanol, drained and then submersed in water for 1 to 2 seconds. The samples are then submersed in an electrolyte solution. The solution is prepared by adding, in order, 360 ml of 1.28 specific gravity sulfuric acid, 35 ml of 1.84 specific gravity sulfuric acid, then 105 ml of 35% hydrogen peroxide. The solution is kept at 80° C. and the samples are submerged in the solution for an extended period. Samples may be tested for elongation at regular time intervals, such as 20 hours, 40 hours, 60 hours, 80 hours, etc. To test at these intervals, the samples 600 are remove from the 80° C. electrolyte bath and placed under luke-warm running water until the acid has been removed. The elongation can then be tested.

In accordance with at least select embodiments, the present disclosure or invention is directed to improved battery separators, Low ER or high conductance separators, improved lead acid batteries, such as flooded lead acid batteries, high conductance batteries, and/or, improved vehicles including such batteries, and/or methods of manufacture or use of such separators or batteries, and/or combinations thereof. In accordance with at least certain embodiments, the present disclosure or invention is directed to improved lead acid batteries incorporating the improved separators and which exhibit increased conductance.

Additives/Surfactants

In certain embodiments, exemplary separators may contain one or more performance enhancing additives added to the separator or porous membrane. The performance enhancing additive may be surfactants, wetting agents, colorants, antistatic additives, an antimony suppressing additive, UV-protection additives, antioxidants, and/or the like, and any combination thereof. In certain embodiments, the additive surfactants may be ionic, cationic, anionic, or non-ionic surfactants.

In certain embodiments described herein, a reduced amount of anionic or non-ionic surfactant is added to the inventive porous membrane or separator. Because of the lower amount of surfactant, a desirable feature may include lowered total organic carbons (“TOCs”) and/or lowered volatile organic compounds (“VOCs”).

Certain suitable surfactants are non-ionic while other suitable surfactants are anionic. The additive may be a single surfactant or a mixture of two or more surfactants, for instance two or more anionic surfactants, two or more non-ionic surfactants, or at least one ionic surfactant and at least one non-ionic surfactant. Certain suitable surfactants may have HLB values less than 6, preferably less than 3. The use of these certain suitable surfactants in conjunction with the inventive separators described herein can lead to even further improved separators that, when used in a lead acid battery, lead to reduced water loss, reduced antimony poisoning, improved cycling, reduced float current, reduced float potential, and/or the like, or any combination thereof for that lead acid batteries. Suitable surfactants include surfactants such as salts of alkyl sulfates; alkylarylsulfonate salts; alkylphenol-alkylene oxide addition products; soaps; alkyl-naphthalene-sulfonate salts; one or more sulfo-succinates, such as an anionic sulfo-succinate; dialkyl esters of sulfo-succinate salts; amino compounds (primary, secondary, tertiary amines, or quaternary amines); block copolymers of ethylene oxide and propylene oxide; various polyethylene oxides; and salts of mono and dialkyl phosphate esters. The additive can include a non-ionic surfactant such as polyol fatty acid esters, polyethoxylated esters, polyethoxylated alcohols, alkyl polysaccharides such as alkyl polyglycosides and blends thereof, amine ethoxylates, sorbitan fatty acid ester ethoxylates, organosilicone based surfactants, ethylene vinyl acetate terpolymers, ethoxylated alkyl aryl phosphate esters and sucrose esters of fatty acids.

In certain embodiments, the additive may be represented by a compound of Formula (I)

R(OR¹)ₙ(COOM_{1/x}^{x+})ₘ (I)

in which:
R is a linear or non-aromatic hydrocarbon radical with 10 to 4200 carbon atoms, preferably 13 to 4200, which may be interrupted by oxygen atoms;
R¹=H, —(CH₂)COOM_{1/x}^{x+} or —(CH₂)ₖ—SO₃M_{1/x}^{x+}, preferably H, where k=1 or 2;
M is an alkali metal or alkaline-earth metal ion, H⁺ or NH₄⁺, where not all the variables M simultaneously have the meaning H⁺;
n=0 or 1;
m=0 or an integer from 10 to 1400; and
x=1 or 2.

The ratio of oxygen atoms to carbon atoms in the compound according to Formula (I) being in the range from 1:1.5 to 1:30 and m and n not being able to simultaneously be 0. However, preferably only one of the variables n and m is different from 0.

By non-aromatic hydrocarbon radicals is meant radicals which contain no aromatic groups or which themselves represent one. The hydrocarbon radicals may be interrupted by oxygen atoms (i.e., contain one or more ether groups).

R is preferably a straight-chain or branched aliphatic hydrocarbon radical which may be interrupted by oxygen atoms. Saturated, uncross-linked hydrocarbon radicals are quite particularly preferred. However, as noted above, R may, in certain embodiments, be aromatic ring-containing.

Through the use of the compounds of Formula (I) for the production of battery separators, they may be effectively protected against oxidative destruction.

Battery separators are preferred which contain a compound according to Formula (I) in which:
R is a hydrocarbon radical with 10 to 180, preferably 12 to 75 and quite particularly preferably 14 to 40 carbon atoms, which may be interrupted by 1 to 60, preferably 1 to 20 and quite particularly preferably 1 to 8 oxygen atoms, particularly preferably a hydrocarbon radical of formula R²—[(OC₂H₄)ₚ(OC₃H₆)_{q}]—, in which:
R² is an alkyl radical with 10 to 30 carbon atoms, preferably 12 to 25, particularly preferably 14 to 20 carbon atoms, wherein R² can be linear or non-linear such as containing an aromatic ring;
P is an integer from 0 to 30, preferably 0 to 10, particularly preferably 0 to 4; and
q is an integer from 0 to 30, preferably 0 to 10, particularly preferably 0 to 4;
compounds being particularly preferred in which the sum of p and q is 0 to 10, in particular 0 to 4;
n=1; and
m=0.

Formula R²—[(OC₂H₄)ₚ(OC₃H₆)_{q}]— is to be understood as also including those compounds in which the sequence of the groups in square brackets differs from that shown. For example according to the invention compounds are suitable in which the radical in brackets is formed by alternating (OC₂H₄) and (OC₃H₆) groups.

Additives in which R² is a straight-chain or branched alkyl radical with 10 to 20, preferably 14 to 18 carbon atoms have proved to be particularly advantageous. OC₂H₄ preferably stands for OCH₂CH₂, OC₃H for OCH(CH₃)₂ and/or OCH₂CH₂CH₃.

As preferred additives there may be mentioned in particular alcohols (p=q=0; m=0) primary alcohols being particularly preferred, fatty alcohol ethoxylates (p=1 to 4, q=0), fatty alcohol propoxylates (p=0; q=1 to 4) and fatty alcohol alkoxylates (p=1 to 2; q=1 to 4) ethoxylates of primary alcohols being preferred. The fatty alcohol alkoxylates are for example accessible through reaction of the corresponding alcohols with ethylene oxide or propylene oxide.

Additives of the type m=0 which are not, or only difficulty, soluble in water and sulphuric acid have proved to be particularly advantageous.

Also preferred are additives which contain a compound according to Formula (I), in which:
R is an alkane radical with 20 to 4200, preferably 50 to 750 and quite particularly preferably 80 to 225 carbon atoms;
M is an alkali metal or alkaline-earth metal ion, H⁺ or NH₄, in particular an alkali metal ion such as Li⁺, Na⁺ and K⁺ or H⁺, where not all the variables M simultaneously have the meaning H⁺;
n=0;
m is an integer from 10 to 1400; and
x=1 or 2.

Salt Additives

In certain embodiments, suitable additives may include, in particular, polyacrylic acids, polymethacrylic acids and acrylic acid-methacrylic acid copolymers, whose acid groups are at least partly neutralized, such as by preferably 40%, and particularly preferably by 80%. The percentage refers to the number of acid groups. Quite particularly preferred are poly(meth)acrylic acids which are present entirely in the salt form. Suitable salts include Li, Na, K, Rb, Be, Mg, Ca, Sr, Zn, and ammonium (NR₄, wherein R is either hydrogen or a carbon functional group). Poly(meth)acrylic acids may include polyacrylic acids, polymethacrylic acids, and acrylic acid-methacrylic acid copolymers. Poly(meth)acrylic acids are preferred and in particular polyacrylic acids with an average molar mass MW of 1,000 to 100,000 g/mol, particularly preferably 1,000 to 15,000 g/mol and quite particularly preferably 1,000 to 4,000 g/mol. The molecular weight of the poly(meth)acrylic acid polymers and copolymers is ascertained by measuring the viscosity of a 1% aqueous solution, neutralized with sodium hydroxide solution, of the polymer (Fikentscher's constant).

Also suitable are copolymers of (meth)acrylic acid, in particular copolymers which, besides (meth)acrylic acid contain ethylene, maleic acid, methyl acrylate, ethyl acrylate, butyl acrylate and/or ethylhexyl acrylate as comonomer. Copolymers are preferred which contain at least 40% by weight and preferably at least 80% by weight (meth)acrylic acid monomer, the percentages being based on the acid form of the monomers or polymers.

To neutralize the polyacrylic acid polymers and copolymers, alkali metal and alkaline-earth metal hydroxides such as potassium hydroxide and in particular sodium hydroxide are particularly suitable. In addition, a coating and/or additive to enhance the separator may include, for example, a metal alkoxide, wherein the metal may be, by way of example only (not intended to be limiting), Zn, Na, or Al, by way of example only, sodium ethoxide.

In some embodiments, the porous polyolefin porous membrane may include a coating on one or both sides of such layer. Such a coating may include a surfactant or other material. In some embodiments, the coating may include one or more materials described, for example, in U.S. Pat. No. 9,876,209, which is incorporated by reference herein. Such a coating may, for example, reduce the overcharge voltage of the battery system, thereby extending battery life with less grid corrosion and preventing dry out and/or water loss.

Ratios

In certain select embodiments, the membrane may be prepared by combining, by weight, about 5-15% polymer, in some instances, about 10% polymer (e.g., polyethylene), about 10-75% filler (e.g., silica), in some instances, about 30% filler, and about 10-85% processing oil, in some instances, about 60% processing oil. In other embodiments, the filler content is reduced, and the oil content is higher, for instance, greater than about 61%, 62%, 63%, 64%, 65%, 66%, 67%, 68%, 69% or 70% by weight. The filler:polymer ratio (by weight) may be about (or may be between about these specific ranges) such as 2:1, 2.5:1, 3:1, 3.5:1, 4.0:1, 4.5:1, 5.0:1, 5.5:1 or 6:1. The filler:polymer ratio (by weight) may be from about 1.5:1 to about 6:1, in some instances, 2:1 to 6:1, from about 2:1 to 5:1, from about 2:1 to 4:1, and in some instances, from about 2:1 to about 3:1. The amounts of the filler, the oil, and polymer are all balanced for runnability and desirable separator properties, such as electrical resistance, basis weight, puncture resistance, bending stiffness, oxidation resistance, porosity, physical strength, tortuosity, and the like.

In accordance with at least one embodiment, the porous membrane can include an UHMWPE mixed with a processing oil and precipitated silica. In accordance with at least one embodiment, the porous membrane can include an UHMWPE mixed with a processing oil, additive and precipitated silica. The mixture may also include minor amounts of other additives or agents as is common in the separator arts (e.g., surfactants, wetting agents, colorants, antistatic additives, antioxidants, and/or the like, and any combination thereof). In certain instances, the porous polymer layer may be a homogeneous mixture of 8 to 100% by volume of polyolefin, 0 to 40% by volume of a plasticizer and 0 to 92% by volume of inert filler material. The preferred plasticizer is petroleum oil. Since the plasticizer is the component which is easiest to remove, by solvent extraction and drying, from the polymer-filler-plasticizer composition, it is useful in imparting porosity to the battery separator.

In certain embodiments, the porous membrane disclosed herein may contain latex and/or rubber, which may be a natural rubber, synthetic rubber, or a mixture thereof. Natural rubbers may include one or more blends of polyisoprenes, which are commercially available from a variety of suppliers. Exemplary synthetic rubbers include methyl rubber, polybutadiene, chloropene rubbers, butyl rubber, bromobutyl rubber, polyurethane rubber, epichlorhydrin rubber, polysulphide rubber, chlorosulphonyl polyethylene, polynorbornene rubber, acrylate rubber, fluorine rubber and silicone rubber and copolymer rubbers, such as styrene/butadiene rubbers, acrylonitrile/butadiene rubbers, ethylene/propylene rubbers (EPM and EPDM) and ethylene/vinyl acetate rubbers. The rubber may be a cross-linked rubber or an uncross-linked rubber; in certain preferred embodiments, the rubber is uncross-linked rubber. In certain embodiments, the rubber may be a blend of cross-linked and uncross-linked rubber. The rubber may be present in the separator in an amount that is at least about 1%, 2%, 3%, 4%, 5%, 6%, 7%, 8%, 9%, or 10% by weight relative to the final separator weight (the weight of the polyolefin separator sheet or layer containing rubber and/or latex). In certain embodiments, the rubber may be present in an amount from approximately 1-6%, approximately 3-6% by weight, approximately 3% by weight, and approximately 6% by weight. The porous membrane may have a filler to polymer and rubber (filler:polymer and rubber) weight ratio of approximately 2.6:1.0. The amounts of the rubber, filler, oil, and polymer are all balanced for runnability and desirable separator properties, such as electrical resistance, basis weight, puncture resistance, bending stiffness, oxidation resistance, porosity, physical strength, tortuosity, and the like.

A porous membrane made in accordance with the present invention, comprising polyethylene and filler (e.g., silica) typically has a residual oil content; in some embodiments, such residual oil content is from about 0.5% up to about 40% of the total weight of the separator membrane (in some instances, about 10-40% of the total weight of the separator membrane, and in some instances, about 20-40% of that total weight). In certain select embodiments herein, some to all of the residual oil content in the separator may be replaced by the addition of more of a performance enhancing additive, such as a surfactant, such as a surfactant with a hydrophilic-lipophilic balance (“HLB”) less than 6, or such as a nonionic surfactant. For example, a performance enhancing additive such as a surfactant, such as a nonionic surfactant, may comprise up to 0.5% all the way up to all of the amount of the residual oil content (e.g., all the way up to 20% or 30% or even 40%) of the total weight of the porous separator membrane, thereby partially or completely replacing the residual oil in the separator membrane.

Manufacture

In some embodiments, an exemplary porous membrane may be made by mixing the constituent parts in an extruder. For example, about 30% by weight filler with about 10% by weight UHMWPE, and about 60% processing oil may be mixed in an extruder. The exemplary porous membrane may be made by passing the constituent parts through a heated extruder, passing the extrudate generated by the extruder through a die and into a nip formed by two heated presses or calender stack or rolls to form a continuous web. A substantial amount of the processing oil from the web may be extracted by use of a solvent, thereby followed with removing the solvent by drying. The web may then be cut into lanes of predetermined width, and then wound onto rolls. Additionally, the presses or calender rolls may be engraved with various groove patterns to impart ribs, grooves, textured areas, embossments, and/or the like as substantially described herein.

Manufacture with Rubber

In some embodiments, an exemplary porous membrane may be made by mixing the constituent parts in an extruder. For example, about 5-15% by weight polymer (e.g., polyethylene), about 10-75% by weight filler (e.g., silica), about 1-50% by weight rubber and/or latex, and about 10-85% processing oil may be mixed in an extruder. The exemplary porous membrane may be made by passing the constituent parts through a heated extruder, passing the extrudate generated by the extruder through a die and into a nip formed by two heated presses or calender stack or rolls to form a continuous web. A substantial amount of the processing oil from the web may be extracted by use of a solvent. The web may then be dried and slit into lanes of predetermined width, and then wound onto rolls. Additionally, the presses or calender rolls may be engraved with various groove patterns to impart ribs, grooves, textured areas, embossments, and/or the like as substantially described herein. The amounts of the rubber, filler, oil, and polymer are all balanced for runnability and desirable separator properties, such as electrical resistance, basis weight, puncture resistance, bending stiffness, oxidation resistance, porosity, physical strength, tortuosity, and the like.

In addition to being added to the constituent parts of the extruder, certain embodiments combine the rubber to the porous membrane after extrusion. For example, the rubber may be coated onto one or both sides, preferably on the side facing the negative electrode, with a liquid slurry comprising the rubber and/or latex, optionally, silica, and water, and then dried such that a film of this material is formed upon the surface of an exemplary porous membrane. For better wettability of this layer, known wetting agents may be added to the slurry for use in lead acid batteries. In certain embodiments, the slurry can also contain one or more performance enhancing additives as described herein. After drying, a porous layer and/or film forms on the surface of the separator, which adheres very well to the porous membrane and increases electrical resistance only insignificantly, if at all. After the rubber is added, it may be further compressed using either a machine press or calender stack or roll. Other possible methods to apply the rubber and/or latex are to apply a rubber and/or latex slurry by dip coat, roller coat, spray coat, or curtain coat one or more surfaces of the separator, or any combination thereof. These processes may occur before or after the processing oil has been extracted, or before or after it is slit into lanes.

A further embodiment of the present invention involves depositing rubber onto the membrane by impregnation and drying.

Manufacture with Performance Enhancing Additives

In certain embodiments, performance enhancing additives or agents (e.g., surfactants, wetting agents, colorants, antistatic additives, antioxidants, and/or the like, and any combination thereof) may also be mixed together with the other constituent parts within the extruder. A porous membrane according to the present disclosure may then be extruded into the shape of a sheet or web, and finished in substantially the same way as described above.

In certain embodiments, and in addition or alternative to adding into the extruder, the additive or additives may, for example, be applied to the separator porous membrane when it is finished (e.g., after extracting a bulk of the processing oil, and before or after the introduction of the rubber). According to certain preferred embodiments, the additive or a solution (e.g., an aqueous solution) of the additive is applied to one or more surfaces of the separator. This variant is suitable in particular for the application of non-thermostable additives and additives which are soluble in the solvent used for the extraction of processing oil. Particularly suitable as solvents for the additives according to the invention are low-molecular-weight alcohols, such as methanol and ethanol, as well as mixtures of these alcohols with water. The application can take place on the side facing the negative electrode, the side facing the positive electrode, or on both sides of the separator. The application may also take place during the extraction of the pore forming agent (e.g., the processing oil) while in a solvent bath. In certain select embodiments, some portion of a performance enhancing additive, such as a surfactant coating or a performance enhancing additive added to the extruder before the separator is made (or both) may combine with the antimony in the battery system and may inactivate it and/or form a compound with it and/or cause it to drop down into the mud rest of the battery and/or prevent it from depositing onto the negative electrode. The surfactant or additive may also be added to the electrolyte, the glass mat, the battery case, pasting paper, pasting mat, and/or the like, or combinations thereof.

In certain embodiments, the additive (e.g., a non-ionic surfactant, an anionic surfactant, or mixtures thereof) may be present at a density or add-on level of at least 0.5 g/m², 1.0 g/m², 1.5 g/m², 2.0 g/m², 2.5 g/m², 3.0 g/m², 3.5 g/m², 4.0 g/m², 4.5 g/m², 5.0 g/m², 5.5 g/m², 6.0 g/m², 6.5 g/m², 7.0 g/m², 7.5 g/m², 8.0 g/m², 8.5 g/m², 9.0 g/m², 9.5 g/m² or 10.0 g/m² or even up to about 25.0 g/m². The additive may be present on the separator at a density or add-on level between 0.5-15 g/m², 0.5-10 g/m², 1.0-10.0 g/m², 1.5-10.0 g/m², 2.0-10.0 g/m², 2.5-10.0 g/m², 3.0-10.0 g/m², 3.5-10.0 g/m², 4.0-10.0 g/m², 4.5-10.0 g/m², 5.0-10.0 g/m², 5.5-10.0 g/m², 6.0-10.0 g/m², 6.5-10.0 g/m², 7.0-10.0 g/m², 7.5-10.0 g/m², 4.5-7.5 g/m², 5.0-10.5 g/m², 5.0-11.0 g/m², 5.0-12.0 g/m², 5.0-15.0 g/m², 5.0-16.0 g/m², 5.0-17.0 g/m², 5.0-18.0 g/m², 5.0-19.0 g/m², 5.0-20.0 g/m², 5.0-21.0 g/m², 5.0-22.0 g/m², 5.0-23.0 g/m², 5.0-24.0 g/m², or 5.0-25.0 g/m².

The application may also take place by dipping the battery separator in the additive or a solution of the additive (solvent bath addition) and removing the solvent if necessary (e.g., by drying). In this way the application of the additive may be combined, for example, with the extraction often applied during membrane production. Other preferred methods are to spray the surface with additive, dip coat, roller coat, or curtain coat the one or more additives on the surface of separator.

In certain embodiments described herein, a reduced amount of ionic, cationic, anionic, or non-ionic surfactant is added to the inventive separator. In such instances, a desirable feature may include lowered total organic carbons and/or lowered volatile organic compounds (because of the lower amount of surfactant) may produce a desirable inventive separator according to such embodiment.

Combined with a Fibrous Mat

In certain embodiments, exemplary separators according to the present disclosure may be combined with another layer (laminated or otherwise), such as a fibrous layer or fibrous mat having enhanced wicking properties and/or enhanced wetting or holding of electrolyte properties. The fibrous mat may be woven, nonwoven, fleeces, mesh, net, single layered, multi-layered (where each layer may have the same, similar or different characteristics than the other layers), composed of glass fibers, or synthetic fibers, fleeces or fabrics made from synthetic fibers or mixtures with glass and synthetic fibers or paper, or any combination thereof.

In certain embodiments, the fibrous mat (laminated or otherwise) or mats may be used as a carrier for additional materials. The addition material may include, for example, rubber and/or latex, optionally silica, water, and/or one or more performance enhancing additive, such as various additives described herein, or any combination thereof. By way of example, the additional material may be delivered in the form of a slurry that may then be coated onto one or more surfaces of the fibrous mat to form a film, or soaked and impregnated into the fibrous mat.

When the fibrous layer is present, it is preferred that the porous membrane has a larger surface area than the fibrous layers. Thus, when combining the porous membrane and the fibrous layers, the fibrous layers do not completely cover the porous layer. It is preferred that at least two opposing edge regions of the membrane layer remain uncovered to provide edges for heat sealing which facilitates the optional formation of pockets or envelopes and/or the like. Such a fibrous mat may have a thickness that is at least 100 μm, in some embodiments, at least about 200 μm, at least about 250 μm, at least about 300 μm, at least about 400 μm, at least about 500 μm, at least about 600 μm, at least about 700 μm, at least about 800 μm, at least about 900 μm, at least about 1 mm, at least about 2 mm, and so forth. The subsequent laminated separator may be cut into pieces. In certain embodiments, the fibrous mat is laminated to a ribbed surface of the porous membrane porous membrane. In certain embodiments, handling and/or assembly advantages are provided to the battery maker with the improved separator described herein, as it may be supplied in roll form and/or cut piece form. And as mentioned previously, the improved separator may be a standalone separator sheet or layer without the addition of one or more fibrous mats or the like.

If the fibrous mat is laminated to the porous membrane, they may be bonded together by adhesive, heat, ultrasonic welding, compression, and/or the like, or any combination thereof. And, the fibrous mat may be a PAM or NAM retention mat.

### EXAMPLES

The following examples further illustrate at least selected separator embodiments of the instant invention.

In certain embodiments, the following precipitated silicas can be employed to obtain separators according to the invention:

Median particle size 20.48 μm, mean particle size, 24.87 μm (as measured using Coulter LS230)

Silica samples shown below in Table 3 having the following characteristics were employed in the preparation of separators:

TABLE 3

| | Oil | Surface | Tap |
|---|---|---|---|
| | Absorption | Area | Density |
| | ml/100 g | m²/g | g/l |
| Silica A | 225 | 180 | 170 |
| Silica B | 275 | 180 | 140 |

Polyethylene separators made using the above silica had the following properties shown below in Tables 4 and 5:

TABLE 4

| Product | | | |
|---|---|---|---|
| Properties | Unit | Separator 1 | Separator 2 |
| Backweb | mm | 0.250 | 0.250 |
| thickness | | | |
| Silica type | | Silica A | Silica B |
| Si/PE ratio | | 2.6:1 | 2.6:1 |
| Starting oil | % | 64.0 | 67.0 |
| content | | | |
| Final oil | % | 15.5 | 16.5 |
| content | | | |
| Basis weight | g/m² | 161 | 157 |
| Puncture | N | 14.1 | 13.1 |
| resistance | | | |
| Porosity | % | 61.5 | 65.1 |
| Wettability | Sec | 49 | 29 |
| ER 10 min | mΩ · cm² | 49 | 40 |
| boil | | | |
| ER 20 min | mΩ · cm² | 65 | 50 |
| soak | | | |
| Elongation - | % | 23 | 25 |
| MD | | | |
| Elongation - | % | 430 | 484 |
| CMD | | | |
| Perox 20 hrs | % | 388 | 350 |
| Perox 40 hrs | % | 333 | 283 |
| Acid | % | −0.9 | −0.8 |
| shrinkage | | | |
| Hg-Pore | μm | 0.099 | 0.126 |
| Size | | | |

TABLE 5

| | | Separator 3 | | | |
|---|---|---|---|---|---|
| | | (Corresponds to | | | |
| | | Example 3 | | | |
| Product | | in Table 9 | | | |
| Properties | Unit | Below) | Separator 4 | Separator 5 | Separator 6 |
| Profile | | Ribbed PE, | Ribbed PE, | Ribbed PE, | Ribbed PE, |
| | | greater than | greater than | fewer than | fewer than |
| | | 12 major | 12 major | 12 major | 12 major |
| | | ribs, lower | ribs, lower | ribs, higher | ribs, higher |
| | | rib height | rib height | rib height | rib height |
| Back web | μm | 250 | 250 | 250 | 250 |
| thickness | | | | | |
| Silica type | | B | A | B | A |
| Si/PE | | 2.6:1 | 2.6:1 | 2.6:1 | 2.6:1 |
| ratio | | | | | |
| Starting oil | % | 67 | 64 | 67 | 64 |
| content | | | | | |
| Final | % | 16.0 | 16.3 | 15.0 | 16.7 |
| oil content | | | | | |
| Coating | | NI | None | NI | None |
| | | (non-ionic) | | (non-ionic) | |
| | | Surfactant | | Surfactant | |
| Porosity | % | 63.8 | 61.7 | 64.4 | 60.6 |
| Electrical | mΩ · cm² | 42 | 50 | 45 | 62 |
| Resistance | | | | | |
| 20 | mΩ · cm² | 43 | 55 | 46 | 65 |
| minute soak | | | | | |
| ER | | | | | |
| Wettability | sec | 6 | 39 | 10 | 73 |
| Puncture | N | 12.9 | 14.7 | 12.2 | 13.9 |
| Resistance | | | | | |
| Elongation - | % | 528 | 419 | 587 | 383 |
| CMD | | | | | |
| Acid | % | −0.7 | −0.8 | −0.3 | −0.1 |
| Shrinkage | | | | | |

Additionally, in further embodiments, the following silica fillers, described below in Table 6, were employed in the separators described in Table 7, below:

TABLE 6

| | | Silica C | Silica D | Silica E | Silica F |
|---|---|---|---|---|---|
| Oil | ml/100 g | 245 | 215 | 270 | 210 |
| Absorption | | | | | |
| Surface Area | m²/g | 180 | 130 | 195 | 180 |
| Bulk | g/l | 100 | 125 | No | No |
| Density | | | | data | data |

TABLE 7

| | | Sepa- | Sepa- | Sepa- | Sepa- |
|---|---|---|---|---|---|
| | | rator 7 | rator 8 | rator 9 | rator 10 |
| Back web | mm | 0.200 | 0.206 | 0.200 | 0.201 |
| Thickness | | | | | |
| Silica Type | | C | D | E | F |
| Si/PE | | 2.6:1 | 2.6:1 | 2.6:1 | 2.6:1 |
| ratio | | | | | |
| Starting oil | % | 68.0 | 65.1 | 67.0 | 65.2 |
| content | | | | | |
| Basis | g/m² | 109.6 | 122.4 | 122.0 | 125.3 |
| Weight | | | | | |
| Final | % | 15.1 | 16.4 | 15.8 | 14.9 |
| oil content | | | | | |
| Porosity | % | 65.9 | 63.6 | 65.7 | 63.4 |
| ER | mΩ · cm² | 36 | 46 | 33 | 48 |
| 10′ Boil | | | | | |
| Wettability | sec | 2 | 2 | 4 | 3 |
| Elongation - | % | 275 | 329 | 294 | 311 |
| CMD | | | | | |
| Puncture | N | 12.4 | 13.0 | 10.8 | 13.9 |
| Resistance | | | | | |

### Further Examples

In the following set of examples, inventive enhanced flooded separators were made according to various embodiments of the present invention and tested compared with a control separator. The results are shown just below in Table 8.

TABLE 8

| | Example A | | Example B | |
|---|---|---|---|---|
| | Enhanced | | Enhanced | |
| | Flooded | Control | Flooded | SPEC |
| Property | Separator A | Separator A | Separator B | (BS-DA-961-4) |
| Profile | Ribbed | Ribbed | Ribbed | — |
| | PE, fewer than | PE, fewer than | PE, greater than | |
| | 12 major ribs | 12 major ribs | 12 major ribs, | |
| | | | lower rib height | |
| Backweb | 0.256 | 0.257 | 0.253 | 0.250 ± 0.040 |
| thickness (mm) | | | | |
| Puncture | 12.5 | 12.2 | — | Min. 10.0 |
| resistance (N) | | | | |
| Total oil | 15.3 | 16.1 | 14.9 | 17.0 ± 3.0 |
| content (%) | | | | |
| Backweb oil | 14.4 | 14.4 | — | Min. 8.0 |
| content (%) | | | | |
| CMD | 530 (100%) | 482 (100%) | — | Min. 150 |
| elongation (%) | | | | |
| Elongation | 379 (72%) | 355 (74%) | — | Min. 100 |
| after Perox 20 h (%) | | | | |
| Elongation | 165 (31%) | — | — | — |
| after Perox 40 h (%) | | | | |
| ER 10′ boil | 71 | 86 | 65 | Max. 140 |
| (mΩ · cm²) | | | | |
| Wettability | 45 | 141 | 39 | — |
| (sec) | | | | |
| Porosity (%) | 64.3 | 57.6 | 65.5 | 60.0 ± 7.5 |

The results above in Table 8 show that the separator of Example A exhibited almost 20% lower ER compared with the control separator A. Similarly, the separator of Example B exhibited more than 20% lower ER compared with the control separator A. These desirable lower ER results occurred despite the fact that the porosity percentages for the inventive separators A and B were within the tolerances (60%+/−7.5%) for the porosity of such a separator. Thus, the novel and unexpected pore structure of the separator contributed to the lowered ER combined with a porosity percentage for the separator that is in line with (not much more than) the porosity of a known separator.

### Additional Examples

Several separators were formed according to the present invention. Those separators were compared to comparative separators. SEMs of the inventive separators were taken to image the shish-kebab formations of the inventive separators.

### Example 1

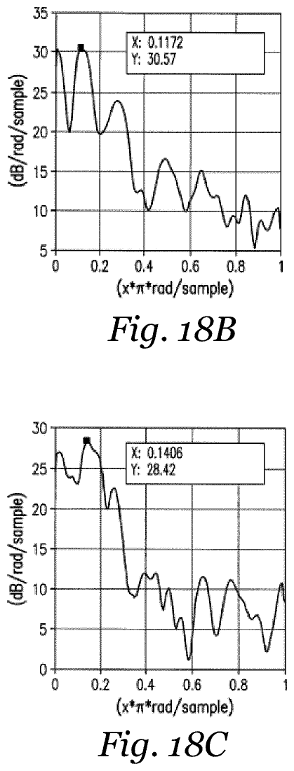

In Example 1, an enhanced flooded separator having a backweb thickness of 250 μm was made according to the present invention using UHMWPE, silica, and oil, and the silica used was a high oil absorption silica. An SEM of the inventive, low ER separator, was taken, see FIG. 17.

Three shish-kebab regions, numbered Nos. 1, 2 and 3 respectively, were identified on the SEM of FIG. 17A, the SEM of the separator of Example 1. Then, FTIR spectra profiles were taken of each of the three shish-kebab regions, see FIGS. 17B-17D. The FTIR spectra taken of each of the three shish-kebab regions (Nos. 1, 2, and 3) of the SEM of FIG. 17A of the separator of Example 1 revealed the following peak position information and periodicity or repetition of the shish-kebab formations or morphology, shown in Table 9, below.

TABLE 9

| | Shish-kebab region number | | |
|---|---|---|---|
| | No. 1 | No. 2 | No. 3 |
| Peak | 0.1172 | 0.1484 | 0.1094 |
| position | | | |
| Periodicity | 0.057 | 0.047 | 0.085 |
| or repetition of | (57 nm) | (47 nm) | (85 nm) |
| the shish-kebab | | | |
| formation | | | |

Ultimately, an average repetition or periodicity of the shish-kebab morphology or structure was obtained, of 63 nm.

### Example 2

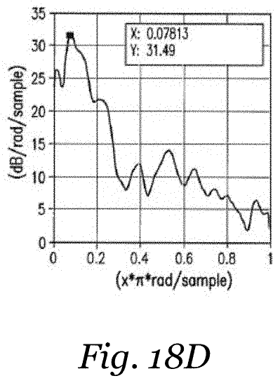

Further, for Example 2, an enhanced flooded separator having a backweb thickness of 200 μm was made according to the present invention, in the same manner as Example 1 above, using UHMWPE, silica, and oil, and the silica used was a high oil absorption silica. An SEM of the inventive, low ER separator, was taken, see FIG. 18A.

Three shish-kebab regions, numbered Nos. 1, 2 and 3 respectively, were identified on the SEM of FIG. 18A, the SEM of the separator of Example 2. Then, FTIR spectra profiles were taken of each of the three shish-kebab regions, see FIGS. 18B-18D. The FTIR spectra taken of each of the three shish-kebab regions (Nos. 1, 2, and 3) of the SEM of FIG. 18A of the separator of Example 2 revealed the following peak position information and periodicity or repetition of the shish-kebab formations or morphology, shown in Table 10, below.

TABLE 10

| | Shish-kebab region number | | |
|---|---|---|---|
| | No. 1 | No. 2 | No. 3 |
| Peak | 0.1172 | 0.1406 | 0.07813 |
| position | | | |
| Periodicity | 0.057 | 0.047 | 0.085 |
| or repetition of | (57 nm) | (47 nm) | (85 nm) |
| the shish-kebab | | | |
| formation | | | |

Ultimately, an average repetition or periodicity of the shish-kebab morphology or structure was obtained, of 63 nm.

### Example 3

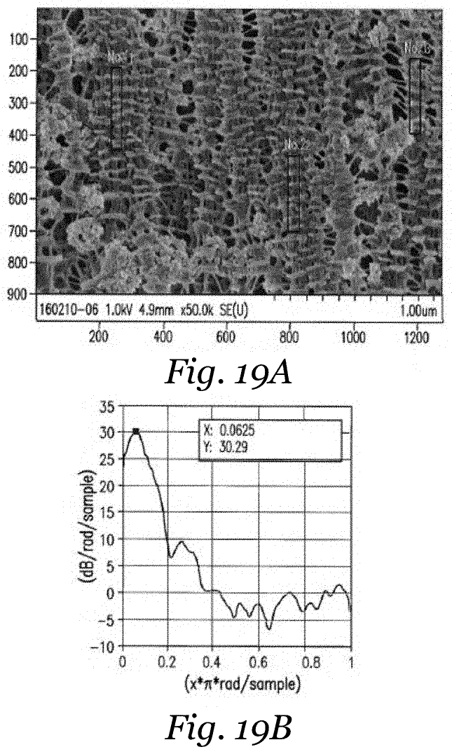

For Example 3, an enhanced flooded separator having a backweb thickness of 250 μm was made according to the present invention, in the same manner as Example 1 above, using UHMWPE, silica, and oil, and the silica used was a high oil absorption silica. An SEM of the inventive, low ER separator, was taken, see FIG. 19A.

Three shish-kebab regions, numbered Nos. 1, 2 and 3 respectively, were identified on the SEM of FIG. 19A, the SEM of the separator of Example 3. Then, FTIR spectra profiles were taken of each of the three shish-kebab regions, see FIGS. 19B-19D. The FTIR spectra taken of each of the three shish-kebab regions (Nos. 1, 2, and 3) of the SEM of FIG. 19A of the separator of Example 3 revealed the following peak position information and periodicity or repetition of the shish-kebab formations or morphology, shown in Table 11, below.

TABLE 11

| | Shish-kebab region number | | |
|---|---|---|---|
| | No. 1 | No. 2 | No. 3 |
| Peak | 0.0625 | 0.05469 | 0.04688 |
| position | | | |
| Periodicity | 0.063 | 0.073 | 0.085 |
| or repetition of | (63 nm) | (73 nm) | (85 nm) |
| the shish-kebab | | | |
| formation | | | |

Ultimately, an average repetition or periodicity of the shish-kebab morphology or structure was obtained, of 74 nm.

### Example 4

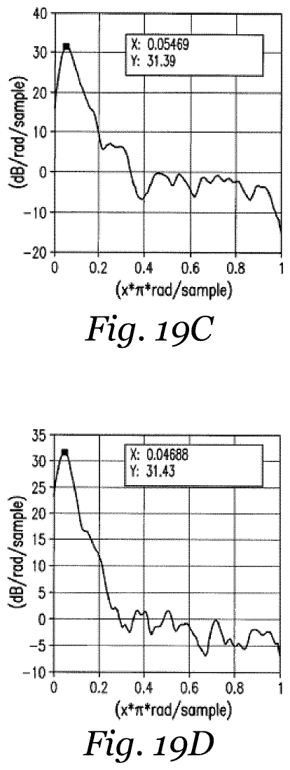

For Example 4, an enhanced flooded separator having a backweb thickness of 250 μm was made according to the present invention, in the same manner as Example 1 above, using UHMWPE, silica, and oil, and the silica used was a high oil absorption silica (a different high oil absorption silica from the silica used in Examples 1-3 above; each of the high oil absorption silicas used to make the separators of Examples 1-5 range from about 230 to about 280 ml/100 g). An SEM of the inventive, low ER separator, was taken, see FIG. 20A.

Three shish-kebab regions, numbered Nos. 1, 2 and 3 respectively, were identified on the SEM of FIG. 20A, the SEM of the separator of Example 4. Then, FTIR spectra profiles were taken of each of the three shish-kebab regions, see FIGS. 20B-20D. The FTIR spectra taken of each of the three shish-kebab regions (Nos. 1, 2, and 3) of the SEM of FIG. 20A of the separator of Example 4 revealed the following peak position information and periodicity or repetition of the shish-kebab formations or morphology, shown in Table 12, below.

TABLE 12

| | Shish-kebab region number | | |
|---|---|---|---|
| | No. 1 | No. 2 | No. 3 |
| Peak | 0.07031 | 0.07031 | 0.07813 |
| position | | | |
| Periodicity | 0.056 | 0.056 | 0.051 |
| or repetition of | (56 nm) | (56 nm) | (51 nm) |
| the shish-kebab | | | |
| formation | | | |

Ultimately, an average repetition or periodicity of the shish-kebab morphology or structure was obtained, of 55 nm.

### Example 5

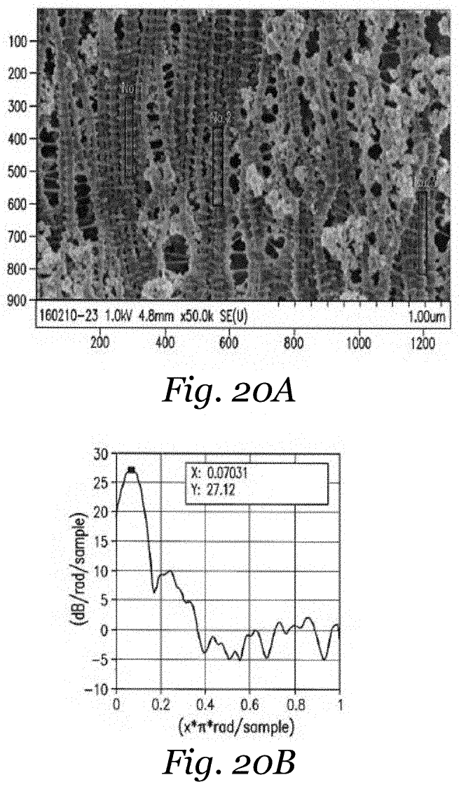

For this example, Example 5, an enhanced flooded separator having a backweb thickness of 250 μm was made according to the present invention, in the same manner as Example 1 above, using UHMWPE, silica, and oil, and the silica used was a high oil absorption silica (a different high oil absorption silica from the silica used in Examples 1-3 above and from the silica used in Example 4 above). An SEM of the inventive, low ER separator, was taken, see FIG. 21A.

Three shish-kebab regions, numbered Nos. 1, 2 and 3 respectively, were identified on the SEM of FIG. 21A, the SEM of the separator of Example 5. Then, FTIR spectra profiles were taken of each of the three shish-kebab regions, see FIGS. 21B-21D. The FTIR spectra taken of each of the three shish-kebab regions (Nos. 1, 2, and 3) of the SEM of FIG. 21A of the separator of Example 5 revealed the following peak position information and periodicity or repetition of the shish-kebab formations or morphology, shown in Table 13, below.

TABLE 13

| | Shish-kebab region number | | |
|---|---|---|---|
| | No. 1 | No. 2 | No. 3 |
| Peak | 0.07031 | 0.0625 | 0.0625 |
| position | | | |
| Periodicity | 0.056 | 0.063 | 0.063 |
| or repetition of | (56 nm) | (63 nm) | (63 nm) |
| the shish-kebab | | | |
| formation | | | |

Ultimately, an average repetition or periodicity of the shish-kebab morphology or structure was obtained, of 61 nm.

### Comparative Example 1

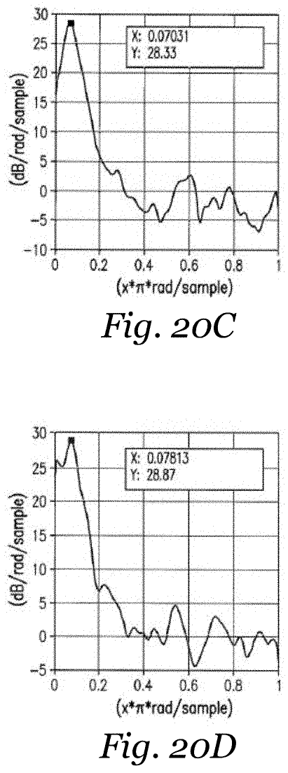

A comparative polyethylene lead acid battery separator was obtained, the separator having a backweb thickness of 250 μm. An SEM of the Comparative Example 1 separator was taken, see FIG. 22A.

Three regions, numbered Nos. 1, 2 and 3 respectively, were identified on the SEM of FIG. 22A, the SEM of the separator of Comparative Example 1. Then, FTIR spectra profiles were taken of each of those three regions, see FIGS. 22B-22D. The FTIR spectra taken of each of the three numbered regions (Nos. 1, 2, and 3) of the SEM of FIG. 22A of the separator of Comparative Example 1 revealed the following peak position information and periodicity or repetition information regarding the crystalline structure and/or morphology of those three regions, shown in Table 14, below.

TABLE 14

| | Region number | | |
|---|---|---|---|
| | No. 1 | No. 2 | No. 3 |
| Peak | 0.03906 | 0.03906 | 0.03906 |
| position | | | |
| Periodicity | 0.170 | 0.170 | 0.170 |
| or repetition of | (170 nm) | (170 nm) | (170 nm) |
| the crystalline | | | |
| structure of | | | |
| morphology of | | | |
| the region | | | |

Ultimately, an average repetition or periodicity of the crystalline structure or morphology of the identified regions was obtained, of 170 nm.

### Comparative Example 2

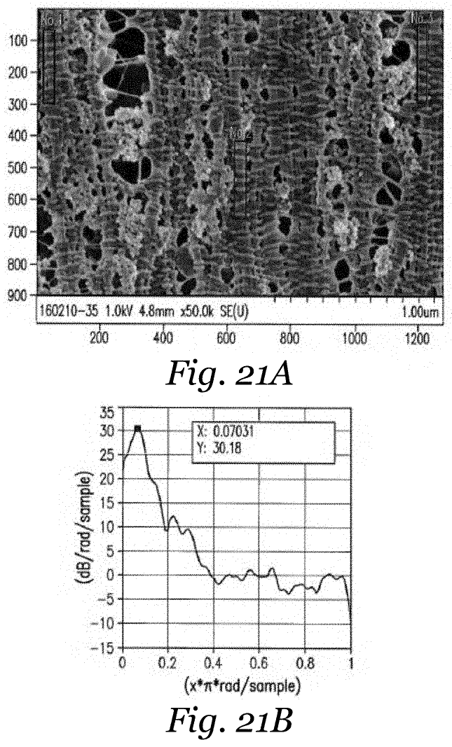

Another comparative polyethylene lead acid battery separator was obtained, the separator having a backweb thickness of 250 μm. An SEM of the Comparative Example 2 separator was taken, see FIG. 23A.

A region of the separator SEM image, numbered No. 1, was identified on the SEM of FIG. 23A, the SEM of the separator of Comparative Example 2. Then, an FTIR spectra profile was taken of that region, see FIG. 23B. The FTIR spectrum taken of the region (No. 1) of the SEM of FIG. 23A of the separator of Comparative Example 2 revealed the following peak position information and periodicity or repetition information regarding the crystalline structure and/or morphology of that region, shown in Table 15, below.

TABLE 15

| Region number | No. 1 |
|---|---|
| Peak position | 0.03125 |
| Periodicity | 0.212 |
| or repetition of | (212 nm) |
| the crystalline | |
| structure of | |
| morphology of | |
| the region | |

Thus, the repetition or periodicity of the crystalline structure or morphology of the identified region was 212 nm.

### Comparative Example 3

Yet another comparative polyethylene lead acid battery separator was obtained, this one commercially available from Daramic, LLC. The separator had a backweb thickness of 250 μm. This separator was made similarly to the separators described in Examples 1-5 above, but the silica used to make this separator was not one with a high oil absorption value.

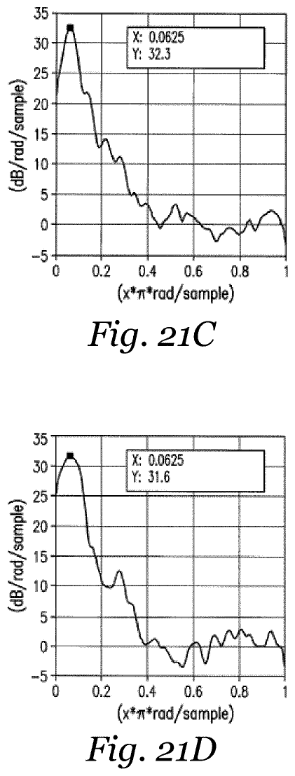

An SEM of the Comparative Example 3 separator was taken, see FIG. 24. Observing FIG. 25, there were no shish-kebab formations which were continuously extending in the length of at least 0.5 μm or longer in this SEM image of the polyolefin microporous membrane. Therefore, no regions were marked on the SEM or further analyzed.

Table 16, below, compares the results obtained for the periodicity or repetition of the shish-kebab regions of Examples 1-5 versus results obtained for Comparative Examples 1-3.

TABLE 16

| Region | Example | | | | | | | |
|---|---|---|---|---|---|---|---|---|
| Number | Ex. 1 | Ex. 2 | Ex. 3 | Ex. 4 | Ex. 5 | CE 1 | CE 2 | CE 3 |
| No. 1 | 57 nm | 57 nm | 63 nm | 56 nm | 56 nm | 170 nm | 212 nm | — |
| No. 2 | 47 nm | 47 nm | 73 nm | 56 nm | 63 nm | 170 nm | — | — |
| No. 3 | 85 nm | 85 nm | 85 nm | 51 nm | 64 nm | 170 nm | — | — |
| Average | 63 nm | 63 nm | 74 nm | 55 nm | 61 nm | 170 nm | 212 nm | — |

For Examples 1-5, the average repetition or periodicity of the shish-kebab formations and/or crystalline structures and/or morphologies was from 1 nm to 150 nm, preferably from 10 nm to 120 nm, and even more preferably from 20 nm to 100 nm. That type of structure was not observed for the separators of Comparative Examples 1-3.

Additional properties and features of the separators of Examples 1-2 and 4-5 are shown below in Table 17 (whereas Table 3 above includes properties of the separator of Example 3).

TABLE 17

| Product | | | | | |
|---|---|---|---|---|---|
| Properties | Unit | Example 1 | Example 2 | Example 4 | Example 5 |
| Profile | | Ribbed PE, | Ribbed PE, | Ribbed PE, | Ribbed PE, |
| | | greater | greater | fewer than | fewer than |
| | | than 12 | than 12 | 12 major | 12 major |
| | | major ribs, | major ribs, | ribs | ribs |
| | | lower rib | lower rib | | |
| | | height | height | | |
| Back web | μm | 250 | 200 | 250 | 250 |
| thickness | | | | | |
| Final | % | 17.1 | 14.3 | 17.0 | 11.3 |
| oil content | | | | | |
| Porosity | % | 62.5 | 65.8 | 58.7 | 65.2 |
| Electrical | mΩ · cm² | 53 | 38 | 52 | 45 |
| Resistance | | | | | |
| 20 minute | mΩ · cm² | 57 | 36 | — | — |
| soak ER | | | | | |
| Puncture | N | 13.6 | 12.7 | 11.6 | 12.0 |
| Resistance | | | | | |
| Wettability | seconds | 25 | 8 | 6 | 6 |
| Elongation - CMD | % | 587 | 470 | 713 | 616 |
| Acid | % | −1.4 | −1.5 | −0.1 | −0.4 |
| Shrinkage | | | | | |

### Solid State NMR Examples

For two separator samples, the ratio (Si—OH)/Si of silanol groups (Si—OH) to elemental silicon (Si) was measured using the ²⁹Si solid-state NMR technique described in great detail above. A sample of the separator of Example 1 was prepared for this NMR testing as well as a sample of a comparative separator, Comparative Example 4, which was a commercially available polyethylene separator from Daramic, LLC, having a 250 μm backweb thickness, made with the same type of polyethylene polymer and silica as the separator described above as Comparative Example 3.

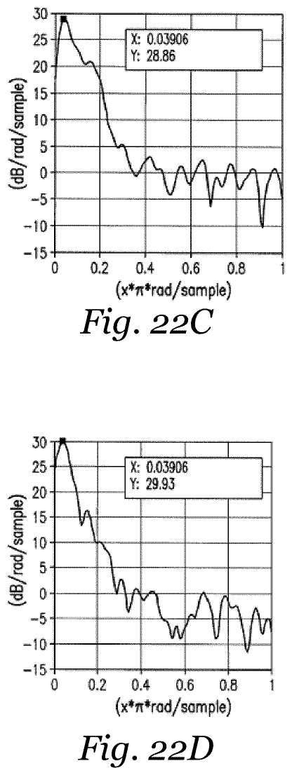

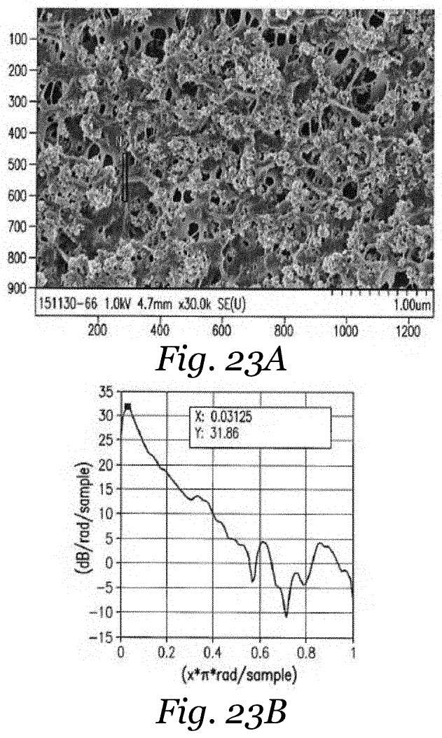

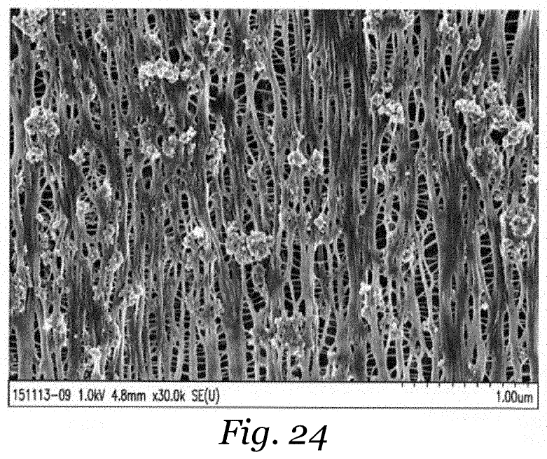

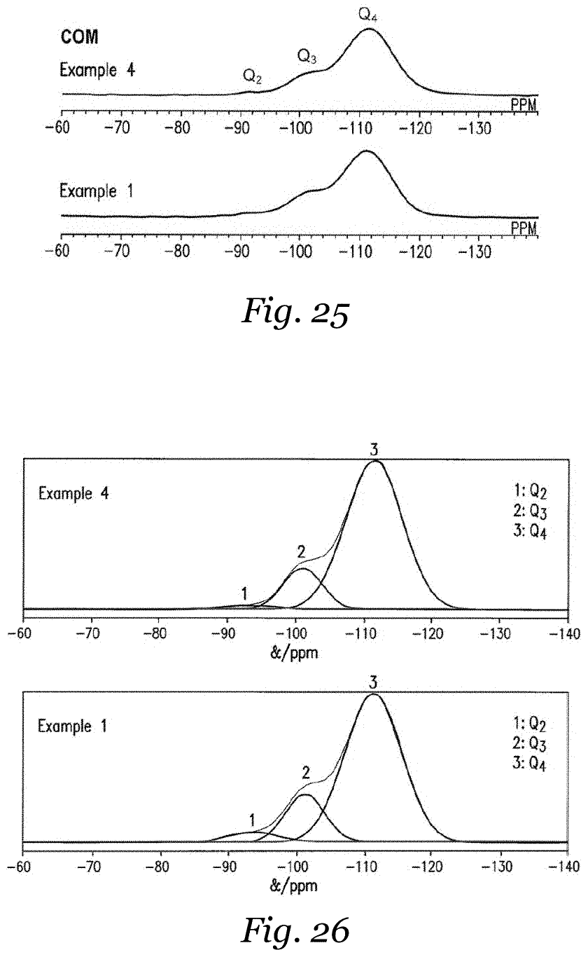

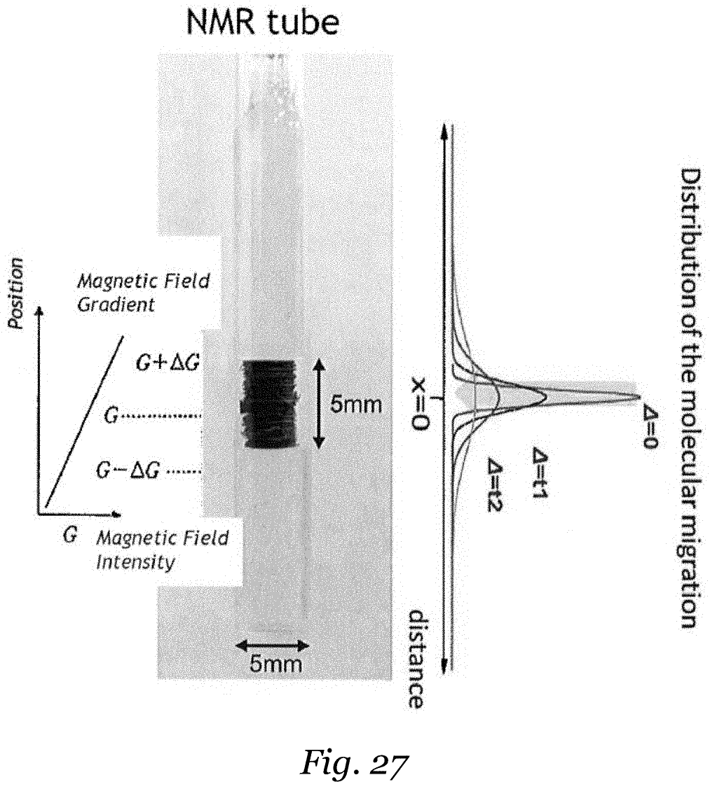

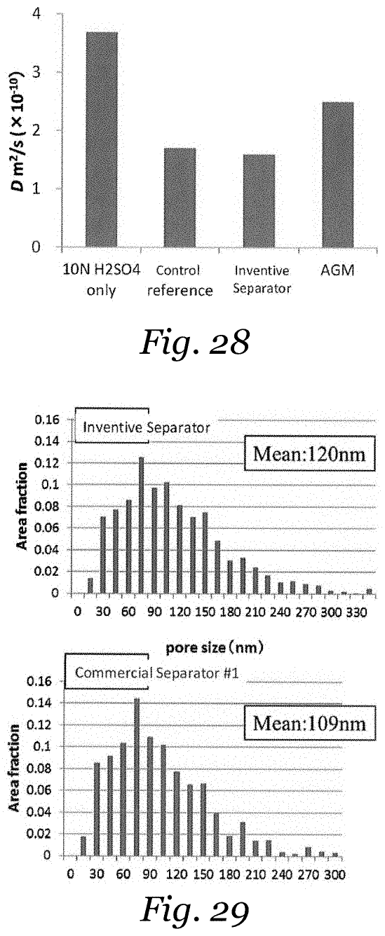

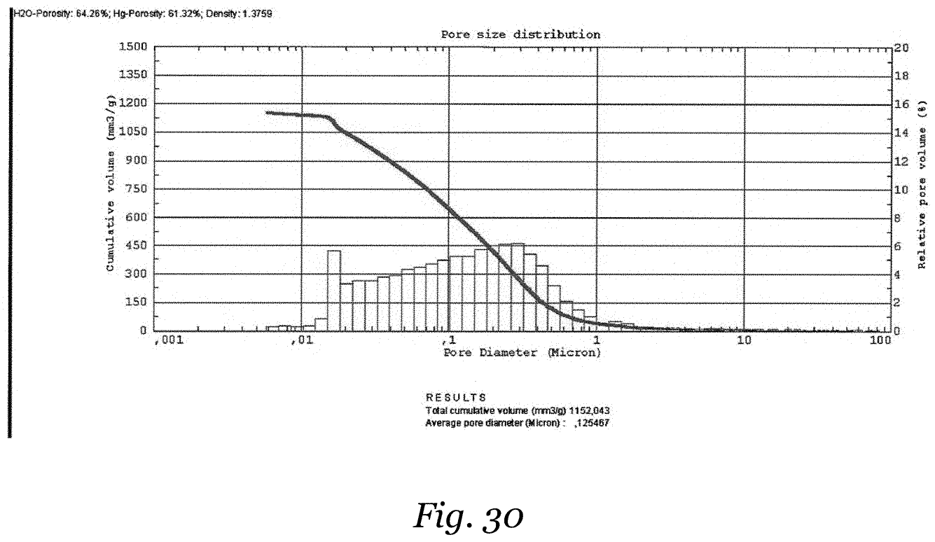

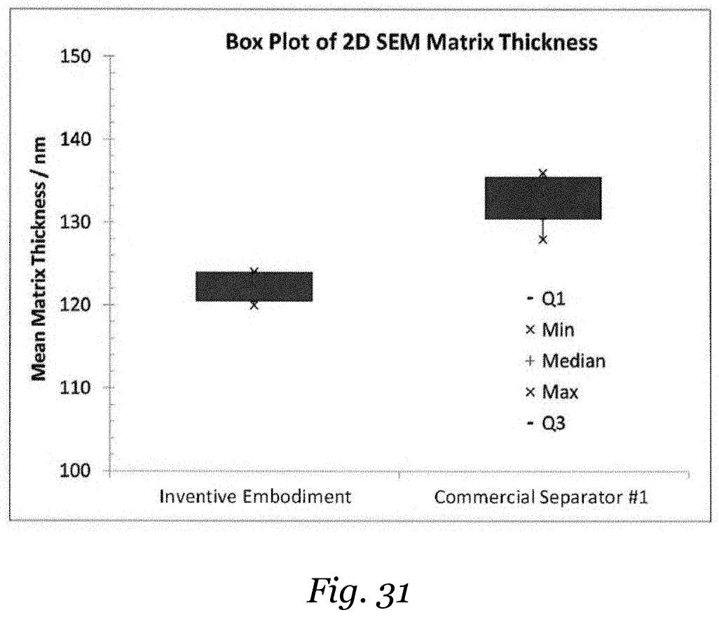

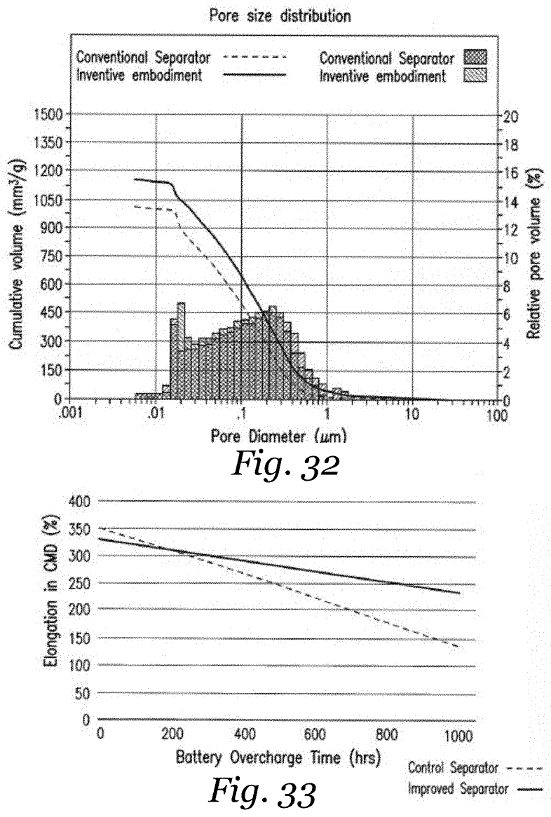

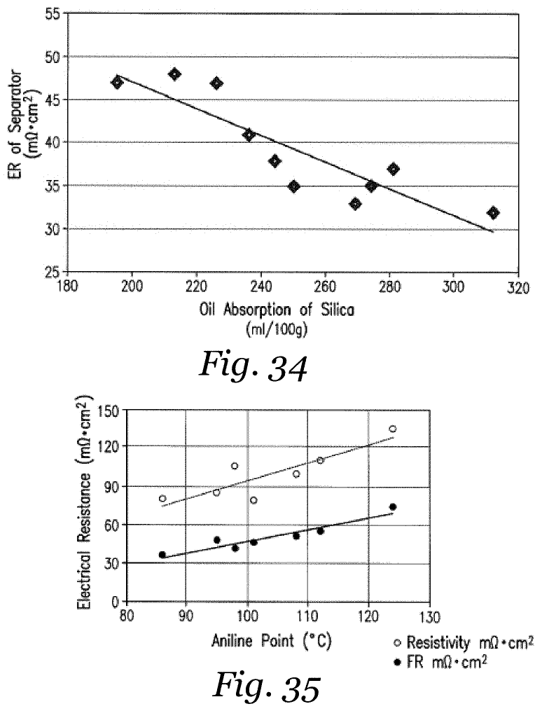

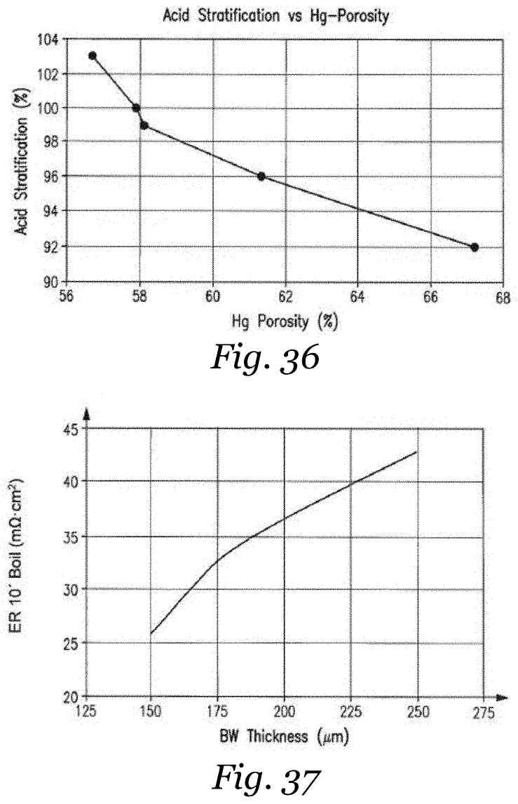

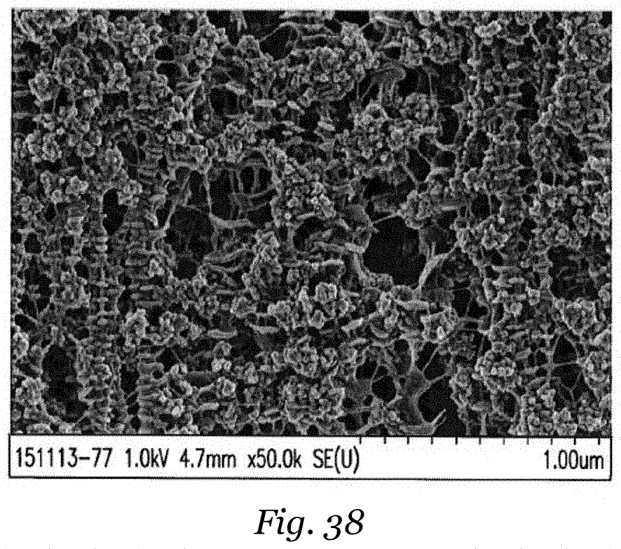

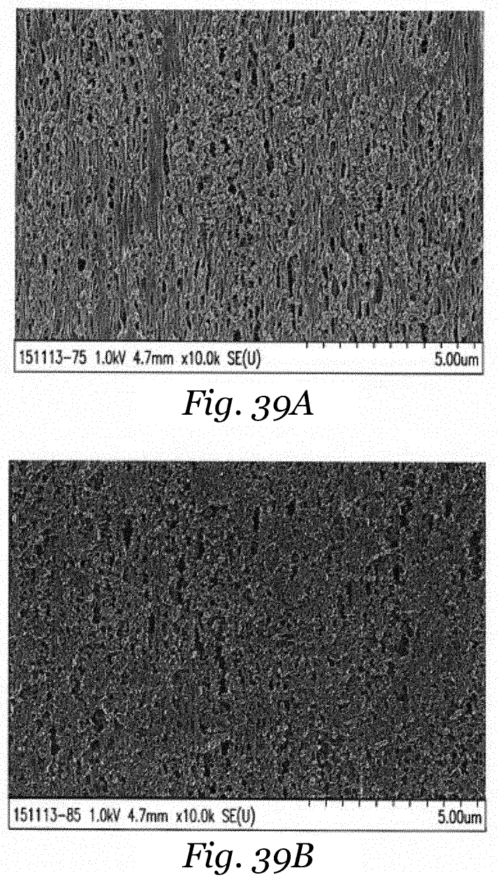

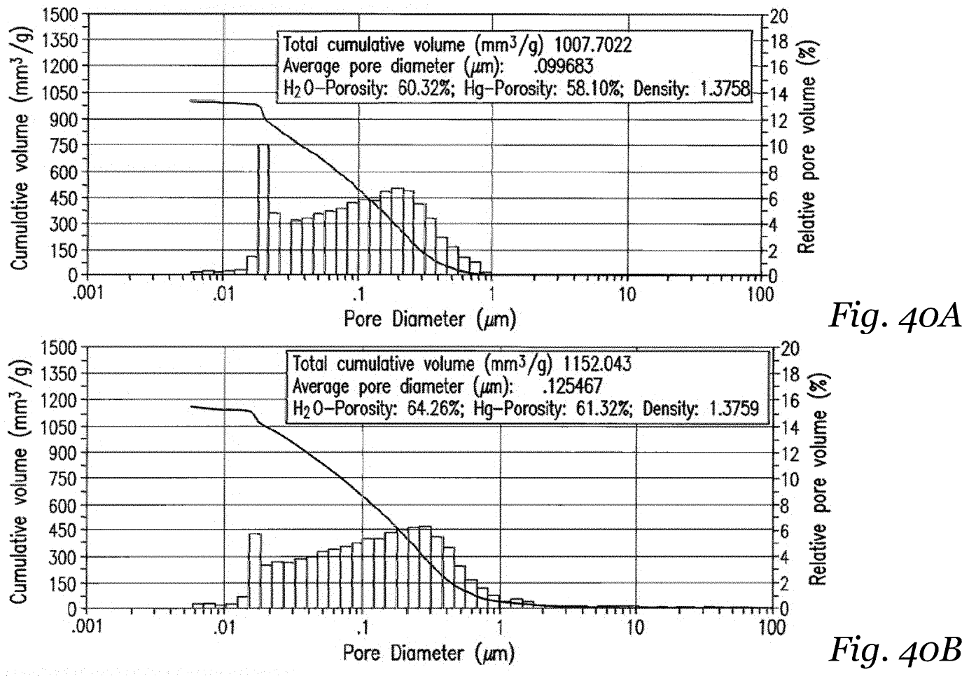

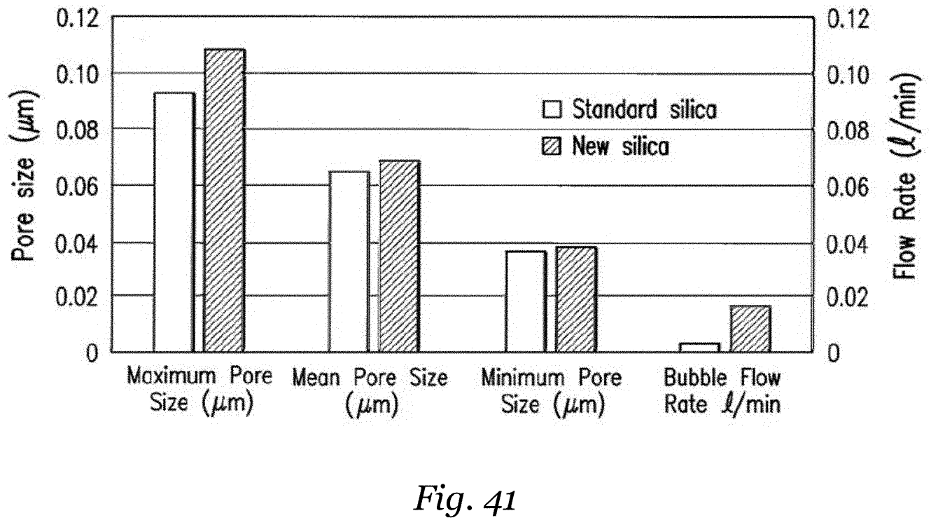

A ²⁹Si-NMR spectrum of each sample was obtained, and these spectra are included as FIG. 26. The Q₂ signal was observed at ca. −93 ppm, while the Q₃ signal was observed at ca. −103 ppm, and the Q₄ signal was observed at ca. −111 ppm. Each component peak was deconvoluted as shown in FIG. 24, and the Q₂:Q₃:Q₄ molecular ratios were calculated using that information from FIG. 24, with results shown below in Table 18:

TABLE 18

| | Observed ²⁹Si-NMR | | | | | | |
|---|---|---|---|---|---|---|---|
| | Signal Area Ratio | | | | Molecular Ratio | | |
| | Q₁ | Q₂ | Q₃ | Q₄ | OH | Si | OH/Si |
| CE4 | 0 | 2 | 16 | 82 | 20 | 100 | 0.20 |
| Example 1 | 0 | 5 | 17 | 78 | 27 | 100 | 0.27 |
| Number of OH | 3 | 2 | 1 | 0 | | | |
| Bonding | | | | | | | |

In the results shown above, the OH/Si ratio of the separator of Example 1 is 35% higher than the OH/Si ratio for the separator of Comparative Example 4, meaning that the additional hydroxyl and/or silanol groups present for the silica for the inventive separator may contribute to the improved features of the inventive separator such as its desirable pore structure and/or morphology and its low ER.

### CONCLUSION

In accordance with at least selected embodiments, the present disclosure or invention is directed to separators, particularly separators for flooded lead acid batteries capable of reducing or mitigating acid starvation; reducing or mitigating acid stratification; reducing or mitigating dendrite growth; and having reduced electrical resistance and/or capable of increasing cold cranking amps. In addition, disclosed herein are methods, systems, and battery separators for enhancing battery life; reducing or mitigating acid starvation; reducing or mitigating acid stratification; reducing to mitigating dendrite growth; reducing the effects of oxidation; reducing water loss; reducing internal resistance; increasing wettability; improving acid diffusion; improving cold cranking amps, improving uniformity, and any combination thereof in at least enhanced flooded lead acid batteries. In accordance with at least particular embodiments, the present disclosure or invention is directed to an improved separator for enhanced flooded lead acid batteries wherein the separator includes an improved and novel rib design, and improved separator resiliency. In accordance with at least particular embodiments, the present disclosure or invention is directed to an improved separator for enhanced flooded lead acid batteries wherein the separator includes performance enhancing additives or coatings, increased oxidation resistance, increased porosity, increased void volume, amorphous silica, higher oil absorption silica, higher silanol group silica, silica with an OH to Si ratio of 21:100 to 35:100, a shish-kebab structure or morphology, a polyolefin microporous membrane containing particle-like filler in an amount of 40% or more by weight of the membrane and polymer, such as ultrahigh molecular weight polyethylene (“UHMWPE”), having shish-kebab formations with extended chain crystal (shish formation) and folded chain crystal (kebab formation) and the average repetition periodicity of the kebab formation from 1 nm to 150 nm, decreased sheet thickness, decreased tortuosity, reduced thickness, reduced oil content, increased wettability, increased acid diffusion, and/or the like, and any combination thereof.

In accordance with at least a first aspect of certain selected embodiments, a lead acid battery separator is provided with a porous membrane having a polymer and a filler. The porous membrane is provided with at least a first surface with at least a first plurality of ribs extending from the first surface. The first plurality of ribs are provided with a first plurality of teeth or discontinuous peaks or protrusions, where each of the first plurality of teeth or discontinuous peaks or protrusions are in such proximity to one another so as to provide resiliency to the separator. Such resiliency may refer to the separators ability to resist deflecting while under pressure resulting from NAM swelling. Such proximity may be at least approximately 1.5 mm from one tooth, peak, or protrusion to another. The separator may be further provided with a continuous base portion with the first plurality of teeth or discontinuous peaks or protrusions extending from the base portion.

In certain embodiments, the separator may be provided with a continuous base portion with the first plurality of teeth or discontinuous peaks or protrusions extending from the base portion. The base portion may be wider than the width of the teeth or discontinuous peaks or protrusions. In addition, the base portion may extend continuously between each of the teeth or discontinuous peaks or protrusions.

In accordance with at least certain select embodiments, the separator may be provided with ribs that are one or more of the following: solid ribs, discrete broken ribs, continuous ribs, discontinuous ribs, discontinuous peaks, discontinuous protrusions, angled ribs, linear ribs, longitudinal ribs extending substantially in a machine direction of the porous membrane, lateral ribs extending substantially in a cross-machine direction of the porous membrane, transverse ribs extending substantially in the cross-machine direction of the separator, teeth, toothed ribs, serrations, serrated ribs, battlements, battlemented ribs, curved ribs, sinusoidal ribs, disposed in a continuous zig-zag-sawtooth-like fashion, disposed in a broken discontinuous zig-zag-sawtooth-like fashion, grooves, channels, textured areas, embossments, dimples, columns, mini columns, porous, non-porous, mini ribs, cross-mini ribs, and combinations thereof.

At least a portion of the first plurality of ribs may be defined by an angle that may be neither parallel nor orthogonal relative to an edge of the separator. Furthermore, the angle may be defined as an angle relative to a machine direction of the porous membrane and the angle may be one of the following: between greater than zero degrees (0°) and less than 180 degrees (180°), and greater than 180 degrees (180°) and less than 360 degrees (360°). In certain aspects of disclosed embodiments, the angle may vary throughout the plurality of ribs.

In certain select aspects of the present invention, the first plurality of ribs may have a cross-machine direction spacing pitch of approximately 1.5 mm to approximately 10 mm, and the plurality of teeth or discontinuous peaks or protrusions may have a machine direction spacing pitch of approximately 1.5 mm to approximately 10 mm.

In certain select embodiments, the separator may be provided with a second plurality of ribs extending from a second surface of the porous membrane. The second plurality of ribs may be one or more of the following: solid ribs, discrete broken ribs, continuous ribs, discontinuous ribs, discontinuous peaks, discontinuous protrusions, angled ribs, linear ribs, longitudinal ribs extending substantially in a machine direction of the porous membrane, lateral ribs extending substantially in a cross-machine direction of the porous membrane, transverse ribs extending substantially in the cross-machine direction of the separator, teeth, toothed ribs, battlements, battlemented ribs, curved ribs, sinusoidal ribs, disposed in a continuous zig-zag-sawtooth-like fashion, disposed in a broken discontinuous zig-zag-sawtooth-like fashion, grooves, channels, textured areas, embossments, dimples, columns, mini columns, porous, non-porous, mini ribs, cross-mini ribs, and combinations thereof.

At least a portion of the second plurality of ribs may be defined by an angle that may be neither parallel nor orthogonal relative to an edge of the separator. Furthermore, the angle may be defined as an angle relative to a machine direction of the porous membrane and the angle may be one of the following: between greater than zero degrees (0°) and less than 180 degrees (180°), and greater than 180 degrees (180°) and less than 360 degrees (360°). In certain aspects of disclosed embodiments, the angle may vary throughout the plurality of ribs.

The second plurality of ribs have a cross-machine or machine direction spacing pitch of approximately 1.5 mm to approximately 10 mm.

The first surface may be provided with one or more ribs that are of a different height than the first plurality of ribs disposed adjacent to an edge of the lead acid battery separator. Likewise, the second surface may be provided with one or more ribs that are of a different height than the second plurality of ribs disposed adjacent to an edge of the lead acid battery separator.

In select embodiments, the polymer may be one of the following: a polymer, polyolefin, polyethylene, polypropylene, ultra-high molecular weight polyethylene (“UHMWPE”), phenolic resin, polyvinyl chloride (“PVC”), rubber, synthetic wood pulp (“SWP”), lignins, glass fibers, synthetic fibers, cellulosic fibers, and combinations thereof.

A fibrous mat may be provided. The mat may be one of the following: glass fibers, synthetic fibers, silica, at least one performance enhancing additive, latex, natural rubber, synthetic rubber, and combinations thereof, and may be nonwoven, woven, mesh, fleece, net, and combinations thereof.

In addition, the separator may be a cut-piece, a leaf, a pocket, a sleeve, a wrap, an envelope, and a hybrid envelope.

According to at least certain select exemplary embodiments, a separator may be provided with resilient means for mitigating separator deflection.

In accordance with at least certain select embodiments, a lead acid battery is provided with a positive electrode, and a negative electrode provided with swollen negative active material. A separator is provided with at least a portion of the separator being disposed between the positive electrode and the negative electrode. An electrolyte is provided that substantially submerges at least a portion of the positive electrode, at least a portion of the negative electrode, and at least a portion of the separator. In at least certain select embodiments, the separator may have a porous membrane made of at least a polymer and a filler. A first plurality of ribs may extend from a surface of the porous membrane. The ribs may be arranged such as to prevent acid starvation in the presence of NAM swelling. The lead acid battery may operate in any one or more of the following conditions: in motion, stationary, in a backup power application, in a cycling applications, in a partial state of charge, and any combination thereof.

The ribs may be provided with a plurality of teeth, or discontinuous peaks or protrusions. Each tooth, or discontinuous peak or protrusion may be at least approximately 1.5 mm from another of the plurality of discontinuous peaks. A continuous base portion may be provided, with the plurality of teeth, or discontinuous peaks or protrusions extending therefrom.

The first plurality of ribs may further be provided so as to enhance acid mixing in a battery, particularly during movement of the battery. The separator may be disposed parallel to a start and stop motion of the battery. The separator may be provided with a mat adjacent to the positive electrode, the negative electrode, or the separator. The mat may be at least partially made of glass fibers, synthetic fibers, silica, at least one performance enhancing additive, latex, natural rubber, synthetic rubber, and any combination thereof. The mat may be nonwoven, woven, mesh, fleece, net, and combinations thereof.

In at least certain select embodiments of the present invention, the lead acid battery may be a flat-plate battery, a flooded lead acid battery, an enhanced flooded lead acid battery (“EFB”), a valve regulated lead acid (“VRLA”) battery, a deep-cycle battery, a gel battery, an absorptive glass mat (“AGM”) battery, a tubular battery, an inverter battery, a vehicle battery, a starting-lighting-ignition (“SLI”) vehicle battery, an idling-start-stop (“ISS”) vehicle battery, an automobile battery, a truck battery, a motorcycle battery, an all-terrain vehicle battery, a forklift battery, a golf cart battery, a hybrid-electric vehicle battery, an electric vehicle battery, an e-rickshaw battery, or an e-bike battery, or any combination thereof.

In certain embodiments, the battery may operate at a depth of discharge of between approximately 1% and approximately 99%.

In accordance with at least one embodiment, a microporous separator with decreased tortuosity is provided. Tortuosity refers to the degree of curvature/turns that a pore takes over its length. Thus, a microporous separator with decreased tortuosity will present a shorter path for ions to travel through the separator, thereby decreasing electrical resistance. Microporous separators in accordance with such embodiments can have decreased thickness, increased pore size, more interconnected pores, and/or more open pores.

In accordance with at least certain selected embodiments, a microporous separator with increased porosity, or a separator with a different pore structure whose porosity is not significantly different from a known separator, and/or decreased thickness is provided. An ion will travel more rapidly though a microporous separator with increased porosity, increased void volume, reduced tortuosity, and/or decreased thickness, thereby decreasing electrical resistance. Such decreased thickness may result in decreased overall weight of the battery separator, which in turn decreases the weight of the enhanced flooded battery in which the separator is used, which in turn decreases the weight of the overall vehicle in which the enhanced flooded battery is used. Such decreased thickness may alternatively result in increased space for the positive active material (“PAM”) or the negative active material (“NAM”) in the enhanced flooded battery in which the separator is used.

In accordance with at least certain selected embodiments, a microporous separator with increased wettability (in water or acid) is provided. The separator with increased wettability will be more accessible to the electrolyte ionic species, thus facilitating their transit across the separator and decreasing electrical resistance.

In accordance with at least one embodiment, a microporous separator with decreased final oil content is provided. Such a microporous separator will also facilitate lowered ER (electrical resistance) in an enhanced flooded battery or system.

The separator may contain improved fillers that have increased friability, and that may increase the porosity, pore size, internal pore surface area, wettability, and/or the surface area of the separator. In some embodiments, the improved fillers have high structural morphology and/or reduced particle size and/or a different amount of silanol groups than previously known fillers and/or are more hydroxylated than previously known fillers. The improved fillers may absorb more oil and/or may permit incorporation of a greater amount of processing oil during separator formation, without concurrent shrinkage or compression when the oil is removed after extrusion. The fillers may further reduce what is called the hydration sphere of the electrolyte ions, enhancing their transport across the membrane, thereby once again lowering the overall electrical resistance or ER of the battery, such as an enhanced flooded battery or system.

The filler or fillers may contain various species (such as polar species, such as metals) that increase the ionic diffusion, and facilitate the flow of electrolyte and ions across the separator. Such also leads to decreased overall electrical resistance as such a separator is used in a flooded battery, such as an enhanced flooded battery.

The microporous separator further comprises a novel and improved pore morphology and/or novel and improved fibril morphology such that the separator contributes to significantly decreasing the electrical resistance in a flooded lead acid battery when such a separator is used in such a flooded lead acid battery. Such improved pore morphology and/or fibril morphology may result in a separator whose pores and/or fibrils approximate a shish-kebab (or shish kabob) type morphology. Another way to describe the novel and improved pore shape and structure is a textured fibril morphology in which silica nodes or nodes of silica are present at the kebab-type formations on the polymer fibrils (the fibrils sometimes called shishes) within the battery separator. Additionally, in certain embodiments, the silica structure and pore structure of a separator according to the present invention may be described as a skeletal structure or a vertebral structure or spinal structure, where silica nodes on the kebabs of polymer, along the fibrils of polymer, appear like vertebrae or disks (the “kebabs”), and sometimes are oriented substantially perpendicularly to, an elongate central spine or fibril (extended chain polymer crystal) that approximates a spinal column-like shape (the “shish”).

In some instances, the improved battery comprising the improved separator with the improved pore morphology and/or fibril morphology may exhibit 20% lower, in some instances, 25% lower, in some instances, 30% lower electrical resistance, and in some instances, even more than a 30% drop in electrical resistance (“ER”) (which may reduce battery internal resistance) while such a separator retains and maintains a balance of other key, desirable mechanical properties of lead acid battery separators. Further, in certain embodiments, the separators described herein have a novel and/or improved pore shape such that more electrolyte flows through or fills the pores and/or voids as compared to known separators.

In addition, the present disclosure provides improved enhanced flooded lead acid batteries comprising one or more improved battery separators for an enhanced flooded battery, which separator combines for the battery the desirable features of decreased acid stratification, lowered voltage drop (or an increase in voltage drop durability), and increased CCA, in some instances, more than 8%, or more than 9%, or in some embodiments, more than 10%, or more than 15%, increased CCA. Such an improved separator may result in an enhanced flooded battery whose performance matches or even exceeds the performance of an AGM battery. Such low electrical resistance separator may also be treated so as to result in an enhanced flooded lead acid battery having reduced water loss.

The separator may contain one or more performance enhancing additives, such as a surfactant, along with other additives or agents, residual oil, and fillers.

Such performance enhancing additives can reduce separator oxidation and/or even further facilitate the transport of ions across the membrane contributing to the overall lowered electrical resistance for the enhanced flooded battery described herein.

The separator for a lead acid battery described herein may comprise a polyolefin microporous membrane, wherein the polyolefin microporous membrane comprises: polymer, such as polyethylene, such as ultrahigh molecular weight polyethylene, particle-like filler, and processing plasticizer (optionally with one or more additional additives or agents). The polyolefin microporous membrane may comprise the particle-like filler in an amount of 40% or more by weight of the membrane. And the ultrahigh molecular weight polyethylene may comprise polymer in a shish-kebab formation comprising a plurality of extended chain crystals (the shish formations) and a plurality of folded chain crystals (the kebab formations), wherein the average repetition or periodicity of the kebab formations is from 1 nm to 150 nm, preferably, from 10 nm to 120 nm, and more preferably, from 20 nm to 100 nm (at least on portions of the rib side of the separator).

The average repetition or periodicity of the kebab formations is calculated in accordance with the following definition:
The surface of the polyolefin microporous membrane is observed using a scanning electron microscope (“SEM”) after being subjected to metal vapor deposition, and then the image of the surface is taken at, for example 30,000 or 50,000-fold magnification at 1.0 kV accelerating voltage.
In the same visual area of the SEM image, at least three regions where shish-kebab formations are continuously extended in the length of at least 0.5 μm or longer are indicated. Then, the kebab periodicity of each indicated region is calculated.
The kebab periodicity is specified by Fourier transform of concentration profile (contrast profile) obtained by projecting in the vertical direction to the shish formation of the shish-kebab formation in each indicated region to calculate the average of the repetition periods.
The images are analyzed using general analysis tools, for example, MATLAB (R2013a).
Among the spectrum profiles obtained after the Fourier transform, spectrum detected in the short wavelength region are considered as noise. Such noise is mainly caused by deformation of contrast profile. The contrast profiles obtained for separators in accordance with the present invention appear to generate square-like waves (rather than sinusoidal waves). Further, when the contrast profile is a square-like wave, the profile after the Fourier transform becomes a Sine function and therefore generates plural peaks in the short wavelength region besides the main peak indicating the true kebab periodicity. Such peaks in the short wavelength region can be detected as noise.

In some embodiments, the separator for a lead acid battery described herein comprises a filler selected from the group consisting of silica, precipitated silica, fumed silica, and precipitated amorphous silica; wherein the molecular ratio of OH to Si groups within said filler, measured by ²⁹Si-NMR, is within a range of from 21:100 to 35:100, in some embodiments, 23:100 to 31:100, in some embodiments, 25:100 to 29:100, and in certain preferred embodiments, 27:100 or higher.

Silanol groups change a silica structure from a crystalline structure to an amorphous structure, since the relatively stiff covalent bond network of Si—O has partially disappeared. The amorphous-like silicas such as Si(—O—Si)₂(—OH)₂ and Si(—O—Si)₃(—OH) have plenty of distortions, which may function as various oil absorption points. Therefore oil absorbability becomes high when the amount of silanol groups (Si—OH) is increased for the silica. Additionally, the separator described herein may exhibit increased hydrophilicity and/or may have higher void volume and/or may have certain aggregates surrounded by large voids when it comprises a silica comprising a higher amount of silanol groups and/or hydroxyl groups than a silica used with a known lead acid battery separator.

The microporous separator further comprises a novel and improved pore morphology and/or novel and improved fibril morphology such that the separator contributes to significantly decreasing the electrical resistance in a flooded lead acid battery when such a separator is used in such a flooded lead acid battery. Such improved pore morphology and/or fibril morphology may result in a separator whose pores and/or fibrils approximate a shish-kebab (or shish kabob) type morphology. Another way to describe the novel and improved pore shape and structure is a textured fibril morphology in which silica nodes or nodes of silica are present at the kebab-type formations on the polymer fibrils (the fibrils sometimes called shishes) within the battery separator. Additionally, in certain embodiments, the silica structure and pore structure of a separator according to the present invention may be described as a skeletal structure or a vertebral structure or spinal structure, where silica nodes on the kebabs of polymer, along the fibrils of polymer, appear like vertebrae or disks (the “kebabs”), and sometimes are oriented substantially perpendicularly to, an elongate central spine or fibril (extended chain polymer crystal) that approximates a spinal column-like shape (the “shish”).

In certain selected embodiments, a vehicle may be provided with a lead acid battery as generally described herein. The battery may further be provided with a separator as described herein. The vehicle may be an automobile, a truck, a motorcycle, an all-terrain vehicle, a forklift, a golf cart, a hybrid vehicle, a hybrid-electric vehicle battery, an electric vehicle, an idling-start-stop (“ISS”) vehicle, an e-rickshaw, an e-bike, an e-bike battery, and combinations thereof.

In certain preferred embodiments, the present disclosure or invention provides a flexible battery separator whose components and physical attributes and features synergistically combine to address, in unexpected ways, previously unmet needs in the deep cycle battery industry, with an improved battery separator (a separator having a porous membrane of polymer, such as polyethylene, plus a certain amount of a performance enhancing additive and ribs) that meets or, in certain embodiments, exceeds the performance of the previously known flexible, which are currently used in many deep cycle battery applications. In particular, the inventive separators described herein are more robust, less fragile, less brittle, more stable over time (less susceptible to degradation) than separators traditionally used with deep cycle batteries. The flexible, performance enhancing additive-containing and rib possessing separators of the present invention combine the desired robust physical and mechanical properties of a polyethylene-based separator with the capabilities of a conventional separator, while also enhancing the performance of the battery system employing the same.

In accordance with at least select embodiments, aspects or objects, disclosed herein or provided are novel or improved separators, battery separators, enhanced flooded battery separators, batteries, cells, and/or methods of manufacture and/or use of such separators, battery separators, enhanced flooded battery separators, cells, and/or batteries. In accordance with at least certain embodiments, the present disclosure or invention is directed to novel or improved battery separators for enhanced flooded batteries. In addition, there is disclosed herein methods, systems, and battery separators having a reduced ER, improved puncture strength, improved separator CMD stiffness, improved oxidation resistance, reduced separator thickness, reduced basis weight, and any combination thereof. In accordance with at least particular embodiments, the present disclosure or invention is directed to an improved separator for enhanced flooded batteries wherein the separator has a reduced ER, improved puncture strength, improved separator CMD stiffness, improved oxidation resistance, reduced separator thickness, reduced basis weight, or any combination thereof. In accordance with at least certain embodiments, separators are provided that include or exhibit a reduced ER, improved puncture strength, improved separator CMD stiffness, improved oxidation resistance, reduced separator thickness, reduced basis weight, and any combination thereof. In accordance with at least certain embodiments, separators are provided in battery applications for flat-plate batteries, tubular batteries, vehicle SLI, and HEV ISS applications, deep cycle applications, golf car or golf cart and e-rickshaw batteries, batteries operating in a partial state of charge (“PSOC”), inverter batteries; and storage batteries for renewable energy sources, and any combination thereof.

In accordance with at least select embodiments, the present disclosure or invention is directed to novel or improved separators for lead acid batteries, such as flooded lead acid batteries, and in particular enhanced flooded lead acid batteries (“EFBs”), and various other lead acid batteries, such as gel and absorptive glass mat (“AGM”) batteries. In accordance with at least select embodiments, the present disclosure or invention is directed to novel or improved separators, battery separators, resilient separators, balanced separators, EFB separators, batteries, cells, systems, methods involving the same, vehicles using the same, methods of manufacturing the same, the use of the same, and combinations thereof. In addition, disclosed herein are methods, systems, and battery separators for enhancing battery life and reducing battery failure by reducing battery electrode acid starvation. In accordance with at least selected embodiments, the present disclosure or invention is directed to novel or improved separators, battery separators, enhanced flooded battery separators, batteries, cells, and/or methods of manufacture and/or use of such separators, battery separators, enhanced flooded battery separators, cells, batteries, systems, methods, and/or vehicles using the same. In accordance with at least certain embodiments, the present disclosure or invention is directed to novel or improved battery separators, resilient separators, balanced separators, flooded lead acid battery separators, or enhanced flooded lead acid battery separators such as those useful for deep-cycling and/or partial state of charge (“PSoC”) applications. Such applications may include such non-limiting examples as: electric motive machine applications, such as fork lifts and golf carts (sometimes referred to as golf cars), e-rickshaws, e-bikes, e-trikes, and/or the like; automobile or truck (or HD truck) applications such as starting lighting ignition (“SLI”) batteries, such as those used for internal combustion engine vehicles; idle-start-stop (“ISS”) vehicle batteries; hybrid vehicle applications, hybrid-electric vehicle applications; batteries with high power requirements, such as uninterrupted power supply (“UPS”) or valve regulated lead acid (“VRLA”), and/or for batteries with high CCA requirements; inverters; and energy storage systems, such as those found in renewable and/or alternative energy systems, such as solar and wind power collection systems.

In accordance with at least selected embodiments, the present disclosure or invention is directed to separators, particularly separators for flooded lead acid batteries capable of reducing or mitigating acid starvation; reducing or mitigating acid stratification; reducing or mitigating dendrite growth; and having reduced electrical resistance and/or capable of increasing cold cranking amps. In addition, disclosed herein are methods, systems, and battery separators for enhancing battery life; reducing or mitigating acid starvation; reducing or mitigating acid stratification; reducing to mitigating dendrite growth; reducing the effects of oxidation; reducing water loss; reducing internal resistance; increasing wettability; improving acid diffusion; improving cold cranking amps, improving uniformity, and any combination thereof in at least enhanced flooded lead acid batteries. In accordance with at least particular embodiments, the present disclosure or invention is directed to an improved separator for enhanced flooded lead acid batteries wherein the separator includes an improved and novel rib design, and improved separator resiliency. In accordance with at least particular embodiments, the present disclosure or invention is directed to an improved separator for enhanced flooded lead acid batteries wherein the separator includes performance enhancing additives or coatings, increased oxidation resistance, increased porosity, increased void volume, amorphous silica, higher oil absorption silica, higher silanol group silica, silica with an OH to Si ratio of 21:100 to 35:100, a shish-kebab structure or morphology, a polyolefin microporous membrane containing particle-like filler in an amount of 40% or more by weight of the membrane and polymer, such as ultrahigh molecular weight polyethylene (“UHMWPE”), having shish-kebab formations with extended chain crystal (shish formation) and folded chain crystal (kebab formation) and the average repetition periodicity of the kebab formation from 1 nm to 150 nm, decreased sheet thickness, decreased tortuosity, reduced thickness, reduced oil content, increased wettability, increased acid diffusion, and/or the like, and any combination thereof.

In accordance with at least selected embodiments, the present disclosure or invention is directed to separators, resilient separators, balanced separators, particularly separators for flooded lead acid batteries capable of reducing or mitigating acid starvation; reducing or mitigating acid stratification; reducing or mitigating dendrite growth; having reduced electrical resistance and/or capable of increasing cold cranking amps; having reduced electrical resistance and negative cross ribs; having low water loss, reduced electrical resistance and/or negative cross ribs; having dendrite blocking or prevention performance, characteristics and/or structures; having acid mixing prevention performance, characteristics and/or structures; having enhanced negative cross ribs; having glass mat on the positive and/or negative side of a PE membrane, piece, sleeve, fold, wrap, Z wrap, S wrap, pocket, envelope, and/or the like; having the glass mat laminated to the PE membrane; and/or combinations or sub-combinations thereof.

The compositions and methods of the appended claims are not limited in scope by the specific compositions and methods described herein, which are intended as illustrations of a few aspects of the claims and any compositions and methods that are functionally equivalent are intended to fall within the scope of the claims. Various modifications of the compositions and methods in addition to those shown and described herein are intended to fall within the scope of the appended claims. Further, while only certain representative compositions and method steps disclosed herein are specifically described, other combinations of the compositions and method steps also are intended to fall within the scope of the appended claims, even if not specifically recited. Thus, a combination of steps, elements, components, or constituents may be explicitly mentioned herein or less, however, other combinations of steps, elements, components, and constituents are included, even though not explicitly stated. The term “comprising” and variations thereof as used herein is used synonymously with the term “including” and variations thereof and are open, non-limiting terms. Although the terms “comprising” and “including” have been used herein to describe various embodiments, the terms “consisting essentially of” and “consisting of” may be used in place of “comprising” and “including” to provide for more specific embodiments of the invention and are also disclosed. Other than in the examples, or where otherwise noted, all numbers expressing quantities of ingredients, reaction conditions, and so forth used in the specification and claims are to be understood at the very least, and not as an attempt to limit the application of the doctrine of equivalents to the scope of the claims, to be construed in light of the number of significant digits and ordinary rounding approaches.

The present invention may be embodied in other forms without departing from the spirit and the essential attributes thereof, and, accordingly, reference should be made to the appended claims, rather than to the foregoing specification, as indicating the scope of the invention. Disclosed are components that may be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all aspects of this application including, but not limited to, steps in disclosed methods. Thus, if there are a variety of additional steps that may be performed it is understood that each of these additional steps may be performed with any specific embodiment or combination of embodiments of the disclosed methods.

The foregoing written description of structures and methods has been presented for purposes of illustration only. Examples are used to disclose exemplary embodiments, including the best mode, and also to enable any person skilled in the art to practice the invention, including making and using any devices or systems and performing any incorporated methods. These examples are not intended to be exhaustive or to limit the invention to the precise steps and/or forms disclosed, and many modifications and variations are possible in light of the above teaching. Features described herein may be combined in any combination. Steps of a method described herein may be performed in any sequence that is physically possible. The patentable scope of the invention is defined by the appended claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

The compositions and methods of the appended claims are not limited in scope by the specific compositions and methods described herein, which are intended as illustrations of a few aspects of the claims. Any compositions and methods that are functionally equivalent are intended to fall within the scope of the claims. Various modifications of the compositions and methods in addition to those shown and described herein are intended to fall within the scope of the appended claims. Further, while only certain representative compositions and method steps disclosed herein are specifically described, other combinations of the compositions and method steps also are intended to fall within the scope of the appended claims, even if not specifically recited. Thus, a combination of steps, elements, components, or constituents may be explicitly mentioned herein or less, however, other combinations of steps, elements, components, and constituents are included, even though not explicitly stated.

As used in the specification and the appended claims, the singular forms “a,” “an,” and “the” include plural referents unless the context clearly dictates otherwise. Ranges may be expressed herein as from “about” or “approximately” one particular value, and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint. “Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other additives, components, integers, or steps. The terms “consisting essentially of” and “consisting of” may be used in place of “comprising” and “including” to provide for more specific embodiments of the invention and are also disclosed. “Exemplary” or “for example” means “an example of” and is not intended to convey an indication of a preferred or ideal embodiment. Similarly, “such as” is not used in a restrictive sense, but for explanatory or exemplary purposes.

Other than where noted, all numbers expressing geometries, dimensions, and so forth used in the specification and claims are to be understood at the very least, and not as an attempt to limit the application of the doctrine of equivalents to the scope of the claims, to be construed in light of the number of significant digits and ordinary rounding approaches.

Unless defined otherwise, all technical and scientific terms used herein have the same meanings as commonly understood by one of skill in the art to which the disclosed invention belongs. Publications cited herein and the materials for which they are cited are specifically incorporated by reference.

Additionally, the invention illustratively disclosed herein suitably may be practiced in the absence of any element which is not specifically disclosed herein.

1. A lead acid battery separator comprising:
a porous membrane comprising a polymer and a filler;
said porous membrane having at least a first surface with at least a first plurality of ribs or protrusions extending therefrom;
said first plurality of ribs or protrusions comprising a first plurality of discontinuous peaks, wherein each of said first plurality of discontinuous peaks are at least approximately 1.5 mm from another of said plurality of discontinuous peaks.

2. The lead acid battery separator of claim 1, further comprising a continuous base portion with said first plurality of discontinuous peaks extending therefrom, wherein said continuous base portion is optionally wider than a width of said discontinuous peaks or extends continuously between said discontinuous peaks.

3. (canceled)

4. (canceled)

5. The lead acid battery separator of claim 1, wherein said first plurality of ribs are one of the following group consisting of: solid ribs, discrete broken ribs, continuous ribs, discontinuous ribs, discontinuous peaks, discontinuous protrusions, angled ribs, linear ribs, longitudinal ribs extending substantially in a machine direction of said porous membrane, lateral ribs extending substantially in a cross-machine direction of said porous membrane, transverse ribs extending substantially in said cross-machine direction of the separator, discrete teeth, toothed ribs, serrations, serrated ribs, battlements, battlemented ribs, curved ribs, sinusoidal ribs, disposed in a continuous zig-zag-sawtooth-like fashion, disposed in a broken discontinuous zig-zag-sawtooth-like fashion, grooves, channels, textured areas, protrusions, embossments, dimples, nubs, columns, mini columns, porous, non-porous, mini ribs, cross-mini ribs, and combinations thereof, optionally wherein:
at least a portion of said first plurality of ribs are defined by an angle that is neither parallel nor orthogonal relative to an edge of said separator;
said angle varies among said at least a portion of said first plurality of ribs; or
at least a portion of said first plurality of ribs are defined by an angle relative to a machine direction of said porous membrane and said angle is chosen from the group consisting of:
between greater than zero degrees (0°) and less than 180 degrees (180°), and greater than 180
degrees (180°) and less than 360 degrees (360°).

6. (canceled)

7. (canceled)

8. (canceled)

9. The lead acid battery separator of claim 5, wherein at least a portion of
said first plurality of ribs are defined by an angle relative to a machine direction of said porous membrane and said angle is chosen from the group consisting of: between greater than zero degrees (0°) and less than 180 degrees (180°), and greater than 180 degrees (180°) and less than 360 degrees (360°), and said angle varies among said at least a portion of said first plurality of ribs.

10. The lead acid battery separator of claim 1, wherein at least a portion of said first plurality of ribs have a height of approximately 100 μm to approximately 1.0 mm, of approximately 400 μm to approximately 600 μm, or of approximately 600 μm to approximately 800 μm.

11. (canceled)

12. (canceled)

13. The lead acid battery separator of claim 4, wherein at least a portion of said first plurality of ribs have a cross-machine direction spacing pitch of approximately 1.5 mm to approximately 10 mm.

14. The lead acid battery separator of claim 4, wherein at least a portion of said first plurality of discontinuous teeth have a machine direction spacing pitch of approximately 1.5 mm to approximately 10 mm.

15. The lead acid battery separator of claim 1, further comprising a second plurality of ribs extending from a second surface of said porous membrane, optionally wherein:
said second plurality of ribs are one of the following group consisting of: solid ribs, discrete broken ribs, continuous ribs, discontinuous ribs, discontinuous peaks, discontinuous protrusions, angled ribs, linear ribs, longitudinal ribs extending substantially in a machine direction of said porous membrane, lateral ribs extending substantially in a cross-machine direction of said porous membrane, transverse ribs extending substantially in said cross-machine direction of the separator, discrete teeth, toothed ribs, battlements, battlemented ribs, curved ribs, sinusoidal ribs, disposed in a continuous zig-zag-sawtooth-like fashion, disposed in a broken discontinuous zig-zag-sawtooth-like fashion, grooves, channels, textured areas, protrusions, nubs, embossments, dimples, columns, mini columns, porous, non-porous, mini ribs, cross-mini ribs, and combinations thereof.

16. (canceled)

17. The lead acid battery separator of claim 15, wherein
said second plurality of ribs are one of the following group consisting of: solid ribs, discrete broken ribs, continuous ribs, discontinuous ribs, discontinuous peaks, discontinuous protrusions, angled ribs, linear ribs, longitudinal ribs extending substantially in a machine direction of said porous membrane, lateral ribs extending substantially in a cross-machine direction of said porous membrane, transverse ribs extending substantially in said cross-machine direction of the separator, discrete teeth, toothed ribs, battlements, battlemented ribs, curved ribs, sinusoidal ribs, disposed in a continuous zigzag-sawtooth-like fashion, disposed in a broken discontinuous zig-zag-sawtooth-like fashion, grooves, channels, textured areas, protrusions, nubs, embossments, dimples, columns, mini columns, porous, non-porous, mini ribs, cross-mini ribs, and combinations thereof, and
at least a portion of said second plurality of ribs are defined by an angle that is neither parallel nor orthogonal relative to an edge of said separator.

18. The lead acid battery separator of claim 17, wherein said angle varies among said at least a portion of said second plurality of ribs.

19. The lead acid battery separator of claim 15, wherein
said second plurality of ribs are one of the following group consisting of: solid ribs, discrete broken ribs, continuous ribs, discontinuous ribs, discontinuous peaks, discontinuous protrusions, angled ribs, linear ribs, longitudinal ribs extending substantially in a machine direction of said porous membrane, lateral ribs extending substantially in a cross-machine direction of said porous membrane, transverse ribs extending substantially in said cross-machine direction of the separator, discrete teeth, toothed ribs, battlements, battlemented ribs, curved ribs, sinusoidal ribs, disposed in a continuous zig-zag-sawtooth-like fashion, disposed in a broken discontinuous zig-zag-sawtooth-like fashion, grooves, channels, textured areas, protrusions, nubs, embossments, dimples, columns, mini columns, porous, non-porous, mini ribs, cross-mini ribs, and combinations thereof, and
at least a portion of said second plurality of ribs are defined by an angle relative to a machine direction of said porous membrane and said angle is chosen from the group consisting of: between greater than zero degrees (0°) and less than 180 degrees (180°), and greater than 180 degrees (180°) and less than 360 degrees (360°).

20. The lead acid battery separator of claim 19, wherein said angle varies among said at least a portion of said second plurality of ribs.

21. The lead acid battery separator of claim 15, wherein at least a portion of said second plurality of ribs have a height of approximately 100 μm to approximately 1.0 mm, of approximately 400 μm to approximately 600 μm, or of approximately 600 μm to approximately 800 μm.

22. (canceled)

23. (canceled)

24. The lead acid battery separator of claim 15, wherein
said second plurality of ribs are one of the following group consisting of: solid ribs, discrete broken ribs, continuous ribs, discontinuous ribs, discontinuous peaks, discontinuous protrusions, angled ribs, linear ribs, longitudinal ribs extending substantially in a machine direction of said porous membrane, lateral ribs extending substantially in a cross-machine direction of said porous membrane, transverse ribs extending substantially in said cross-machine direction of the separator, discrete teeth, toothed ribs, battlements, battlemented ribs, curved ribs, sinusoidal ribs, disposed in a continuous zig-zag-sawtooth-like fashion, disposed in a broken discontinuous zig-zag-sawtooth-like fashion, grooves, channels, textured areas, protrusions, nubs, embossments, dimples, columns, mini columns, porous, non-porous, mini ribs, cross-mini ribs, and combinations thereof, and
at least a portion of said second plurality of ribs have a cross machine direction spacing pitch of approximately 1.5 mm to approximately 10 mm, or at least a portion of said second plurality of ribs have a machine direction spacing pitch of approximately 1.5 mm to approximately 10 mm.

25. (canceled)

26. The lead acid battery separator of claim 1, wherein at least one of the following:
said porous membrane has a thickness of approximately 50 μm to approximately 500 μm;
said first surface comprises one or more ribs that are of a different height than said first plurality of ribs disposed adjacent to an edge of said lead acid battery separator;
said second surface comprises one or more ribs that are of a different height than said second plurality of ribs disposed adjacent to an edge of said lead acid battery separator;
said polymer comprises one of the following group consisting of a polymer, polyolefin, polyethylene, polypropylene, ultra-high molecular weight polyethylene (“UHMWPE”), phenolic resin, polyvinyl chloride (“PVC”), rubber, latex, synthetic wood pulp (“SWP”), lignins, glass fibers, synthetic fibers, cellulosic fibers, and combinations thereof;
said separator further comprises a fibrous mat; or
said separator is in a shape of one of the following group consisting of a cut-piece, a leaf, a pocket, a sleeve, a wrap, an envelope, and a hybrid envelope.

27. (canceled)

28. (canceled)

29. (canceled)

30. (canceled)

31. The lead acid battery separator of claim 26, wherein said separator further comprises a fibrous mat, and
said fibrous mat comprises one of the following group consisting of glass fibers, synthetic fibers, silica, at least one performance enhancing additive, latex, natural rubber, synthetic rubber, and combinations thereof, or said fibrous mat is one selected from a nonwoven, a woven, a mesh, a fleece, a net, or combinations thereof.

32. (canceled)

33. (canceled)

34. A lead acid battery separator comprising:
a porous membrane comprising a polymer and a filler;
at least a first plurality of ribs extending from a surface of said porous membrane;
said first plurality of ribs comprising a first plurality of discrete teeth, wherein each of said first plurality of discrete teeth are at least approximately 1.5 mm from another of said plurality of discrete teeth.

35. The lead acid battery separator of claim 33, further comprising a continuous base portion with said first plurality of discrete teeth extending therefrom, optionally wherein:
said continuous base portion is wider than a width of said discrete teeth; or
said continuous base portion extends continuously between said discrete teeth.

36. (canceled)

37. (canceled)

38. A lead acid battery separator comprising:
a porous membrane backweb; and
resilient means for mitigating backweb deflection.

39. A lead acid battery comprising:
a positive electrode, and a negative electrode comprising a swollen negative active material;
a separator, wherein at least a portion of said separator is disposed between said positive electrode and said negative electrode;
an electrolyte substantially submerging at least a portion of said positive electrode, at least a portion of said negative electrode, and at least a portion of said separator; and
said separator comprising a porous membrane made of at least a polymer and a filler;
said porous membrane having at least a first surface with at least a first plurality of ribs extending therefrom;
said plurality of ribs being arranged such as to prevent acid starvation in the presence of active material swelling, optionally wherein:
said first plurality of ribs comprise a first plurality of discontinuous peaks, wherein each of said first plurality of discontinuous peaks are at least approximately 1.5 mm from another of said plurality of discontinuous peaks;
said first plurality of ribs comprise a first plurality of discontinuous peaks, wherein each of said first plurality of discontinuous peaks are at least approximately 1.5 mm from another of said plurality of discontinuous peaks, and the separator further comprising a continuous base portion, wherein said first plurality of discontinuous peaks extending therefrom;
said first plurality of ribs are configured to enhance acid mixing in a moving battery, with said separator disposed therein and positioned parallel to a start and stop motion of said battery;
said battery further comprises a mat adjacent to at least one of said positive electrode, said negative electrode, and said separator;
said battery further comprises a mat adjacent to at least one of said positive electrode, said negative electrode, and said separator, and said mat comprises one of the following group consisting of: glass fibers, synthetic fibers, silica, at least one performance enhancing additive, latex, natural rubber, synthetic rubber, and combinations thereof;
said battery further comprises a mat adjacent to at least one of said positive electrode, said negative electrode, and said separator, and said mat is a fibrous mat selected from a nonwoven, a woven, a mesh, a fleece, a net, or combinations thereof;
said battery operates in one of the following group consisting of in motion, stationary, in a backup power application, in a cycling applications, in a partial state of charge, in a solar power system, in a wind power system, and combinations thereof; or
wherein said battery is selected from the group consisting of: a flat-plate battery, a flooded lead acid battery, an enhanced flooded lead acid battery (“EFB”), a valve regulated lead acid (“VRLA”) battery, a deep-cycle battery, a gel battery, an absorptive glass mat (“AGM”) battery, a tubular battery, an inverter battery, a vehicle battery, a starting-lighting-ignition (“SLI”) vehicle battery, an idling-start-stop (“ISS”) vehicle battery, an automobile battery, a truck battery, a HD truck battery, a motorcycle battery, an all-terrain vehicle battery, a forklift battery, a golf cart battery, a hybrid-electric vehicle battery, an electric vehicle battery, an e-rickshaw battery, and an e-bike battery.

40. (canceled)

41. (canceled)

42. (canceled)

43. (canceled)

44. (canceled)

45. (canceled)

46. (canceled)

47. (canceled)

48. A lead acid battery comprising:
a positive electrode, and a negative electrode comprising a swollen negative active material;
a separator, wherein at least a portion of said separator is disposed between said positive electrode and said negative electrode;
an electrolyte substantially submerging at least a portion of said positive electrode, at least a portion of said negative electrode, and at least a portion of said separator; and
said separator comprising resilient means for mitigating separator deflection for mitigating acid starvation, optionally wherein:
said separator further comprises acid mixing means for reducing, mitigating, or reversing the effects of acid stratification; or
said separator further comprises acid mixing means for reducing, mitigating, or reversing the effects of acid stratification, and said resilient means and said acid mixing means comprise the same physical structure.

49. (canceled)

50. (canceled)

51. A vehicle comprising:
a lead acid battery operating at a partial state of charge;
a separator comprising a polymer and a filler;
said porous membrane having at least a first surface with at least a first plurality of ribs extending therefrom;
said first plurality of ribs comprising a first plurality of discontinuous peaks, wherein each of said first plurality of discontinuous peaks are at least approximately 1.5 mm from another of said plurality of discontinuous peaks, optionally wherein:
said lead acid battery operates at a depth of discharge between approximately 1% and approximately 99%;
said vehicle is an automobile, a truck, a motorcycle, an all-terrain vehicle, a forklift, a golf cart, a hybrid vehicle, a hybrid-electric vehicle battery, an electric vehicle, an idling-start-stop (“ISS”) vehicle, an e-rickshaw battery, and an e-bike battery.

52. (canceled)

53. (canceled)

54. The battery separator of claim 1 being a resilient separator, a balanced separator, an EFB separator, an ISS separator, and/or combinations or sub-combinations thereof.

55. The battery separator of claim 1, being a truck battery separator having low ER, reduced water loss, and acid mixing ribs.

56. A truck battery or battery string having the separator of claim 1, or
a heavy duty (HD) truck battery or battery string having the separator of claim 1, or
a lead acid battery or battery string having the battery separator of claim 1.

57. (canceled)

58. (canceled)
